(19) United States
(12) Patent Application Publication
(10) Pub. No.: US 2025/0278175 A1
(43) Pub. Date: Sep. 4, 2025

(54) SYSTEMS AND TECHNIQUES FOR INCORPORATING LARGE LANGUAGE MODELS INTO INTELLIGENT AUTOMATED ASSISTANTS

(71) Applicant: Apple Inc., Cupertino, CA (US)

(72) Inventors: Brad K. HERMAN, Culver City, CA (US); Shiraz AKMAL, Playa Vista, CA (US); William CARUSO, Cupertino, CA (US); St John W. COLON, Los Angeles, CA (US); Kenneth S. FRIEDMAN, Berkeley, CA (US); Arjun KAUL, San Francisco, CA (US); Viraaj M. MARATHE, Los Angeles, CA (US); Nicholas S. NEWBERG, Los Angeles, CA (US); Ping Wen ONG, San Jose, CA (US); Aarohi UNADKAT, San Jose, CA (US)

(21) Appl. No.: 19/053,239

(22) Filed: Feb. 13, 2025

Related U.S. Application Data
(60) Provisional application No. 63/670,046, filed on Jul. 11, 2024.
(60) Provisional application No. 63/560,621, filed on Mar. 1, 2024.

(51) Int. Cl. G06F 3/0484; G06F 3/16; G06F 40/40

(52) U.S. Cl. CPC G06F 3/0484; G06F 3/167; G06F 40/40

(57) ABSTRACT

An example process includes receiving a speech input from a user, obtaining a plurality of tasks based on the speech input, and determining, based on the plurality of tasks, an ordered task list associated with a set of task dependency criteria, wherein each task of the ordered task list includes a respective task dependency criteria. The process further includes displaying a representation of the ordered task list and performing each task of the ordered task list based on the set of task dependency criteria. The process further includes, while performing each task, updating the display of the representation of the ordered task list to indicate completion status of each task of the ordered task list, and displaying at least one graphical object corresponding to a respective task of the ordered task list.

### CROSS-REFERENCE TO RELATED APPLICATIONS

This application claims priority to U.S. Provisional Patent Application No. 63/670,046, entitled “SYSTEMS AND TECHNIQUES FOR INCORPORATING LARGE LANGUAGE MODELS INTO INTELLIGENT AUTOMATED ASSISTANTS”, filed on Jul. 11, 2024, and 63/560,621, entitled “SYSTEMS AND TECHNIQUES FOR INCORPORATING LARGE LANGUAGE MODELS INTO INTELLIGENT AUTOMATED ASSISTANTS,” filed on Mar. 1, 2024, the contents of which is hereby incorporated by reference in its entirety.

### FIELD

This relates generally to intelligent automated assistants and, more specifically, to incorporating large language models into intelligent automated assistant systems.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user.

### SUMMARY

Example methods are disclosed herein. An example method includes at a computer system in communication with a display generation component and one or more input devices: receiving, via the one or more input devices, a speech input from a user; obtaining a plurality of tasks based on the speech input; determining, based on the plurality of tasks, an ordered task list associated with a set of task dependency criteria, wherein each task of the ordered task list includes a respective task dependency criteria; displaying, via the display generation component, a representation of the ordered task list; performing each task of the ordered task list based on the set of task dependency criteria; while performing each task: updating the display, via the display generation component, of the representation of the ordered task list to indicate completion status of each task of the ordered task list; and displaying, via the display generation component, at least one graphical object corresponding to a respective task of the ordered task list.

Example non-transitory computer-readable storage media are described herein. An example non-transitory computer-readable storage medium stores one or more programs configured to be executed by one or more processors of a computer system that is in communication with a display generation component and one or more input devices, the one or more programs including instructions for: receiving, via the one or more input devices, a speech input from a user; obtaining a plurality of tasks based on the speech input; determining, based on the plurality of tasks, an ordered task list associated with a set of task dependency criteria, wherein each task of the ordered task list includes a respective task dependency criteria; displaying, via the display generation component, a representation of the ordered task list; performing each task of the ordered task list based on the set of task dependency criteria; while performing each task: updating the display, via the display generation component, of the representation of the ordered task list to indicate completion status of each task of the ordered task list; and displaying, via the display generation component, at least one graphical object corresponding to a respective task of the ordered task list.

Example computer systems are described herein. An example computer system is configured to communicate with a display generation component and one or more input devices. The computer system includes: one or more processors; and memory storing one or more programs configured to be executed by the one or more processors, the one or more programs including instructions for: receiving, via the one or more input devices, a speech input from a user; obtaining a plurality of tasks based on the speech input; determining, based on the plurality of tasks, an ordered task list associated with a set of task dependency criteria, wherein each task of the ordered task list includes a respective task dependency criteria; displaying, via the display generation component, a representation of the ordered task list; performing each task of the ordered task list based on the set of task dependency criteria; while performing each task: updating the display, via the display generation component, of the representation of the ordered task list to indicate completion status of each task of the ordered task list; and displaying, via the display generation component, at least one graphical object corresponding to a respective task of the ordered task list.

An example computer system includes: means for receiving, via the one or more input devices, a speech input from a user; means for obtaining a plurality of tasks based on the speech input; means for determining, based on the plurality of tasks, an ordered task list associated with a set of task dependency criteria, wherein each task of the ordered task list includes a respective task dependency criteria; means for displaying, via the display generation component, a representation of the ordered task list; means for performing each task of the ordered task list based on the set of task dependency criteria; while performing each task: means for updating the display, via the display generation component, of the representation of the ordered task list to indicate completion status of each task of the ordered task list; and means for displaying, via the display generation component, at least one graphical object corresponding to a respective task of the ordered task list.

Developing and executing an ordered task list using LLM functionality provides an enhanced interface for user-device interactions. In particular, leveraging task dependency criteria allows the device and/or server to build an intelligent list based on complex user requests. By leveraging concurrent and sequential performance of ordered tasks, the device optimizes task performance by intelligently performing asynchronous and synchronous tasks when appropriate. In addition, using LLM architecture combined with intuitive user interface controls such as speech, gaze, and air gestures, the user-device interaction is made more intuitive, accurate, and efficient (e.g., by reducing the number of user inputs otherwise required for the computer system to complete complex, multi-step requests). These improvements reduce power usage and improve battery life of the computer system by enabling the user to use the computer system more quickly and efficiently.

Example methods are disclosed herein. An example method includes at a computer system in communication with a display generation component and one or more input devices: displaying, via the display generation component, a user interface object that represents a digital assistant, wherein the user interface object that represents the digital assistant is overlaid over content; while displaying the user interface object that represents the digital assistant and that is overlaid over the content, detecting, via the one or more input devices, a first gaze of a user; and in response to detecting the first gaze of the user: in accordance with a determination that the first gaze is directed to the user interface object that represents the digital assistant and in accordance with a determination that the computer system satisfies a first set of criteria, displaying, via the display generation component, a first suggestion user interface object, wherein the first suggestion user interface object includes one or more suggestions determined based on a first context associated with the content; and in accordance with a determination that the first gaze is not directed to the user interface object that represents the digital assistant, forgoing displaying the first suggestion user interface object based on the detected first gaze.

Example non-transitory computer-readable storage media are described herein. An example non-transitory computer-readable storage medium stores one or more programs configured to be executed by one or more processors of a computer system that is in communication with a display generation component and one or more input devices, the one or more programs including instructions for: displaying, via the display generation component, a user interface object that represents a digital assistant, wherein the user interface object that represents the digital assistant is overlaid over content; while displaying the user interface object that represents the digital assistant and that is overlaid over the content, detecting, via the one or more input devices, a first gaze of a user; and in response to detecting the first gaze of the user: in accordance with a determination that the first gaze is directed to the user interface object that represents the digital assistant and in accordance with a determination that the computer system satisfies a first set of criteria, displaying, via the display generation component, a first suggestion user interface object, wherein the first suggestion user interface object includes one or more suggestions determined based on a first context associated with the content; and in accordance with a determination that the first gaze is not directed to the user interface object that represents the digital assistant, forgoing displaying the first suggestion user interface object based on the detected first gaze.

Example computer systems are described herein. An example computer system is configured to communicate with a display generation component and one or more input devices. The computer system includes: one or more processors; and memory storing one or more programs configured to be executed by the one or more processors, the one or more programs including instructions for: displaying, via the display generation component, a user interface object that represents a digital assistant, wherein the user interface object that represents the digital assistant is overlaid over content; while displaying the user interface object that represents the digital assistant and that is overlaid over the content, detecting, via the one or more input devices, a first gaze of a user; and in response to detecting the first gaze of the user: in accordance with a determination that the first gaze is directed to the user interface object that represents the digital assistant and in accordance with a determination that the computer system satisfies a first set of criteria, displaying, via the display generation component, a first suggestion user interface object, wherein the first suggestion user interface object includes one or more suggestions determined based on a first context associated with the content; and in accordance with a determination that the first gaze is not directed to the user interface object that represents the digital assistant, forgoing displaying the first suggestion user interface object based on the detected first gaze.

An example computer system includes: means for, displaying, via the display generation component, a user interface object that represents a digital assistant, wherein the user interface object that represents the digital assistant is overlaid over content; means, while displaying the user interface object that represents the digital assistant and that is overlaid over the content, for detecting, via the one or more input devices, a first gaze of a user; and in response to detecting the first gaze of the user: means, in accordance with a determination that the first gaze is directed to the user interface object that represents the digital assistant and in accordance with a determination that the computer system satisfies a first set of criteria, for displaying, via the display generation component, a first suggestion user interface object, wherein the first suggestion user interface object includes one or more suggestions determined based on a first context associated with the content; and means, in accordance with a determination that the first gaze is not directed to the user interface object that represents the digital assistant, for forgoing displaying the first suggestion user interface object based on the detected first gaze.

Providing suggestions determined based on context information when a user's gaze is directed at a user interface object provides an intuitive manner for the computer system to present predicted content and/or actions. The user can select a provided suggestion to implement it, thereby enabling the user to quickly, accurately, and efficiently operate the computer system as desired. Further, not providing the suggestions when the user's gaze is not directed at certain user interface object(s) provides an intuitive and efficient mechanism for the user to control whether they want suggestions and avoids cluttering the user interface with suggestions when they are not desired. Further, by determining suggestions based on context information and the techniques described herein, the suggestions may predict the next actions the user will request the computer system to perform. In this manner, the user-device interaction is made more intuitive, accurate, and efficient (e.g., by reducing the number of user inputs otherwise required for the computer system to complete desired actions, by providing accurate suggestions, and/or by reducing the number of user inputs required to hide/remove undesired suggestions), which additionally reduces power usage and improves battery life of the computer system by enabling the user to use the computer system more quickly and efficiently.

Example methods are disclosed herein. An example method includes at a computer system in communication with a display generation component and one or more input devices: receiving, via the one or more input devices, a first user input directed to a digital assistant operating on the computer system; and in response to receiving the first user input: in accordance with a determination that the first user input corresponds to a request to initiate a plan, wherein the plan includes one or more tasks suggested by the digital assistant: displaying, via the display generation component and in a user interface associated with the digital assistant, a first response graphical object corresponding to the plan, wherein the first response graphical object includes a representation of the one or more tasks suggested by the digital assistant; and adding an ongoing plan graphical object corresponding to the plan to a user interface that indicates one or more ongoing plans, wherein the user interface that indicates one or more ongoing plans is different from the user interface associated with the digital assistant; and in accordance with a determination that the first user input does not correspond to the request to initiate the plan: displaying, via the display generation component and in the user interface associated with the digital assistant, a second response graphical object that corresponds to the first user input and that is different from the first response graphical object; and forgoing, based on the first user input, adding an ongoing plan graphical object to the user interface that indicates one or more ongoing plans.

Example non-transitory computer-readable storage media are described herein. An example non-transitory computer-readable storage medium stores one or more programs configured to be executed by one or more processors of a computer system that is in communication with a display generation component and one or more input devices, the one or more programs including instructions for: receiving, via the one or more input devices, a first user input directed to a digital assistant operating on the computer system; and in response to receiving the first user input: in accordance with a determination that the first user input corresponds to a request to initiate a plan, wherein the plan includes one or more tasks suggested by the digital assistant: displaying, via the display generation component and in a user interface associated with the digital assistant, a first response graphical object corresponding to the plan, wherein the first response graphical object includes a representation of the one or more tasks suggested by the digital assistant; and adding an ongoing plan graphical object corresponding to the plan to a user interface that indicates one or more ongoing plans, wherein the user interface that indicates one or more ongoing plans is different from the user interface associated with the digital assistant; and in accordance with a determination that the first user input does not correspond to the request to initiate the plan: displaying, via the display generation component and in the user interface associated with the digital assistant, a second response graphical object that corresponds to the first user input and that is different from the first response graphical object; and forgoing, based on the first user input, adding an ongoing plan graphical object to the user interface that indicates one or more ongoing plans.

Example computer systems are described herein. An example computer system is configured to communicate with a display generation component and one or more input devices. The computer system includes: one or more processors; and memory storing one or more programs configured to be executed by the one or more processors, the one or more programs including instructions for: receiving, via the one or more input devices, a first user input directed to a digital assistant operating on the computer system; and in response to receiving the first user input: in accordance with a determination that the first user input corresponds to a request to initiate a plan, wherein the plan includes one or more tasks suggested by the digital assistant: displaying, via the display generation component and in a user interface associated with the digital assistant, a first response graphical object corresponding to the plan, wherein the first response graphical object includes a representation of the one or more tasks suggested by the digital assistant; and adding an ongoing plan graphical object corresponding to the plan to a user interface that indicates one or more ongoing plans, wherein the user interface that indicates one or more ongoing plans is different from the user interface associated with the digital assistant; and in accordance with a determination that the first user input does not correspond to the request to initiate the plan: displaying, via the display generation component and in the user interface associated with the digital assistant, a second response graphical object that corresponds to the first user input and that is different from the first response graphical object; and forgoing, based on the first user input, adding an ongoing plan graphical object to the user interface that indicates one or more ongoing plans.

An example computer system includes: means for receiving, via the one or more input devices, a first user input directed to a digital assistant operating on the computer system; and in response to receiving the first user input: means, in accordance with a determination that the first user input corresponds to a request to initiate a plan, wherein the plan includes one or more tasks suggested by the digital assistant, for: displaying, via the display generation component and in a user interface associated with the digital assistant, a first response graphical object corresponding to the plan, wherein the first response graphical object includes a representation of the one or more tasks suggested by the digital assistant; and adding an ongoing plan graphical object corresponding to the plan to a user interface that indicates one or more ongoing plans, wherein the user interface that indicates one or more ongoing plans is different from the user interface associated with the digital assistant; and means, in accordance with a determination that the first user input does not correspond to the request to initiate the plan, for: displaying, via the display generation component and in the user interface associated with the digital assistant, a second response graphical object that corresponds to the first user input and that is different from the first response graphical object; and forgoing, based on the first user input, adding an ongoing plan graphical object to the user interface that indicates one or more ongoing plans.

Adding an ongoing plan graphical object to a particular user interface if a user requests to initiate a plan improves the capability of a digital assistant by allowing more efficient and accurate management of user requested plans. Specifically, having the particular user interface that includes graphical objects for respective plans allows the computer system to organize the plans being managed for the user and provides the user with a convenient platform for managing their plans. For example, from the particular user interface, the user can select a graphical object for a respective plan to view, edit, and/or otherwise manage the respective plan. Further, not adding an ongoing plan graphical object to the particular user interface if a user does not request the digital assistant to initiate a plan avoids cluttering the particular user interface by separating planning tasks (e.g., planning a vacation) from non-planning tasks (e.g., retrieving weather information). Further still, as described herein, the digital assistant can update the graphical object for a respective plan (and/or another displayed representation of the plan) in response to a change in an aspect of a plan. As one example, if the digital assistant determines to request the user for additional information to continue with the plan (e.g., because the digital assistant cannot progress with the plan without such information), the display of the respective graphical object changes (e.g., is emphasized) to indicate the request for additional information. In this manner, the user-device interaction is made more accurate and efficient (e.g., by allowing the computer system to manage complex planning tasks that may involve coordinating the performance of multiple tasks over an extended time period (and/or involve multiple rounds of interaction with the digital assistant over an extended time period) and/or by reducing the number of user inputs required to manage such planning tasks), which additionally reduces power usage and improves battery life of the computer system by enabling the user to use the computer system more quickly and efficiently.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4 is a block diagram of an exemplary multifunction device with a display and a touch-sensitive surface, according to various examples.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 8 illustrates a computer system, according to various examples.

FIG. 9A illustrates various components of an exemplary foundation system including foundation model, according to various examples.

FIG. 9B illustrates various components of a large language model (LLM) unit and processes that the LLM unit performs, according to various examples.

FIGS. 10A-10M and FIGS. 11A-11P illustrate techniques for providing suggestions, according to various examples.

FIGS. 12A-12Y illustrate user interfaces and techniques for managing plans, according to various examples.

FIG. 13 illustrates a process for determining tasks from speech, according to various examples.

FIG. 14 illustrates a process for providing suggestions, according to various examples.

FIG. 15 illustrates a process for managing a plan, according to various examples.

### DETAILED DESCRIPTION

As described herein, incorporating large language models (LLMs) into digital assistant systems may improve digital assistant capability in various manners, e.g., by improving how digital assistants handle natural language inputs that include multiple commands, by improving how digital assistants provide suggestions, and by improving how digital assistants manage plans requested by a user.

In the following description of examples, reference is made to the accompanying drawings in which are shown by way of illustration specific examples that can be practiced. It is to be understood that other examples can be used and structural changes can be made without departing from the scope of the various examples.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone or a head-mounted device, that also contains other functions, such as PDA and/or music player functions. Exemplary embodiments of portable multifunction devices include, without limitation, the Apple Watch®, iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 256) by transmitting, via a wired or wireless connection, data (e.g., image data or video data) to an integrated or external display generation component to visually produce the content.

### 1. System and Environment

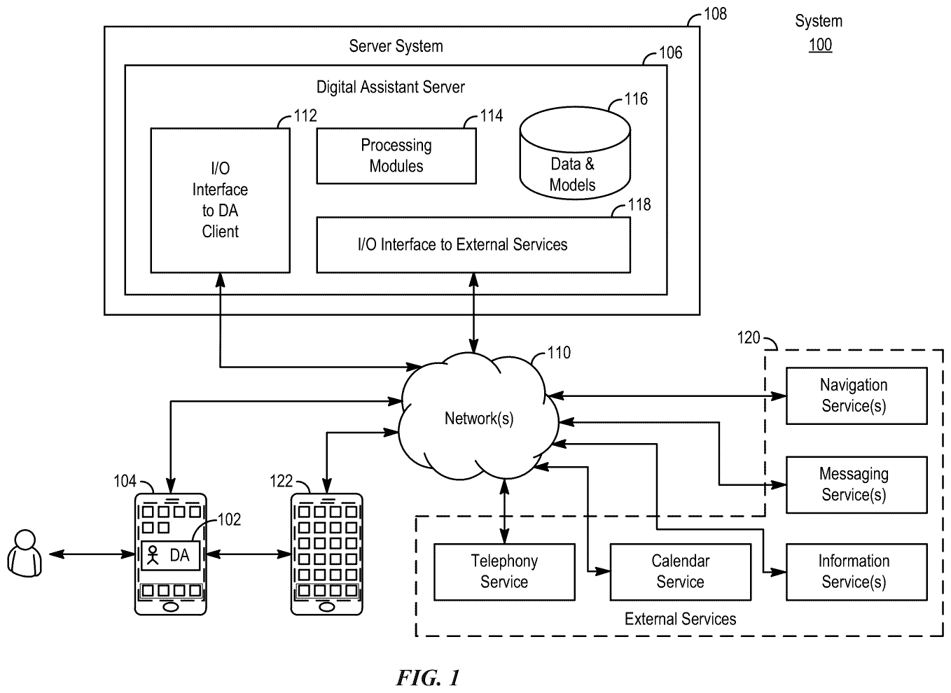

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

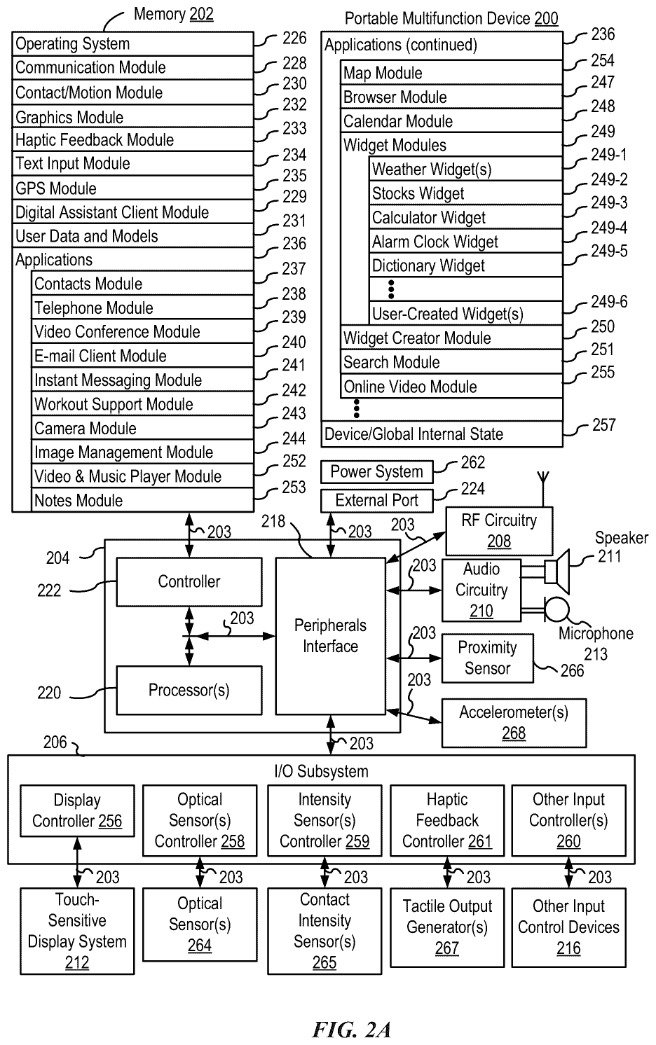

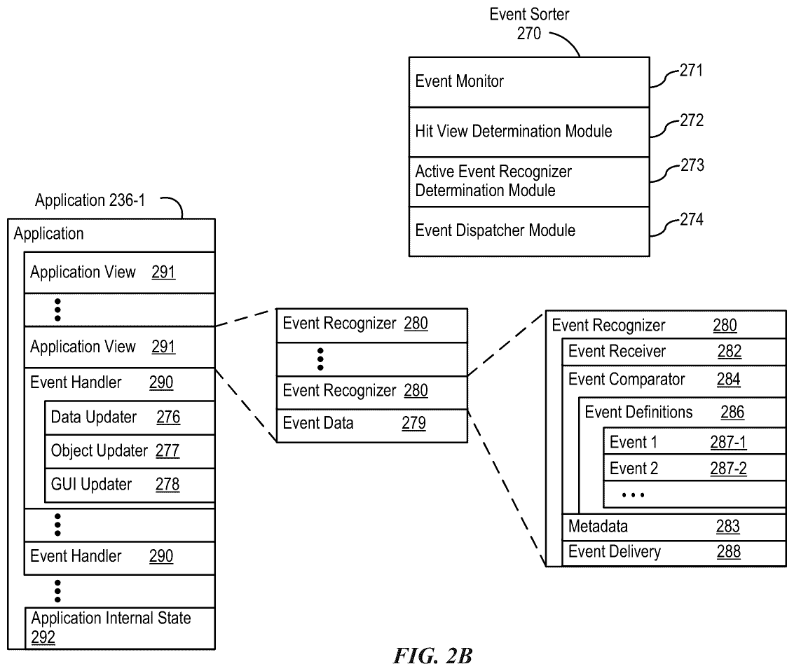

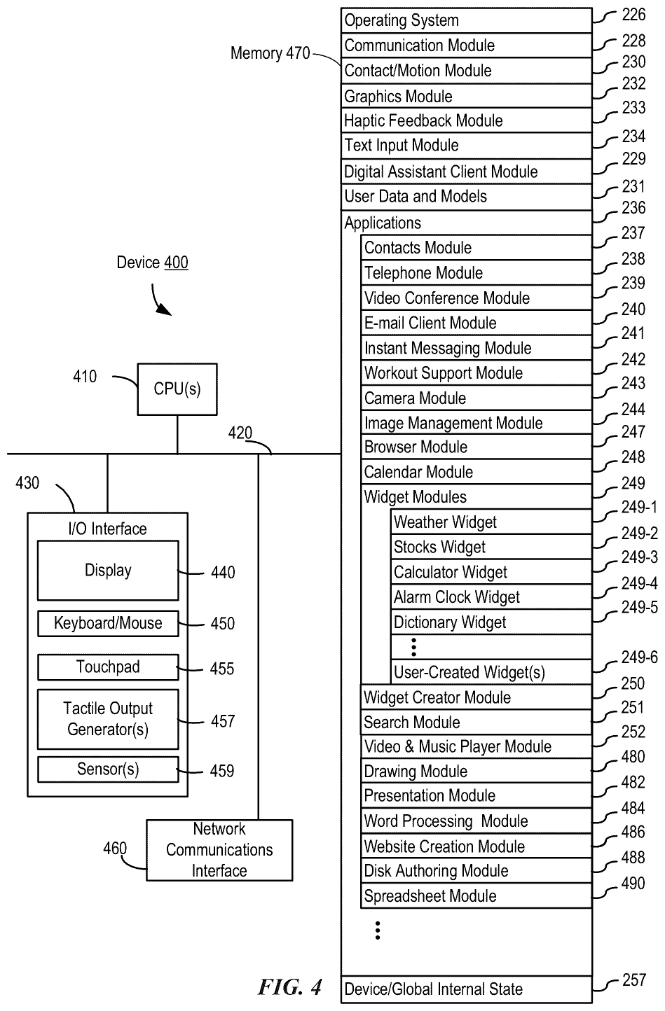

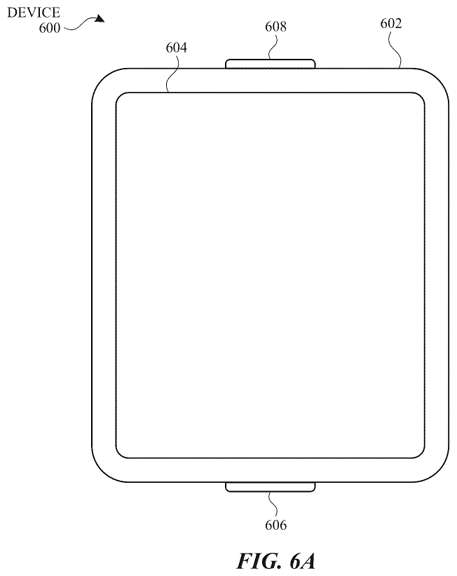

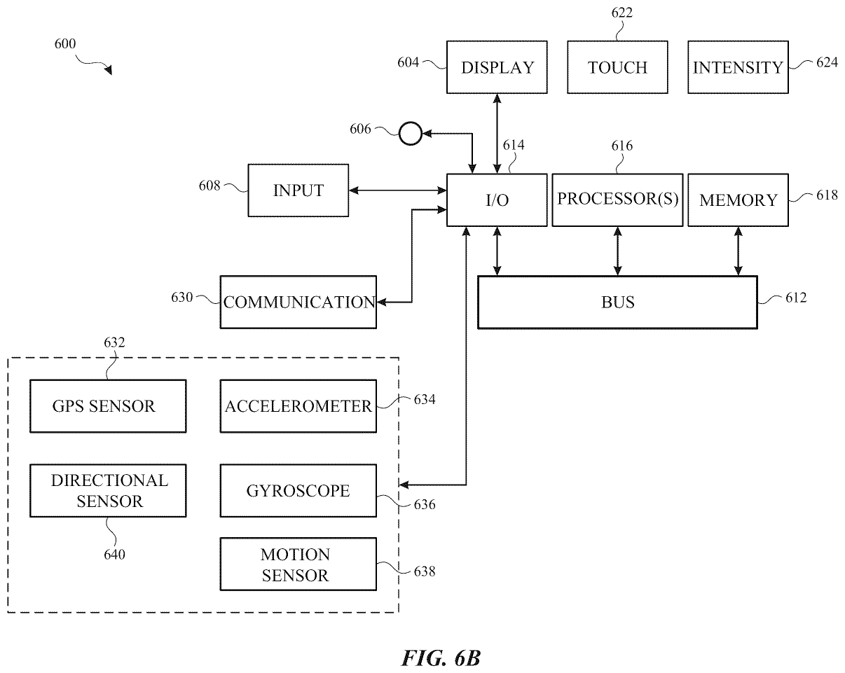

User device 104 can be any suitable electronic device. In some examples, user device 104 is a portable multifunctional device (e.g., device 200, described below with reference to FIG. 2A), a multifunctional device (e.g., device 400, described below with reference to FIG. 4), or a personal electronic device (e.g., device 600, described below with reference to FIGS. 6A-6B). A portable multifunctional device is, for example, a mobile telephone that also contains other functions, such as PDA and/or music player functions. Specific examples of portable multifunction devices include the Apple Watch®, iPhone®, iPod Touch®, and iPad® devices from Apple Inc. of Cupertino, California. Other examples of portable multifunction devices include, without limitation, earphones/headphones, speakers, head-mounted devices, and laptop or tablet computers. Further, in some examples, user device 104 is a non-portable multifunctional device. In particular, user device 104 is a desktop computer, a game console, a speaker, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4, and 6A-6B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and returns relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

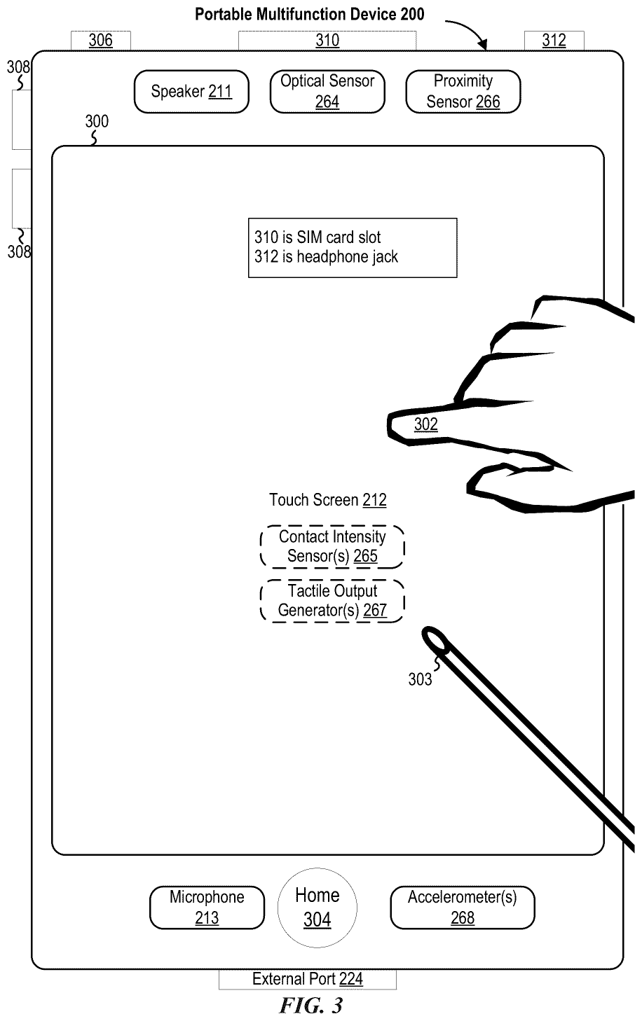

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both cars) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 264, optical sensor(s) included in eye tracking device 806, and/or optical sensor(s) included in hand tracking device 810), e.g., for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, California.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. In some embodiments, optical sensor 264 includes charge-coupled device (CCD) or complementary metal-oxide semiconductor (CMOS) phototransistors. In some embodiments, optical sensor 264 receives light from the environment, projected through one or more lenses, and converts the light to data representing an image. In some embodiments, optical sensor 264 includes a depth camera sensor that receives data from the environment to create, from a particular viewpoint, a three-dimensional model of an object within a scene. In some embodiments, in conjunction with imaging module 243 (also called a camera module), optical sensor 264 captures still images or video. In some embodiments, in conjunction with imaging module 243, optical sensor 264 is used to determine a depth map of different portions of a captured image. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4) stores device/global internal state 257, as shown in FIGS. 2A and 4. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or altitude.

Operating system 226 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts module 237, e-mail client module 240, IM module 241, browser module 247, and any other application that needs text input).

GPS module 235 determines the location of the device and provides this information for use in various applications (e.g., to telephone module 238 for use in location-based dialing; to camera module 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 264, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

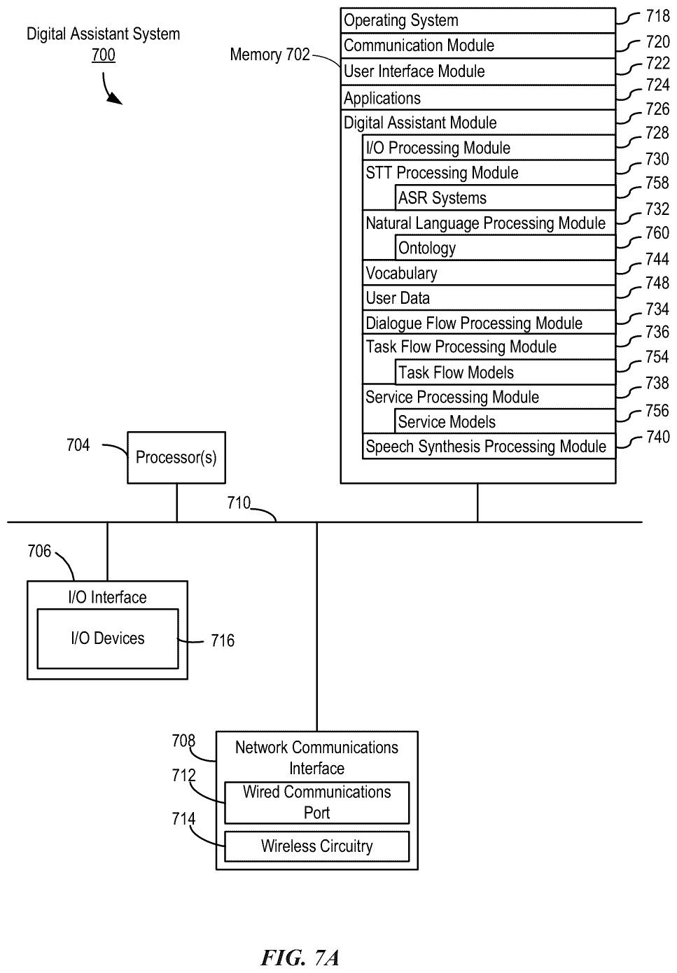

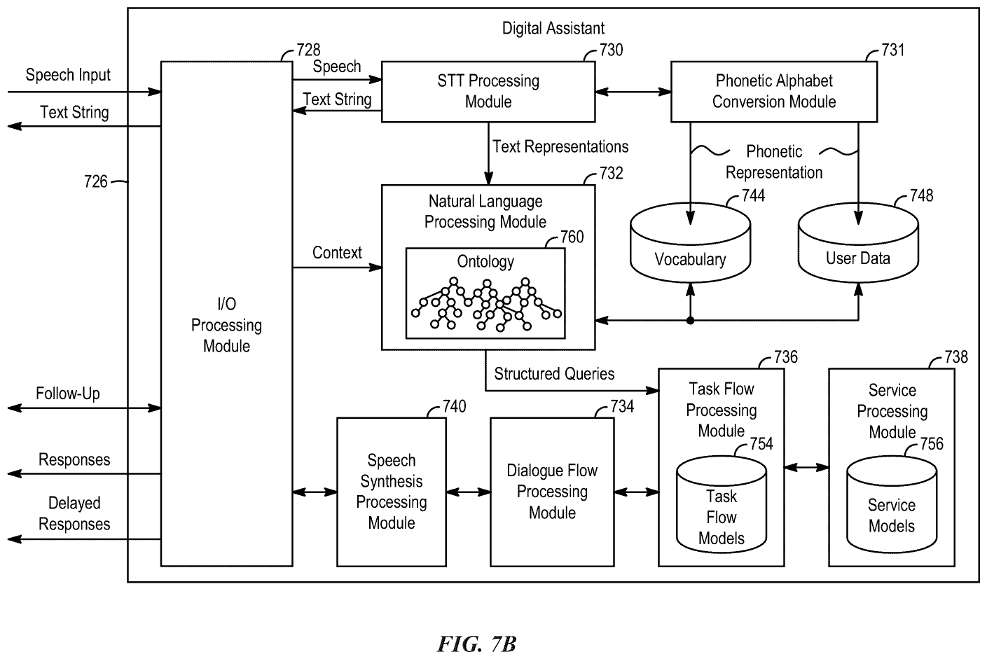

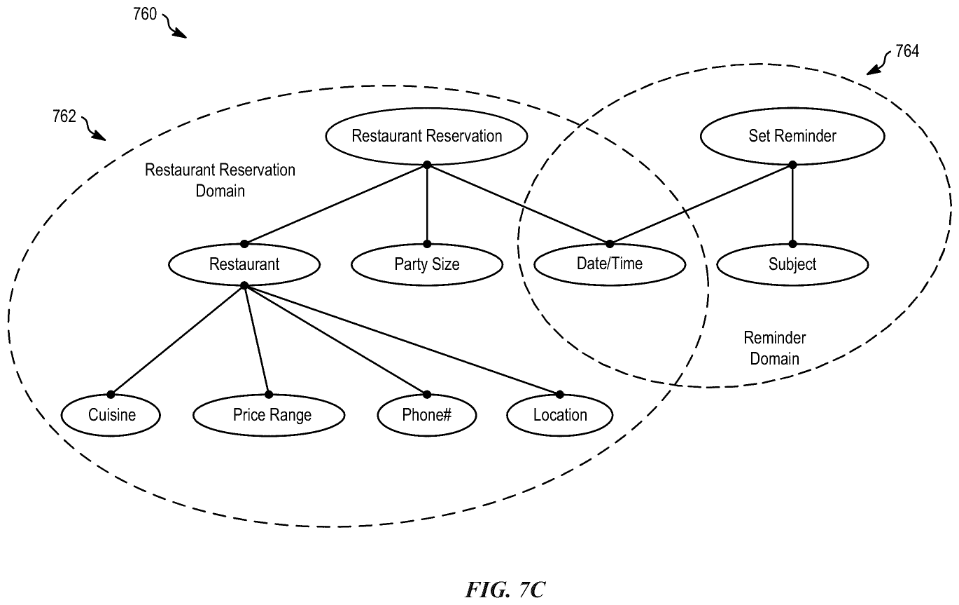

A more detailed description of a digital assistant is described below with reference to FIGS. 7A-7C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 238, video conference module 239, e-mail client module 240, or IM module 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4 is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4 is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Attention is now directed towards embodiments of user interfaces that can be implemented on, for example, portable multifunction device 200.

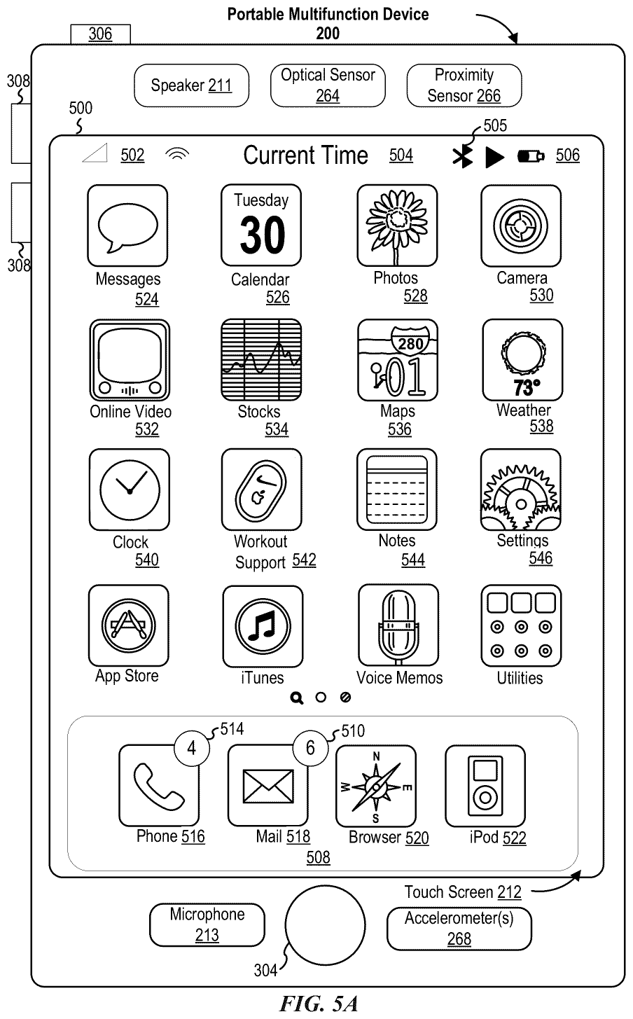

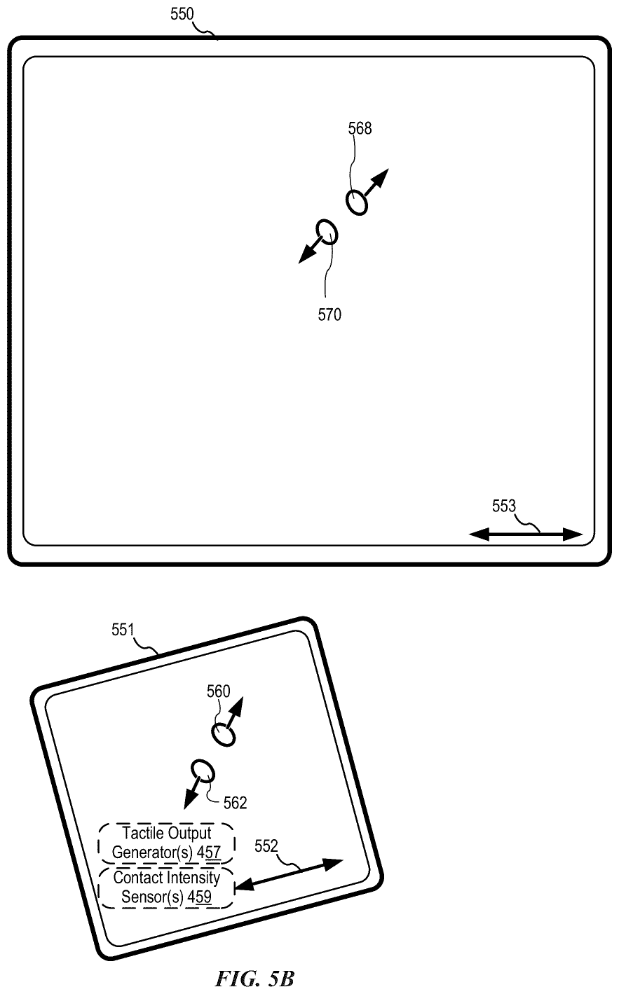

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4) with a touch-sensitive surface 551 (e.g., a tablet or touchpad 455, FIG. 4) that is separate from the display 550 (e.g., touch screen display 212). Device 400 also, optionally, includes one or more contact intensity sensors (e.g., one or more of sensors 459) for detecting intensity of contacts on touch-sensitive surface 551 and/or one or more tactile output generators 457 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, 600, 800, 1000, 1100, and/or 1200 (FIGS. 2A, 4, 6A-6B, 8, 10A-10M, 11A-11P, and 12A-12Y). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4 or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, 600, 800, 1000, 1100, or 1200) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, 600, 800, 1000, 1100, and/or 1200 (FIGS. 2A, 4, 6A-6B, 8, 10A-10M, 11A-11P, and 12A-12Y). In some examples, digital assistant system 700 represents the server portion of a digital assistant implementation, and can interact with the user through a client-side portion residing on a user device (e.g., devices 104, 200, 400, 600, 800, 1000, 1100, or 1200).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VOIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIGS. 2A, 4, 6A-6B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis processing module 740. Each of these modules has access to one or more of the following systems or data and models of the digital assistant module 726, or a subset or superset thereof: ontology 760, vocabulary index 744, user data 748, task flow models 754, service models 756, and ASR systems 758.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems 758. The one or more ASR systems 758 can process the speech input that is received through I/O processing module 728 to produce a recognition result. Each ASR system 758 includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system 758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of / [symbol] / and / [symbol] /. Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation / [symbol] / is ranked higher than / [symbol] /, because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation / [symbol] / is associated with the United States, whereas the candidate pronunciation / [symbol] / is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation / [symbol] / (associated with the United States) is ranked higher than the candidate pronunciation / [symbol] / (associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes / [symbol] / corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes / [symbol] / corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked property nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string are described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=Mar. 12, 2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generates requests for the service in accordance with the protocols and APIs required by the service according to the service model.

For example, if a restaurant has enabled an online reservation service, the restaurant submits a service model specifying the necessary parameters for making a reservation and the APIs for communicating the values of the necessary parameter to the online reservation service. When requested by task flow processing module 736, service processing module 738 establishes a network connection with the online reservation service using the web address stored in the service model, and sends the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis processing module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis processing module 740 is configured to synthesize speech outputs for presentation to the user. Speech synthesis processing module 740 synthesizes speech outputs based on text provided by the digital assistant. For example, the generated dialogue response is in the form of a text string. Speech synthesis processing module 740 converts the text string to an audible speech output. Speech synthesis processing module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis processing module 740 is configured to synthesize individual words based on phonemic strings corresponding to the words. For example, a phonemic string is associated with a word in the generated dialogue response. The phonemic string is stored in metadata associated with the word. Speech synthesis processing module 740 is configured to directly process the phonemic string in the metadata to synthesize the word in speech form.

In some examples, instead of (or in addition to) using speech synthesis processing module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

4. Computer System and Processes for Incorporating Large Language Models into a Digital Assistant System

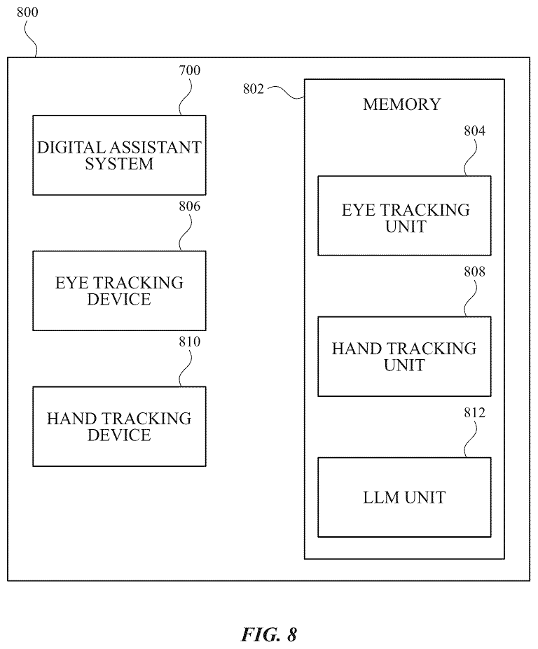

FIG. 8 illustrates computer system 800, according to various examples. Computer system 800 includes at least some of the components of devices 104, 122, 200, 400, and/or 600. In some examples, computer system 800 is implemented as a smartphone device, a tablet device, a laptop computer, a desktop computer, a smart watch, a smart home device (e.g., a smart speaker, a smart TV, and/or smart home appliance), a wearable device, a head-mounted device, or another type of mobile device (e.g., an automobile, a robot, and/or a drone). While FIG. 8 illustrates certain components of computer system 800, one of ordinary skill in the art will appreciate that certain components of computer system 800 are not illustrated. Such components are not illustrated for brevity and to avoid obscuring more pertinent aspects of the present disclosure.

Further, FIG. 8 includes a functional description of the various components that may be present in a particular example, as opposed to a structural schematic of the examples described herein. As recognized by those of ordinary skill in the art, components shown separately could be combined and some components could be separated. For example, some functional components shown separately in FIG. 8 could be implemented in a single component and the various functions of single functional components could be implemented by one or more functional components in various examples. The actual number of components and how functions are allocated between the components will vary from one implementation to another and, in some examples, depends in part on the particular combination of hardware, software, and/or firmware chosen for a particular implementation of computer system 800.

Computer system 800 at least partially implements digital assistant system 700, as described above with respect to FIGS. 7A-7C. Computer system 800 further includes memory 802. Memory 802 is at least partially implemented as a respective separate instance of at least one of memory(ies) 202, 470, 618, and 702. For example, memory 802 includes at least some of the components of memory(ies) 202, 470, 618, and/or 702. In some examples, memory 802 includes one or more additional components, described below, that enable computer system 800 to incorporate large language models into digital assistant systems and to perform the processes described herein.

In a non-limiting example, memory 802 includes eye tracking unit 804 and computer system 800 includes eye tracking device 806. Eye tracking unit 804 includes instructions and/or logic for tracking the position and movement of the user's gaze (or more broadly, the user's eyes, face, or head) using data obtained from eye tracking device 806. In some examples, eye tracking unit 804 tracks the position and movement of the user's gaze relative to a physical environment, relative to the user (e.g., the user's hand, face, or head), relative to computer system 800, and/or relative to content displayed by a display generation component.

Eye tracking device 806 is controlled by eye tracking unit 804 and includes various hardware and/or software components configured to perform eye tracking techniques. For example, eye tracking device 806 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards mirrors that reflect IR or NIR light from the eyes to the eye tracking cameras. Eye tracking device 806 optionally captures images of the user's eyes (e.g., as a video stream captured at 60-120 frames per second), analyzes the images to generate eye tracking information, and communicates the eye tracking information to eye tracking unit 804. In some examples, two eyes of the user are separately tracked by respective eye tracking cameras and illumination sources. In some examples, only one eye of the user is tracked by a respective eye tracking camera and illumination sources.

In a non-limiting example, memory 802 includes hand tracking unit and 808 and computer system 800 includes hand tracking device 810. Hand tracking unit 808 includes instructions and/or logic for tracking, using hand tracking data obtained from hand tracking device 810, the position of one or more portions of the user's hands and/or motions of one or more portions of the user's hands. Hand tracking unit 808 tracks the position and/or motion relative to a physical environment, relative to the user (e.g., the user's head, face, or eyes), relative to computer system 800, relative to content displayed by a display generation component, and/or relative to a coordinate system defined relative to the user's hand. In some examples, hand tracking unit 808 analyzes the hand tracking data to identify a hand gesture (e.g., an air gesture, such as a grabbing gesture, a pinching gesture, or a pointing gesture) and to identify content (e.g., physical content or virtual content) corresponding to the hand gesture, e.g., content selected by the hand gesture.

Hand tracking device 810 is controlled by hand tracking unit 808 and includes various hardware and/or software components configured to perform hand tracking and hand gesture recognition techniques. For example, hand tracking device 810 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 810 communicates the temporal sequence of the hand tracking data to hand tracking unit 808 for further analysis, e.g., to identify hand gestures, hand poses, and/or hand movements.

In some examples, hand tracking device 810 includes one or more hardware input devices configured to be worn and/or held by (or be otherwise attached to) one or more respective hands of the user. In such examples, hand tracking device 810 tracks the position, pose, and/or motion of a user's hand based on tracking the position, pose, and/or motion of the respective hardware input device. Hand tracking device 810 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch sensitive surface(s), pressure sensitive surface(s), knob(s), joystick(s), and the like) and a user input that selects a particular physical control serves a function analogous to a respective hand gesture input. For example, if computer system 800 interprets a pinching hand gesture input as a user selection of a particular element, computer system 800 can alternatively or additionally interpret selection of a physical button of the hardware device as a user selection of the particular element.

While FIG. 8 illustrates that DA system 700, memory 802 (including eye tracking unit 804, head tracking unit 808, and LLM unit 812), eye tracking device 806, and head tracking device 810 reside on a single computing device, in other examples, the components and/or functionalities of computer system 800 can be distributed across multiple computing devices in various different manners. For example, server system 108 (FIG. 1) implements LLM unit 812 and its associated functionalities, while the other components of computer system 800 reside on another computing device separate from and in communication with server system 108. As another example, eye tracking device 806 and hand tracking device 810 reside on a first device that is in communication with a separate second device that implements the other components of computer system 800 and their associated functions.

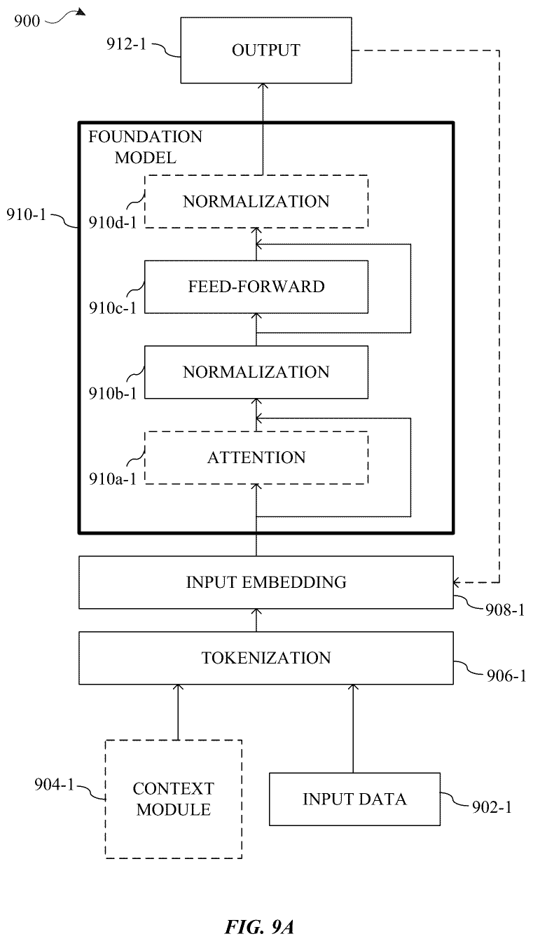

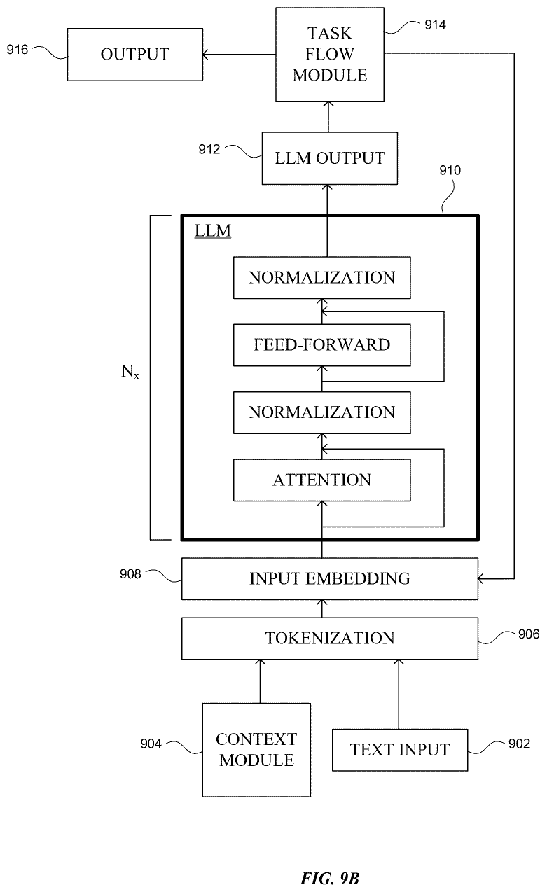

FIG. 9A illustrates exemplary foundation system 900-1 including foundation model 910-1, according to some embodiments. In some embodiments, the blocks of foundation system 900 are combined, the order of the blocks is changed, and/or blocks of foundation system 900 are removed.

Foundation system 900 includes tokenization module 906-1, input embedding module 908-1, and foundation model 910-1 which use input data 902-1 and, optionally, context module 904-1 to train foundation model 910-1 to process input data 902-1 to determine output 912-1.

In some examples, the various components of digital assistant system 700 include and/or are implemented using generative artificial intelligence (AI) such as foundation model 910-1. In some examples, foundation model 910-1 include a subset of machine learning models that are trained to generate text, images, and/or other media based on sets of training data that include large amounts of a particular type of data. Foundation model 910-1 is then integrated into the components of digital assistant system 700 (or otherwise available to digital assistant system 700) to provide text, images, and/or other media that digital assistant system 700 uses to determine tasks, perform tasks, and/or provide the outputs of tasks.

Generative AI models, such as foundation model 910-1, are trained on large quantities of data with self-supervised or semi-supervised learning to be adapted to a specific downstream task. For example, foundation model 910-1 is trained with large sets of different images and corresponding text or metadata to determine the description of newly captured image data as output 912-1. These descriptions can then be used by digital assistant system 700 to determine user intent, tasks, and/or other information that can be used to perform tasks.

Foundation models are generally trained using large sets unlabeled data first and then later adapted to a specific task within the architecture of digital assistant system 700. Thus, a specific task or type of output is not encoded into the foundation models, rather the trained foundation model emerges based on the self-supervised training using the unlabeled data. The trained foundation model is then adapted to a variety of tasks based on the needs of the digital assistant system 700 to efficiently perform tasks for a user.

Large language models (LLM) are a type of foundation model that provide text output after being trained on large sets of input text data. As with other foundation models, LLM's can be trained in a self-supervised manner and thus the output of different LLM's trained on the same large set of input text can be different. These LLM's can then be adapted for use with digital assistant system 700 to specific types of text. Thus, in some examples, the LLM is trained to determine a summary of text provided to the LLM as an input while in other examples, the LLM is trained to predict text based on the set of input text. Thus, the LLM can efficiently process large amounts of input text to provide the digital assistant with text that can be used to determine and/or perform tasks.

In some examples, the LLM may be trained in a semi-supervised manner and/or provided human feedback to refine the output of the LLM. In this way, the LLM may be adapted to provide the specific output required for a particular task of digital assistant system 700, such as a summary of large amounts of text or a task for digital assistant system 700 to perform. Further, the input provided to the LLM can be adapted such that the LLM processes data as or more efficiently than digital assistant system 700 could without the use of the LLM.

Once foundation model 910-1 (e.g., a LLM) has been fully trained, foundation model 910-1 can process input data 902-1 as discussed below to determine output 912-1 which may be used to further train foundation model 910-1 or can be processed by digital assistant 700 to perform a task and/or provide an output to the user.

Specifically, input data 902-1 is received and provided to tokenization module 906-1 which converts input data 902-1 into a token and/or a series of tokens which can be processed by input embedding module 908-1 into a format that is understood by foundation model 910-1. Tokenization module 906-1 converts input data into a series of characters that has a specific semantic meaning to foundation model 910-1.

In some examples, tokenization module 906-1 tokenizes contextual data from context module 904-1 to add further information to input data 902-1 for processing by foundation model 910-1. For example, context module 904-1 can provide information related to input data 902-1 such as a location that input data 902-1 was received, a time that input data 902-1 was received, other data that was received contemporaneously with input data 902-1, and/or other contextual information that relates to input data 902-1. Tokenization module 906-1 can then tokenize this contextual data with input data 902-1 to be provided to foundation model 910-1.

After input data 902-1 has been tokenized, input data 902-1 is provided to input embedding module 908-1 to convert the tokens to a vector representation that can be processed by foundation model 910-1. In some examples, the vector representation includes information provided by context module 904-1. In some examples, the vector representation includes information determined from output 912-1. Accordingly, input embedding module 908-1 converts the various data provided as an input into a format that foundation model 910-1 can parse and process.

For example, when foundation model 910-1 is a large language model (LLM) tokenization module 906-1 converts input data 902-1 into text which is then converted into a vector representation by input embedding module 908-1 that can be processed by foundation model 910-1 to determine a response to input data 902-1 as output 912-1 or to determine a summary of input data 902-1 as output 912-1. As another example, when foundation model 910-1 is a model that has been trained to determine descriptions of images, input data 902-1 of images can be tokenized into characters and then converted into a vector representation by input embedding module 908-1 that is processed by foundation model 910-1 to determine a description of the images as output 912-1.

Foundation model 910-1 processes the received vector representation using a series of layers including, in some embodiments, attention layer 910a-1, normalization layer 910b-1, feed-forward layer 910c-1, and/or normalization layer 910d-1. In some examples, foundation model 910-1 includes additionally layers similar to theses layers to further process the vector representation. Accordingly, foundation model 910-1 can be customized based on the specific task that foundation model 910-1 has been trained to perform. Each of the layers of foundation model 910-1 perform a specific task to process the vector representation into output 912-1.

Attention layer 910a-1 provides access to all portions of the vector representation at the same time, increasing the speed at which the vector representation can be processed and ensuring that the data is processed equally across the portions of the vector representation. Normalization layer 910b-1 and normalization layer 910d-1 scale the data that is being processed by foundation model 910-1 up or down based on the needs of the other layers of foundation model 910-1. This allows foundation model 910-1 to manipulate the data during processing as needed. Feed-forward layer 910c-1 assigns weights to the data that is being processed and provides the data for further processing within foundation model 810-1. These layers work together to process the vector representation provided to foundation model 810-1 to determine the appropriate output 912-1.

For example, as discussed above, when foundation model 910-1 is a large language model (LLM) foundation model 910-1 processes input text to determine a summary and/or further follow-up text as output 912-1. As another example, as discussed above, when foundation model 910-1 is a model trained to determine descriptions of images, foundation model 910-1 processes input images to determine a description of the image and/or tasks that can be performed based on the content of the images as output 912-1.

In some examples, output 912-1 is further processed by digital assistant system 700 to provide an output or execute a task. For example, when output 912-1 is a sentence describing a task that digital assistant system 700 has performed, digital assistant system 700 can use the text to create a visual or audio output to be provided to a user. As another example, when output 912-11 is text that includes a function and a parameter for the function, digital assistant system 700 can perform a function call to execute the function with the provided parameter.

In some examples, digital assistant system 700 includes multiple generative AI (e.g., foundation) models that work together to process data in an efficient manner. In some examples, components of digital assistant system 700 may be replaced with generative AI (e.g., foundation) models trained to perform the same function as the component. In some examples, these generative AI models are more efficient than traditional components and/or provide more flexible processing and/or outputs for digital assistant system 700 to utilize.

FIG. 9B illustrates various components of LLM unit 812 and processes that LLM unit 812 performs, according to various examples. In a non-limiting example, memory 802 includes the large language model (LLM) unit 812. In general, LLM unit 812 may receive various forms of input, such as text input 902. For example, text input 902 may correspond to a textual representation (e.g., transcription) of speech input received from a user of computer system 800. In some examples, text input 902 may correspond to textual input typed by a user (e.g., via an accessibility application, physical or virtual keyboard, etc.).

LLM unit 812 includes context module 904. Context module 904 is configured to determine context information relevant for processing a request directed to LLM unit 812. Context module 904 thus enables LLM unit 812 to generate LLM output 912 based on both text input 902 and relevant context information. One of ordinary skill in the art will appreciate that operating LLM unit 812 in such manner enables LLM unit to perform computing tasks in a context aware manner, thereby increasing the number of different types of tasks LLM unit 812 can handle. For example, if text input 902 requests to perform a particular operation on an ambiguous entity (e.g., is “tell me about this”), the context information indicates what the ambiguous entity refers to, so LLM output 912 indicates to perform the particular operation on the correct entity. As another example, if text input 902 requests to provide relevant suggestions, the context information indicates what is determined as relevant, so LLM output 912 represents relevant suggestions.

Generally, context module 904 is configured to determine context information from information accessible to (e.g., able to be sensed and/or determined by) computer system 800. Non-limiting examples of context information include one or more applications installed on computer system 800 (e.g., open application(s), active application(s), background application(s), and/or suspended application(s)), metadata associated with the applications (e.g., internet search history for a web browsing application, activity logs for a word processing application, and/or recent messages for a text or email application), displayed content, the location of computer system 800, the physical environment surrounding computer system 800 (e.g., information determined from analysis of the physical environment, such as objects identified to be within the physical environment and/or people identified to be within the physical environment (and optionally, their associated facial expressions, gaze directions, and/or performed gestures)), an emotional state of the user (e.g., as determined from speech input and/or optical input) temperature information, weather information, ambient lighting information, an orientation of computer system 800, time, user information accessible to computer system 800 (e.g., the user's list of contacts (e.g., in a digital phonebook), financial information, health information (e.g., detected heart rate or blood glucose level), reminder information, notes, calendar information, photos and/or videos, media items, user preferences, and the like), information associated with user inputs to computer system 800 (e.g., elements selected by the user, applications launched by the user, objects the user gazed at, objects the user gestured at, previous user requests to digital assistant system 700 and/or to LLM unit 812, responses generated by digital assistant system 700 and/or LLM unit 812 to previous user requests, and/or actions the user caused computer system 800 to perform), device state information (e.g., indicating that a particular device is open, closed, locked, unlocked, set to a specific value (e.g., temperature setting and/or brightness value), and/or has a particular value (e.g., CPU usage level and/or battery level)), user-configurable settings of computer system 800, nearby devices detected by computer system 800, the connectivity level of computer system 800 to external network(s) (e.g., the Internet and/or cellular network(s)), the type of computer system 800 (e.g., a smartphone device, a wearable device, or a head mounted device), the hardware capabilities of computer system 800, and/or the software capabilities of computer system 800.

Context module 904 determines the context information relevant at a current time and/or current location of computer system 800. In some examples, the current time refers to the time when a request is made (e.g., by the user and/or by computer system 800) for LLM unit 812 to provide LLM output 912. In some examples, context module 904 scores different context information accessible to computer system 800 based on current relevance and determines the relevant context information to include the context information having respective scores that each exceed a threshold. In some examples, context module 904 determines the relevant context information based on analyzing current and/or historical user interactions associated with computer system 800. One of skill in the art will appreciate that context module 904 can implement various techniques to determine the relevant context information based on analyzing user-device interactions, and such details are not included here for brevity. As one example, the relevant context information for a particular time indicates that two applications are open on computer system 800, the displayed content of the applications, and that the user typically calls their mom at the particular time. As another example, the relevant context information for a particular time indicates the current location of the user/computer system 800, that the user is currently in a meeting, and that the user has recently requested for a digital assistant to assist with a particular task, e.g., a flight booking task, a travel planning task, and/or a restaurant reservation task.

In some examples, context module 904 processes user input received by computer system 800 to determine the relevant context information. The user input can explicitly or implicitly indicate the context information. For example, natural language input (e.g., “I only want to consider the notes app as context” or “I only want to consider my location as context”) explicitly indicates the context information. In some examples, the digital assistant processes the natural language input to determine an associated user intent and then executes a corresponding task flow that instructs context module 904 to generate the appropriate context information.

Examples of user input that implicitly indicates the context information include gaze input, gesture input, and other user inputs (e.g., input received via a hardware input device, such as a mouse and/or a keyboard) that correspond to a selection of content. In response to receiving the user input, context module 904 identifies the selected content (e.g., a portion of text, a portion of a physical environment, and/or a portion of a virtual environment) as context information. As one example, context module 904 receives information from eye tracking device 806 and/or from eye tracking unit 804 indicating that the user's gaze is directed to a particular element (e.g., a physical or virtual element). Context module 904 implements recognition techniques known in the art to identify the gazed-at element and determines the identified element as context information. As another example, context module 904 receives information from hand tracking device 810 and/or from hand tracking unit 808 indicating that a user's gesture corresponds to a selection of a particular element. Context module 904 implements recognition techniques known in the art to identify the selected element and determines the identified element as context information. As yet another example, context module 904 receives information indicating that a cursor is positioned over a particular element, identifies the element, and determines the identified element as context information. In some examples, device 800 does not include eye tracking device 806 and/or eye tracking unit 804. In such cases, in some examples, device 800 processes sensor (e.g., camera and/or microphone) information to determine whether a user is facing device 800, to determine whether the user is facing device 800 while speaking, and/or to approximate a user's gaze location. In some examples, device 800 uses such determinations and/or approximations as context information. Accordingly, in examples where device 800 has limited or no gaze-tracking functionality, information determined from other sensor(s) of device 800 can serve as a proxy for (e.g., approximation for) gaze information.

Additional context can be used as input. For instance, image or video information may be utilized, for example, to capture a user's expressions, gestures, and/or other environmental information. For example, image or video information can be analyzed (e.g., using diffusion models, traditional image analysis, etc.) in order to determine a specific room size (e.g., area and/or volume), various objects within an environment (e.g., furniture, appliances, doors, windows, and/or plants), and various object properties (e.g., materials used in doors, walls, flooring, and/or upholstery). The image or video information can also be used to detect gestures such as head nods or shakes in order to identify affirmative or negative responses from the user. As another example, the image or video information may be analyzed in order to determine characteristics associated with the user, such as the clothing and/or accessories the user is wearing, the user's current pose, and the user's hair and/or eye color. Sensor device inputs may also provide additional context such as eye gaze direction, heart rate, and identification of other users or entities within an environment (e.g., based on devices the users are carrying and/or facial recognition). Various emotional states of the user may also be tracked based on context information such as facial recognition (e.g., general appearances of a user's facial expressions) and/or audio input (e.g., tone, stress, intonation, and other audio characteristics detected in a user's voice).

In some examples, context module 904 determines context information associated with multiple users. For example, eye tracking device 806 and eye tracking unit 804 are configured to concurrently track the respective gaze locations of multiple users and hand tracking device 810 and hand tracking unit 808 are configured to concurrently track the respective hand movements, hand gestures, and/or body poses of multiple users. Accordingly, in some examples, a digital assistant provides output 916 based on information associated with multiple users, e.g., a first user's gaze location and a different second user's gaze location and/or the first user's health information and the second user's health information.

In some examples, context module 904 determines context information based on a combination of a user inputs. For example, context module 904 determines relevant context information from inputs such as (1) a first gaze input at a particular element and a second natural language input such as “consider what I looked at” and (2) a first gesture input selecting a particular element and a second natural language input such as “consider what I selected”. More specifically, the digital assistant processes the natural language input in conjunction with sensor information to identify what a user looked at and/or selected, and then executes a task flow that instructs context module 904 to generate context information including the identified element.

In some examples, context module 904 provides a representation of the determined context information to tokenization layer 906. In some examples, context module 904 formats the representation according to a particular type of data structure (e.g., a hash table, a tree-type structure, a trie, or the like). In some examples, context module 904 provides the representation in natural language format. For example, context module 904 converts the context information from a predetermined structured data type into natural language text, e.g., “The user typically calls their mom around the current time. The user has a web browsing application open to cnn.com. The user has a notes application open and has typed ‘Tokyo trip’ into the notes application.” One of skill in the art will appreciate that providing the context information to tokenization layer 906 in natural language text format may reduce the amount of downstream processing that LLM unit 812 performs to handle a request, e.g., in examples where LLM unit 812 is trained to and/or optimized to operate on text inputs.

In general, text input 902 and the context representation obtained from context module 904 are provided to tokenization layer 906. Tokenization layer 906 converts both text input 902 and the context representation into one or more individual words, sub-words, tokens, or other specific units which are understandable to LLM 910. For instance, tokenization layer 906 may utilize various algorithms to convert text input 902 and the context representation into sub-units. The process of tokenization may reveal both frequently used and rarely used words by one or more users of computer system 800. Output from tokenization layer 906 may thus include a tokenized representation having one or more individual words, sub-words, tokens, or other specific units which reflect a combination of both the user's speech input and context representation provided by context module 904.

The output from tokenization layer 906 may then be fed to input embedding layer 908. In general, input embedding layer 908 converts the tokenized representation into a vector representation (e.g., an embedding). In some examples, the vector representation may be a continuous vector representation reflecting the semantic and syntactic meanings of both the user's speech input and the context representation. The vector representation is generally provided in a format that is recognizable or can otherwise be processed by LLM 910. For example, the user's speech input may include “tell me about this,” and the context representation may reflect the fact that the user is generally gazing at a displayed element, such as a picture of a tree. The vector representation may thus reflect an association between the ambiguous term “this” and the content which the user is currently viewing, specifically, the picture of a tree.

Generally, input embedding layer 908 passes the vector representation to LLM 910, which processes the vector representation in order to obtain LLM output 912. LLM 910 may include various neural network layers and other mechanisms, including one or more attention mechanisms, feed-forward layers, normalization, and residual connections to facilitate processing of the vector representation to obtain LLM output 912. Attention mechanisms serve to weight various aspects of the vector representation, which in turn allow LLM 910 to prioritize processing the most relevant portions of the embedding (e.g., particular words and/or phrases) and identify relationships between different portions of the embedding (e.g., dependencies between different tasks within a task list). Normalization layers and residual connections may assist LLM 910 with identifying main components of an input and generalizing concepts across different types of words, phrases, and context. Feed-forward layers transform an input into a new representation in order to identify patterns within the input embedding (e.g., focusing on general types of words or phrases when certain context is present). Moreover, LLM 910 may include multiple (Nₓ) iterations of processing using the components described herein. While FIGS. 9A-9B illustrate certain components of LLM 910, one of ordinary skill in the art will appreciate that certain components of LLM 910 are not illustrated. Such components are not illustrated for brevity and to avoid obscuring more pertinent aspects of the present disclosure.

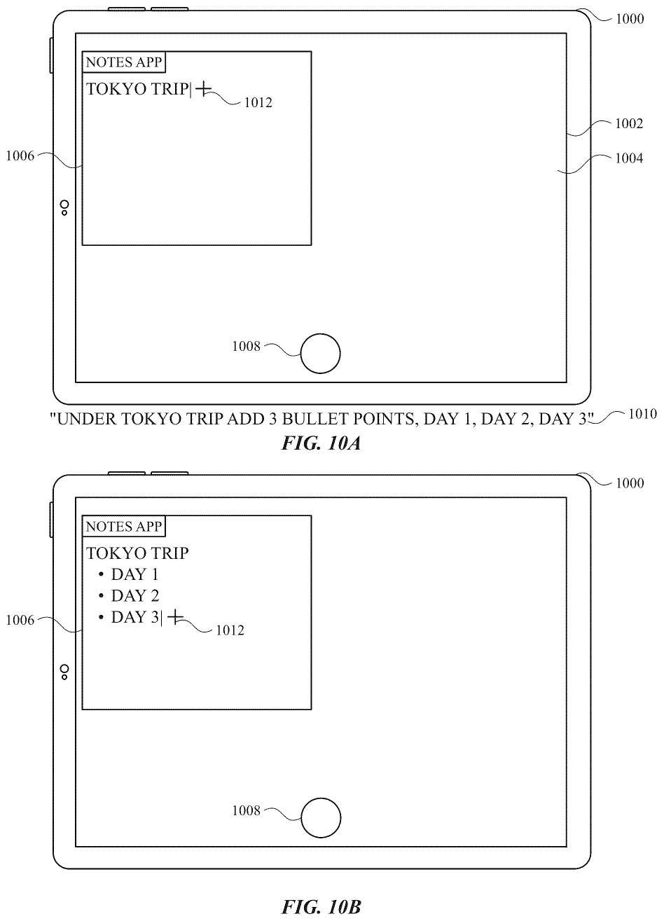

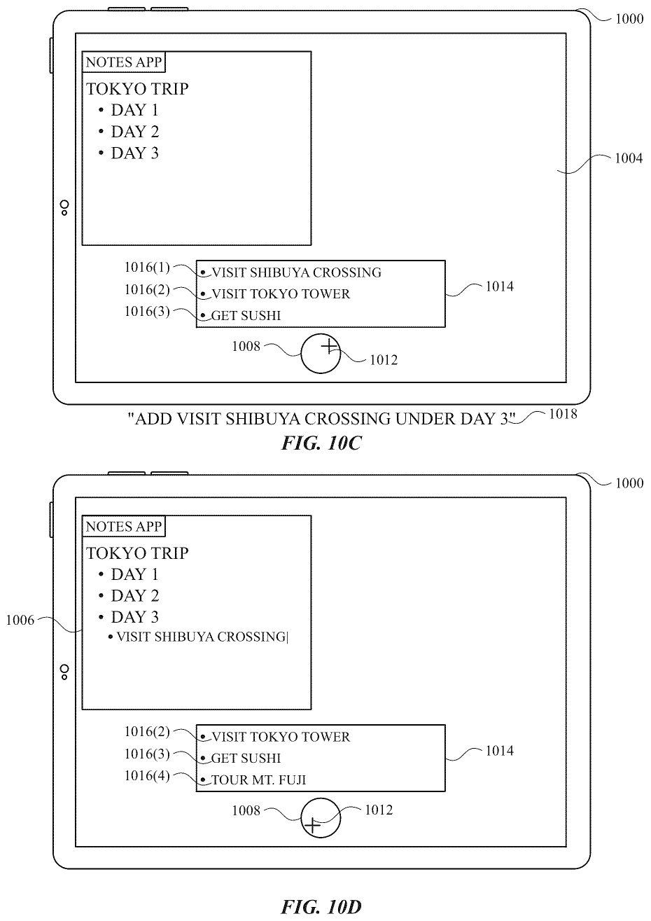

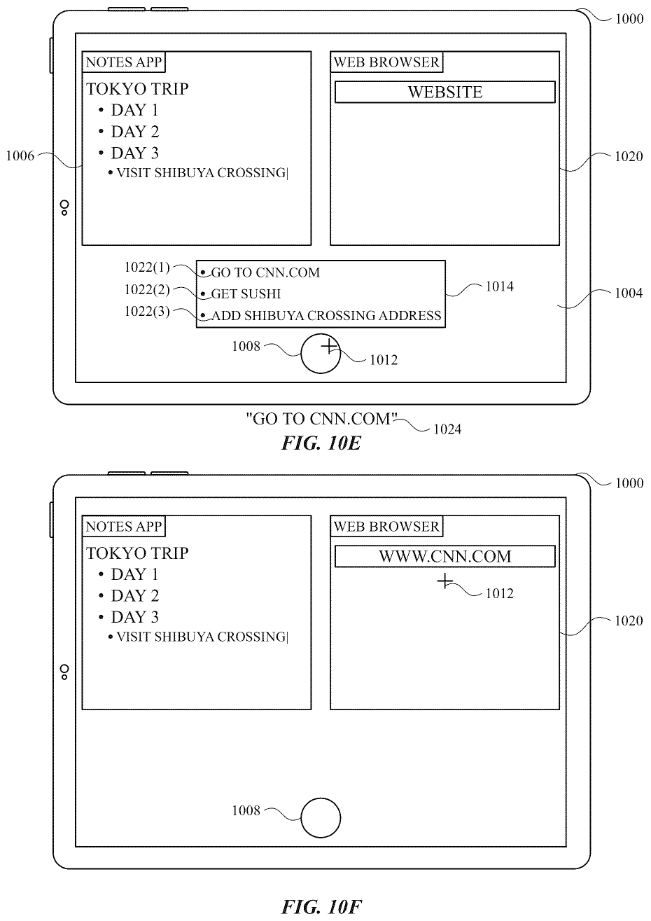

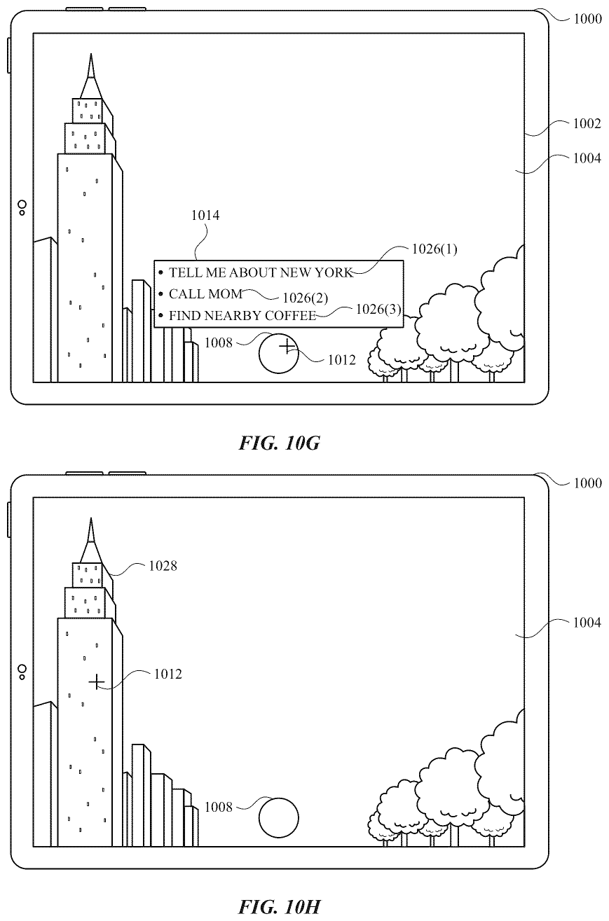

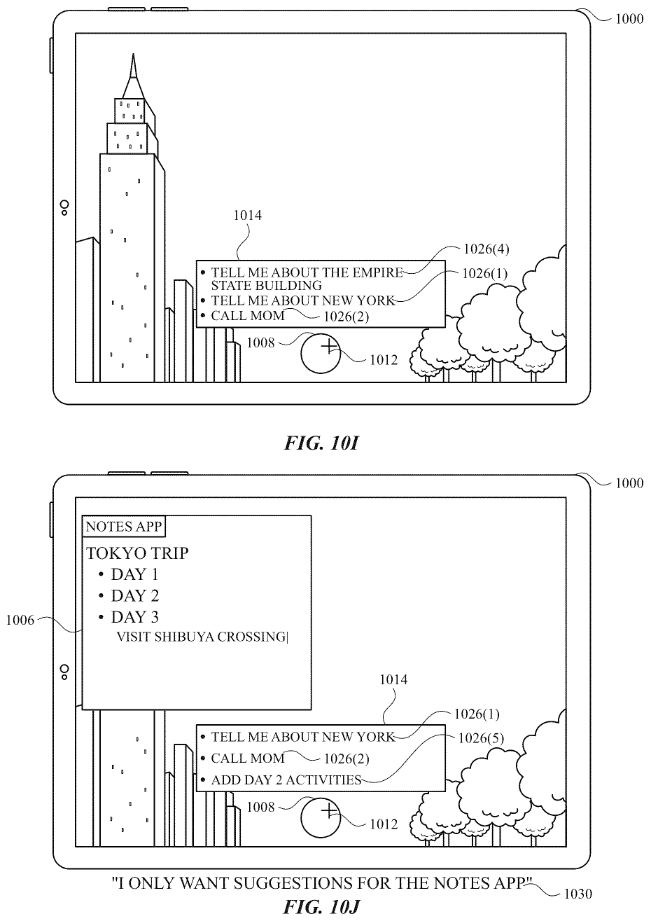

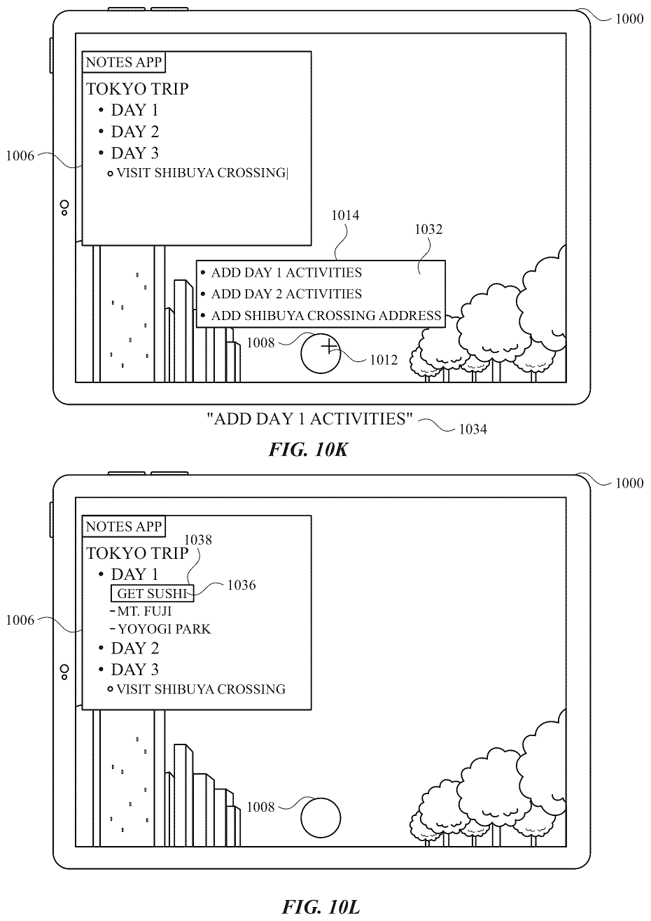

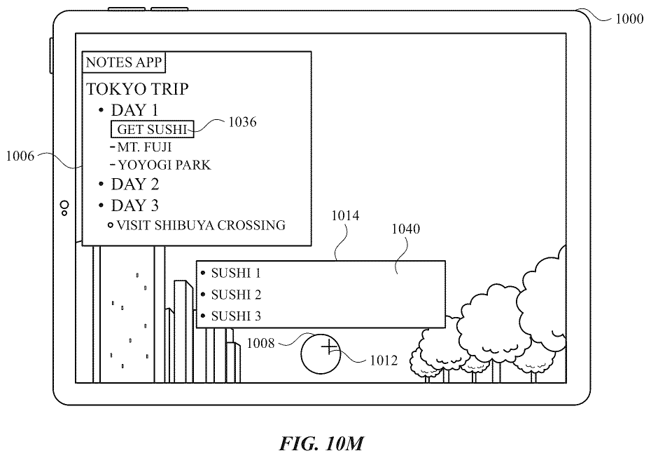

LLM output 912 may be provided in one or more formats, such as a textual representation, graphical representation, audio/video representation, and the like. For instance, LLM output 912 may include one or more tasks or commands in the form of a textual representation. In some cases, LLM output 912 represents a user intent that corresponds to text input 902. In some cases, LLM output 912 may include one or more suggestions to be provided to the user. For example, as described in more detail with respect to FIGS. 10A-10M, the user may be provided with various suggestions based on information provided from context module 904 (and optionally, in the absence of speech input). LLM output 912 can also provide further contextual information for task flow processing, such as whether the user's speech input (reflected via text input 902) corresponds to a specific type of request. As an example, LLM output 912 may include a classification type corresponding to the user's input, such as a request to create a narrative (e.g., narrative classification), a request to create a picture and/or video representation (e.g., graphical classification), and the like.

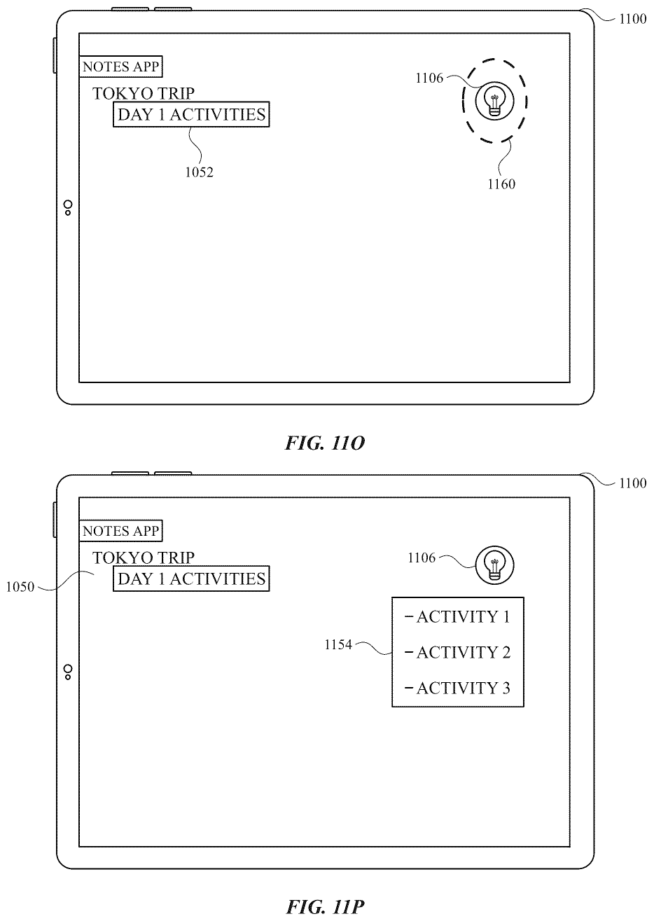

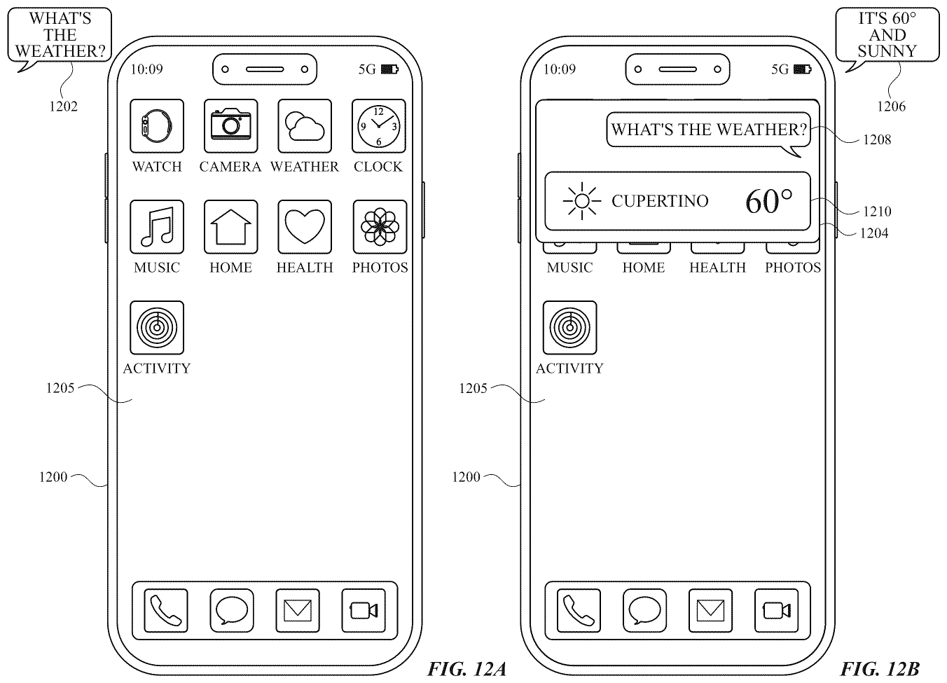

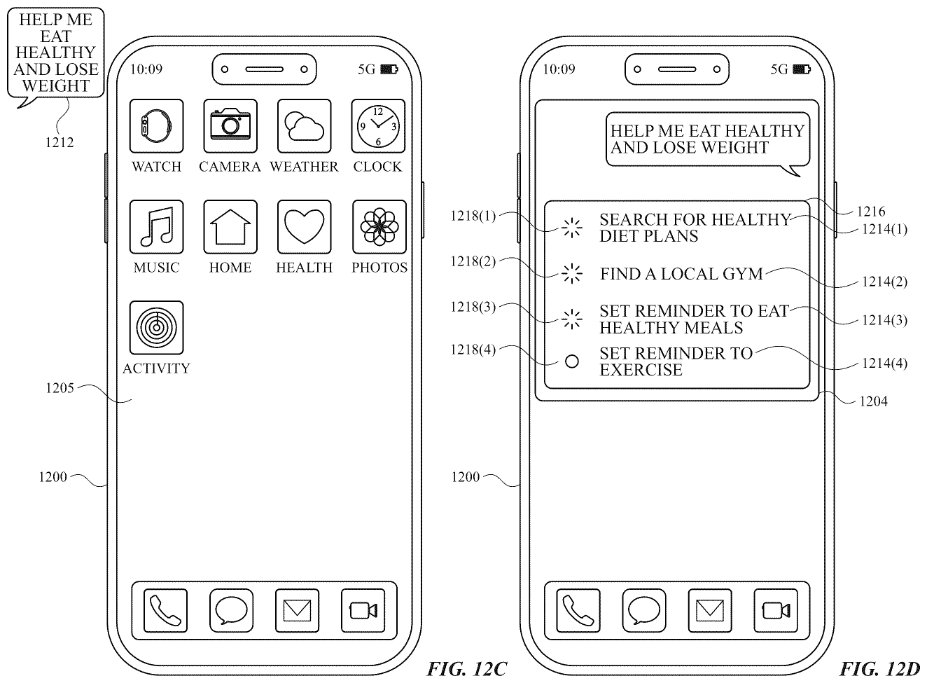

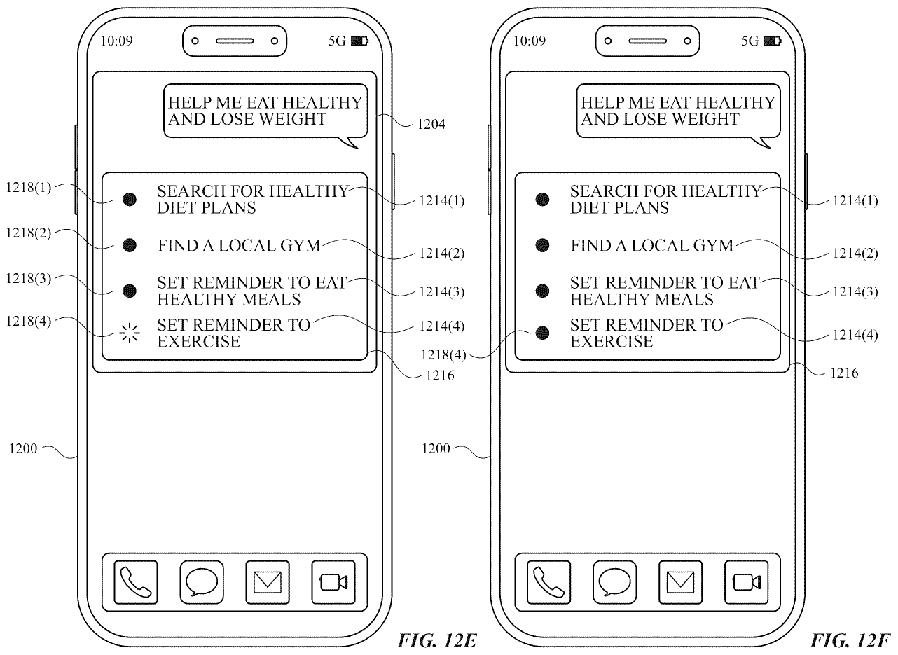

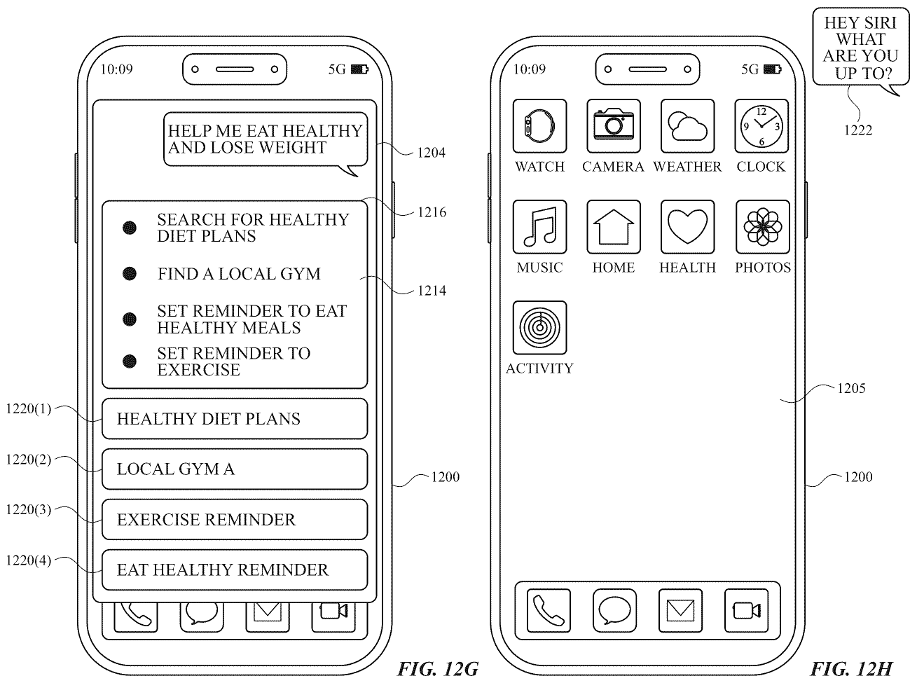

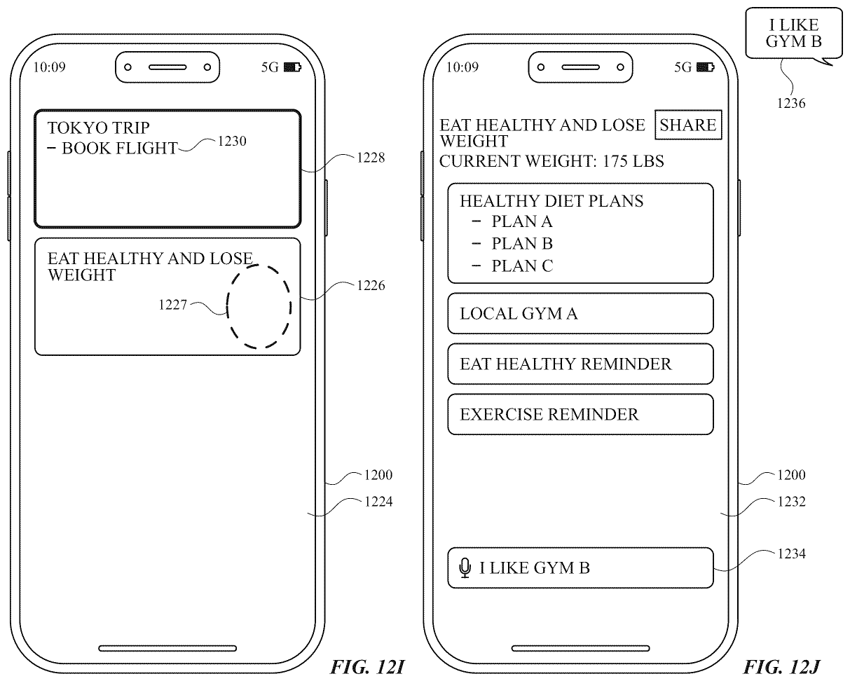

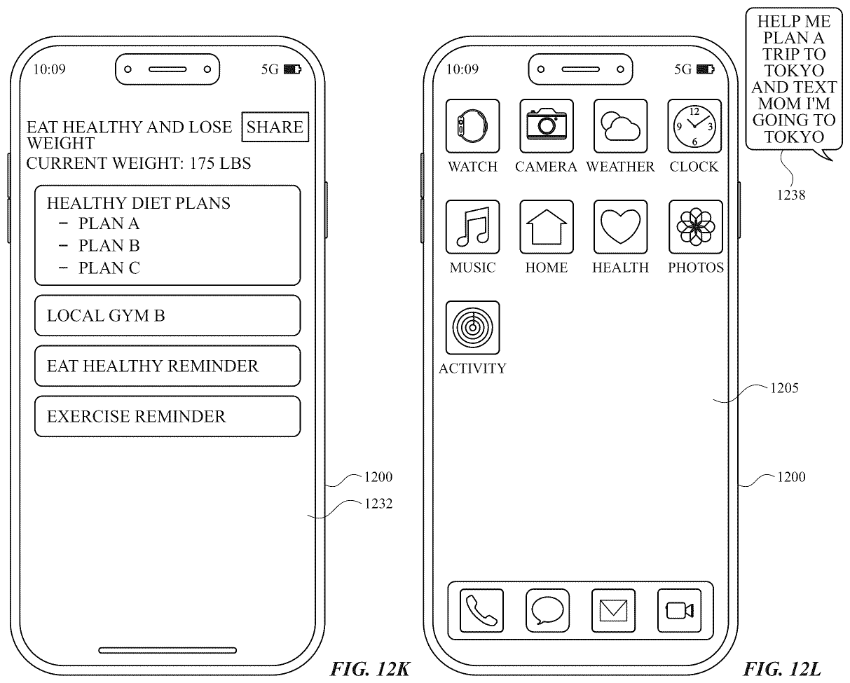

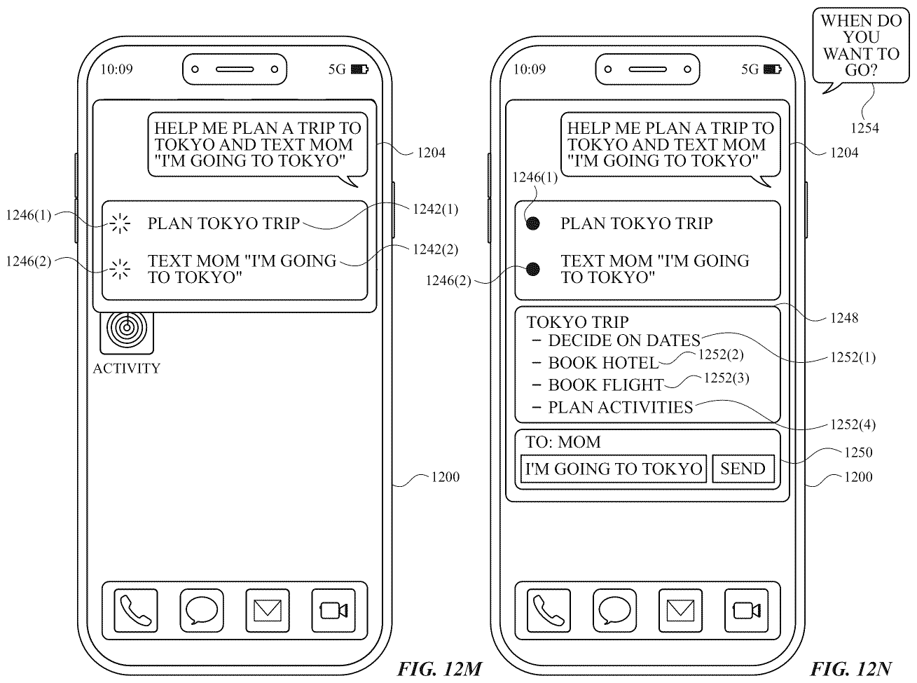

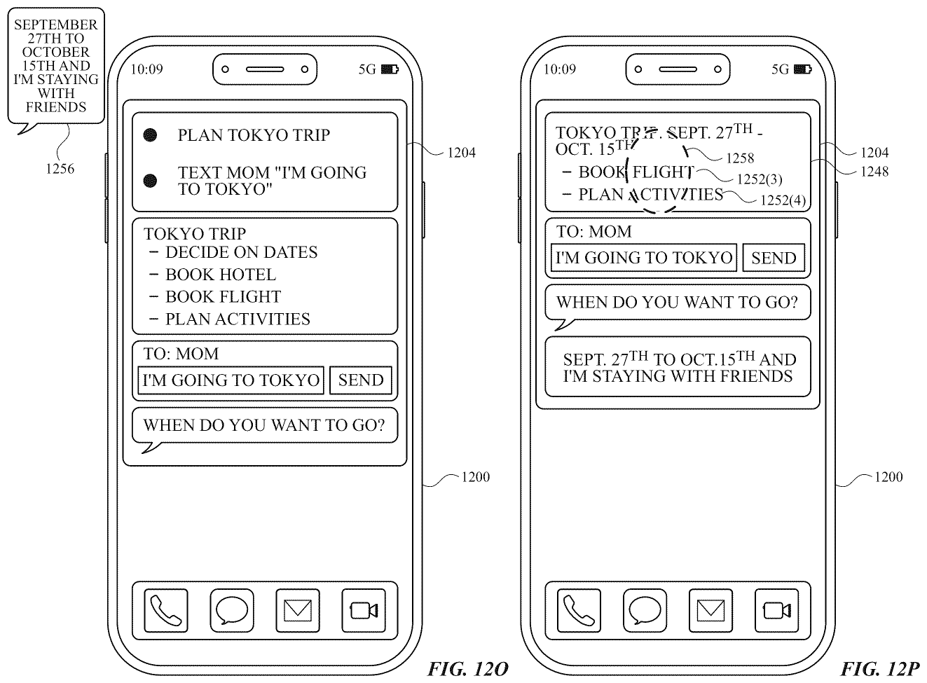

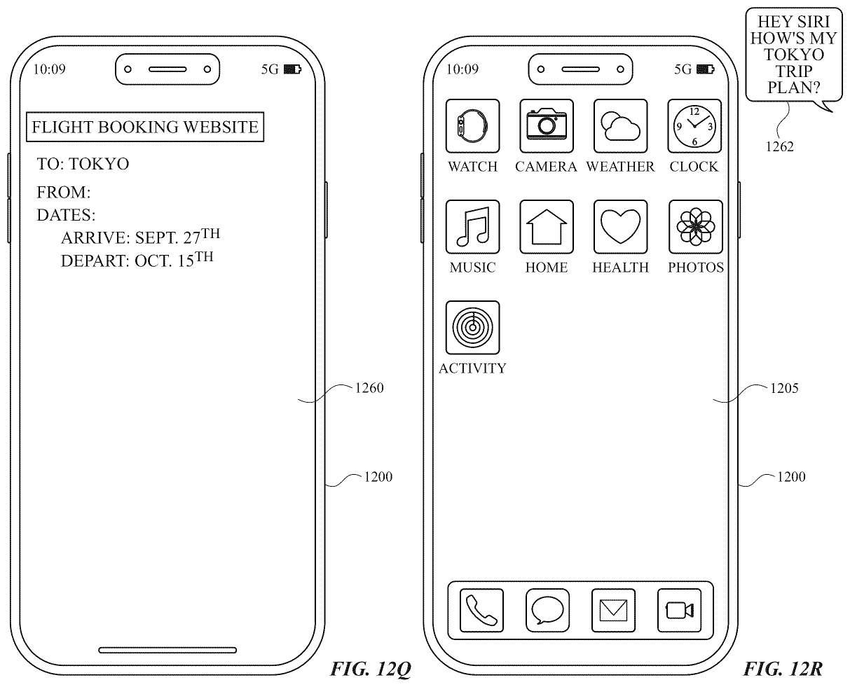

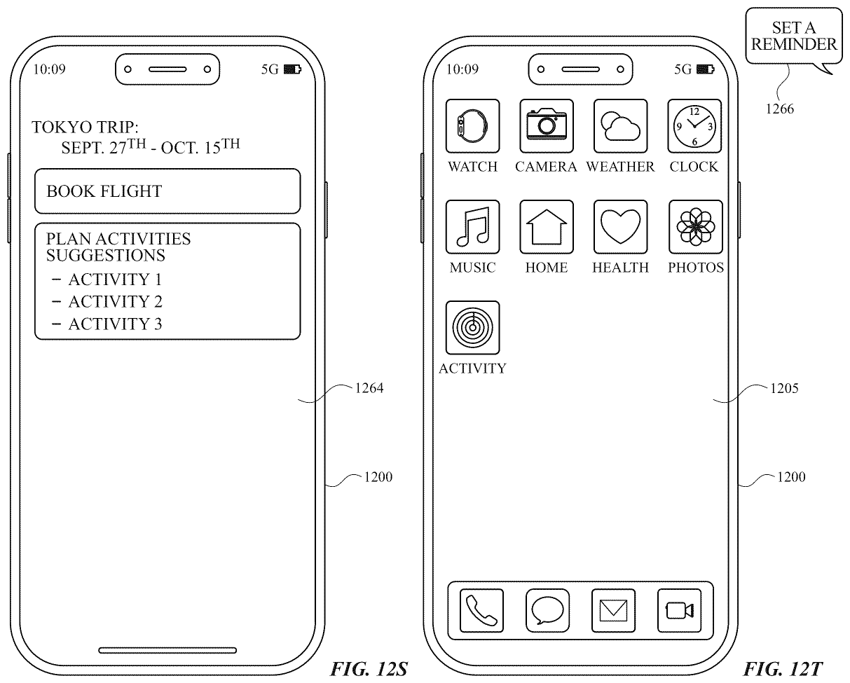

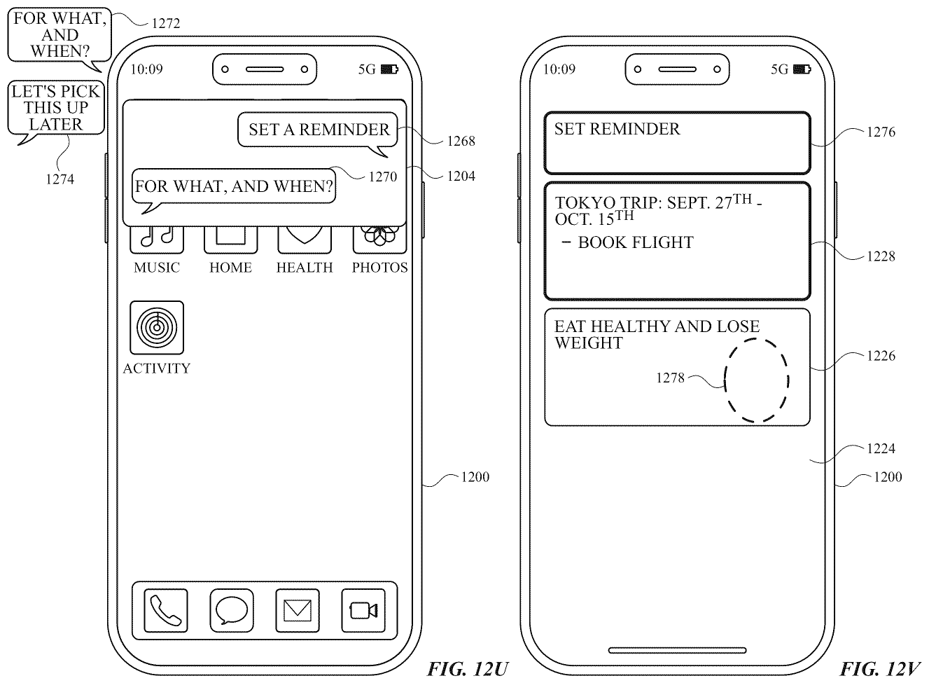

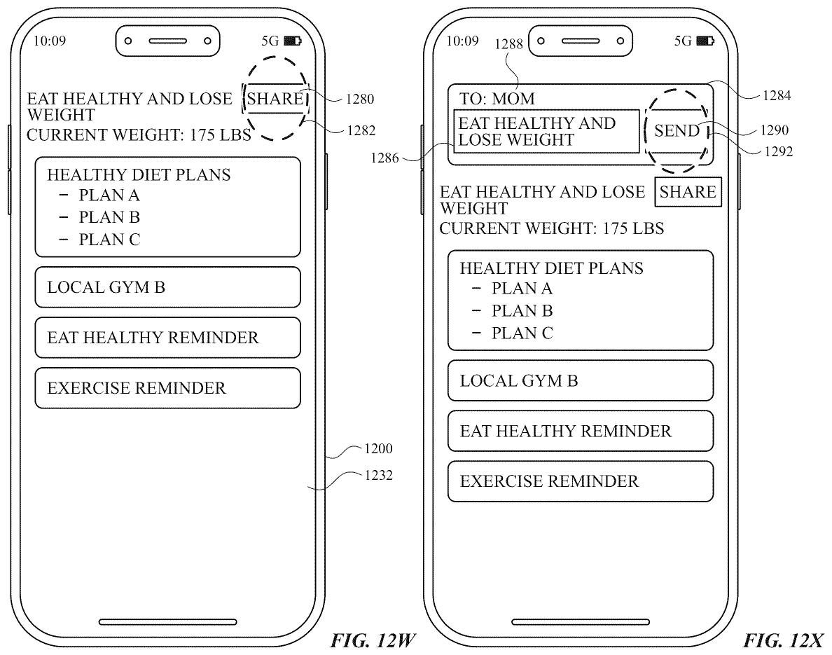

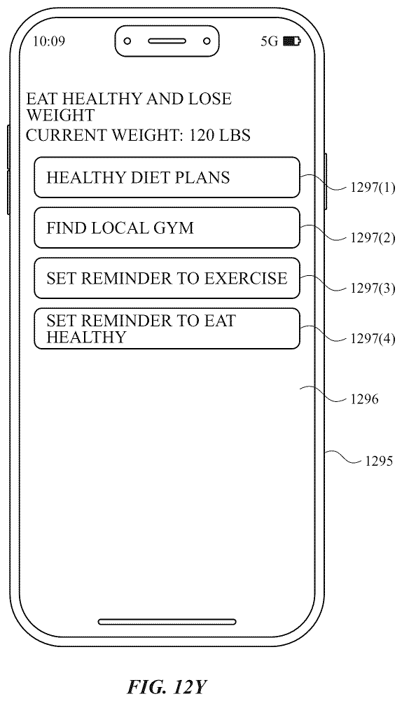

In some examples, the classification type included in LLM output 912 indicates whether a user request (e.g., represented by input embedding 908) corresponds to a request to initiate a plan. For example, LLM 910 is trained to classify an input as a request to initiate a plan (a planning request) or as not a request to initiate a plan (a non-planning request). Generally, a plan includes, at least initially, one or more tasks suggested by the computer system 800 for completion of the plan. Non-limiting examples of planning requests include a request to plan a vacation (e.g., “help me plan a trip to Tokyo”), a request for an exercise plan (e.g., “help me run a 6 minute mile”), a request for a diet plan (e.g., “help me eat healthier”), a request to plan an event (e.g., “help me plan Thanksgiving dinner”), a request to learn about a topic (e.g., “help me learn calculus”), a request for self-improvement (e.g., “help me have more energy and improve my mood”), and other requests to achieve a user-specified goal. Computer system 800 interprets such planning requests as requests to generate respective suggestion(s) associated with the plan, e.g., suggestions for steps/tasks associated with planning a trip to Tokyo or suggestions for steps/tasks associated with running a mile in 6 minutes or less. In contrast, a non-planning request does not involve generation of suggested task(s) associated with a plan. Non-limiting examples of non-planning requests include a request for certain types of information (e.g., sports information, weather information, the news, and/or encyclopedia information) and requests for computer system 800 to perform certain tasks (e.g., to control a home automation device, to perform a calculation/conversion/translation, to launch an application, to set a timer/alarm/reminder, to play media, to message/call a particular person, to navigate to a requested location, and the like). Whether a particular request is classified as a planning request or as a non-planning request can depend on the particular implementation of LLM 910 (e.g., depend on the architecture of LLM 910, depend on the data used to train LLM 910, and/or depend on the particular techniques used to train LLM 910). As described below with respect to FIGS. 12A-12Y, in some examples, computer system 800 performs different actions responsive to a request depending on whether it is classified as a planning request or as a non-planning request. Accordingly, in some examples, planning requests and non-planning requests are distinguished by the differing actions computer system 800 performs in response to receiving the respective request.

LLM output 912 is then passed to task flow module 914 which performs various functions to satisfy the commands. Task flow module 914 may also determine that additional information is needed in order to satisfy the commands, such that task flow module 914 passes one or more output representations back to input embedding layer 908. In some examples, the output from task flow module 914 may first be passed to tokenization layer 906, or alternatively, may be passed directly to LLM 910 (e.g., depending on the format of the output from task flow module 914). Task flow module 914 may cause one of more outputs 916 to be provided at the end of processing or throughout processing (e.g., displayed outputs, audible outputs, haptic outputs, and the like).

In some examples, in computer system 800, digital assistant system 700 at least partially implements LLM unit 812 to assist with processing a natural language input. In some examples, in computer system 800, certain components/functions of LLM unit 812 replace or supplement analogous components/functions of digital assistant system 700. As one example, natural language processing module 732 implements (or is at least partially replaced by) LLM 910, as LLM 910 is similarly configured to accept a representation of a user request and to provide LLM output 912 that represents a corresponding user intent. As another example, context module 904 provides the context information that natural language processing module 732 uses to interpret a user request. As another example, task flow module 914 is implemented within task flow processing module 736 to coordinate the task(s) performed to satisfy a user request and/or to coordinate the manner in which the digital assistant responds to a user request. A person of ordinary skill in the art will appreciate that various other combinations and/or replacements of the components/functions of digital assistant system 700 with the components/functions of LLM unit 812 are possible. Accordingly, the specific manner in which digital assistant system 700 incorporates LLM unit 812 can vary across different examples of the present disclosure, and in some cases, depends on the hardware, software, and/or firmware used for digital assistant system 700.

By way of example, an initial speech input may be received from a user of computer system 800, such as “Go to this site and send the main story to John.” While the user provides the speech input, the user may be looking at a specific bookmark being displayed (e.g., on the user's mobile phone, on the user's head-mounted display, etc.). The specific bookmark, for example, may include “BestNews.com.” Thus, text input 902 may correspond to the user's transcribed speech input, whereas the output from context module 904 may include an identifier (e.g., a hyperlink) to “BestNews.com” based on determination that the user is gazing at the bookmark. Based on the input context and speech content, a plurality of tasks are determined. In this example, the plurality of tasks may include: (1) Navigate to “BestNews.com” using web browser application, (2) Identify link to headline story on “BestNews.com” within web browser application, (3) Lookup John's contact information in contacts application, (4) Compose message to John's contact identifier including link to identified headline story, and (5) Send composed message.

Once the task(s) are determined, each task is assessed as to whether the task satisfies management criteria. Management criteria may generally correspond to criteria needed to determine whether computer system 800 can perform the task. Assessment of task management criteria may be performed in multiple ways. Prompt engineering may be used in order to determine applications and application programming interfaces on computer system 800, as well as other functionality available on computer system 800 and/or available to computer system 800 (e.g., via one or more remote servers, additional devices, etc.). For example, the task “(1) Navigate to ‘BestNews.com’ using web browser application” is determined to be manageable given that computer system 800 has an application corresponding to a web browser. In some examples, LLM model tuning is used to determine capabilities of computer system 800 (e.g., applications and available API). Specifically, a task-specific dataset may be applied to LLM 910, such that the LLM architecture and LLM parameters are optimized in order to handle requests directed to a specific domain or area of interest (e.g., trip planning, cooking, scholarly research, social media interactions, etc.). The fine-tuned LLM may then be used to assess system capabilities. Tasks satisfying the management criteria are then be added to an ordered task list. Any tasks not satisfying the management criteria may be subject to additional follow-up. For instance, the user may be prompted to modify the task request and/or provide additional information in order to facilitate proper processing of the task (e.g., the user may be prompted “Did you mean BestNewsPage.com?”).

Each task of the ordered task list may include various task dependency criteria. In general, the task dependency criteria may indicate which (if any) tasks must be performed prior to a respective task being performed. For example, in order to perform the fourth task “(4) Compose message to John's contact identifier including link to identified headline story,” the second task “(2) Identify link to headline story on ‘BestNews.com’ within web browser application” must first be performed. Likewise, in order to perform the second task “(2) Identify link to headline story on ‘BestNews.com’ within web browser application” the first task “(1) Navigate to ‘BestNews.com’ using web browser application” must first be performed. Generally, tasks that are dependent on the performance of other tasks within the ordered task list may be referred to as synchronous tasks, whereas tasks that are not dependent on the performance of any other tasks within the ordered task list may be referred to as asynchronous tasks.

Certain tasks may be performed concurrently with other tasks. Specifically, asynchronous tasks may be performed concurrently to other asynchronous and synchronous tasks. In this example, the third task “(3) Lookup John's contact information in contacts application” is an asynchronous task. The third task thus may be performed at any time, such as being performed concurrently with the first task “(1) Navigate to ‘BestNews.com’ using web browser application.” Various synchronous tasks may be performed in-part or otherwise partially performed while the result from dependent tasks is pending. For example, the fourth task “(4) Compose message to John's contact identifier including link to identified headline story” may be partially performed after the third task, such that a message with “To:” field is populated with the appropriate contact information is generated. The message may include a blank subject field that may be further modified once the result of the second task “(2) Identify link to headline story on “BestNews.com” within web browser application” is retrieved. The ordered task list with the task dependency criteria thus assists task flow module 914 with optimizing task flow processing.

As tasks within the ordered task list are performed, context information may be accumulated and used for optimized task performance. For example, the user may request a local dinner reservation for four specific people along with a request to send the reservation confirmation to the attendees. While performing the ordered task list, a determination is made that there are two locations for the respective restaurant that are generally reachable by the user (e.g., within 10 miles). Context information regarding each restaurant may then be gathered in order to determine whether additional follow-up with the user is needed. For example, the additional context information may include restaurant ratings, reservation availability, the user's preference regarding either location, and the like. To the extent a determination cannot be made as to which restaurant the user intends to dine at, an additional task can be created (e.g., “Provide prompt to user asking whether the user prefers to dine at Restaurant X or Restaurant Y). The additional task can then be inserted into the ordered task list at the appropriate slot based on any relevant task dependency criteria.

As described in more detail with respect to FIGS. 12A-12Y, various audible, visible, and haptic feedback mechanisms may be employed in order inform the user of the progress in completing the ordered task list. In general, a representation of the ordered task list may be presented to the user once the ordered task list is determined. As various tasks are performed, the representation is updated to reflect tasks currently being performed and/or tasks which have been completed. Indicators may reflect one or more tasks currently being performed (e.g., a spinning wheel). In some examples, a progress bar or progress wheel may indicate a percentage or approximate amount of task completion for a particular task. For instance, a particular task may include four discrete sub-tasks, such that a progress wheel may be displayed as half full when two of the four sub-tasks have been completed. The task information may be provided in one or more additional formats, such as picture or video format. As an example, with respect to the task “(2) Identify link to headline story on ‘BestNews.com’ within web browser application,” a thumbnail representation (e.g., a small picture and a brief headline description) of the headline story on “BestNews.com” may be provided proximate to the second task representation within the interface displaying the ordered task list.

The user may also interact with individual tasks displayed in the ordered task list representation. The user may select a displayed representation corresponding to a displayed task, such as the third task “(3) Lookup John's contact information in contacts application.” For instance, the user may tap on a touch-sensitive display or perform one or more gestures (e.g., air gestures) while using a head-mounted device with gaze-tracking capabilities. Selection of the displayed task representation may result in one or more sub-tasks being displayed. In some cases, the user may modify one or more task parameters after selecting a displayed task representation. In this example, selecting the displayed task representation may cause an option to be displayed to change the contact referred to by the user (e.g., the user may change the intended contact from “John” to “Jane”).

In some cases, the user may be interacting with a non-display-based device, such as a home speaker or earbuds communicatively coupled to a smart phone. In these examples, instead of display-based outputs, audible outputs may be provided to a user. For example, the user may utter “Go to BestNews.com and send the main story to John.′ A corresponding task list may thus include: (1) Navigate to “BestNews.com” using web browser application, (2) Identify link to headline story on “BestNews.com” within web browser application, (3) Lookup John's contact information in contacts application, (4) Compose message to John's contact identifier including link to identified headline story, and (5) Send composed message. Optionally, given the non-display-based nature of the interaction, additional tasks may be included, such as “Provide user with message read-out,” “Confirm with user whether to transmit message,” etc.

5. Incorporating Large Language Models into a Digital Assistant System to Provide Suggestions

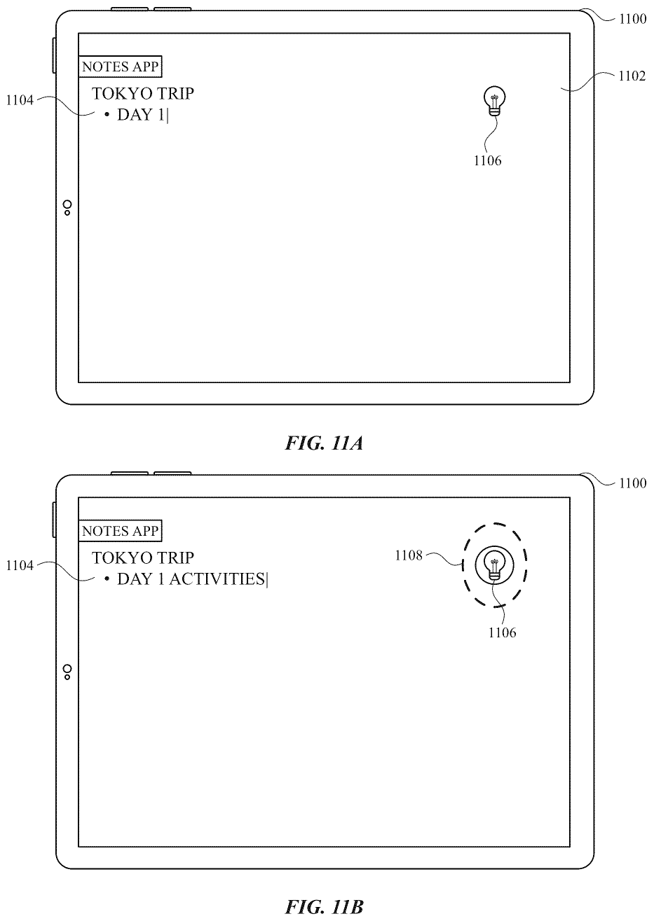

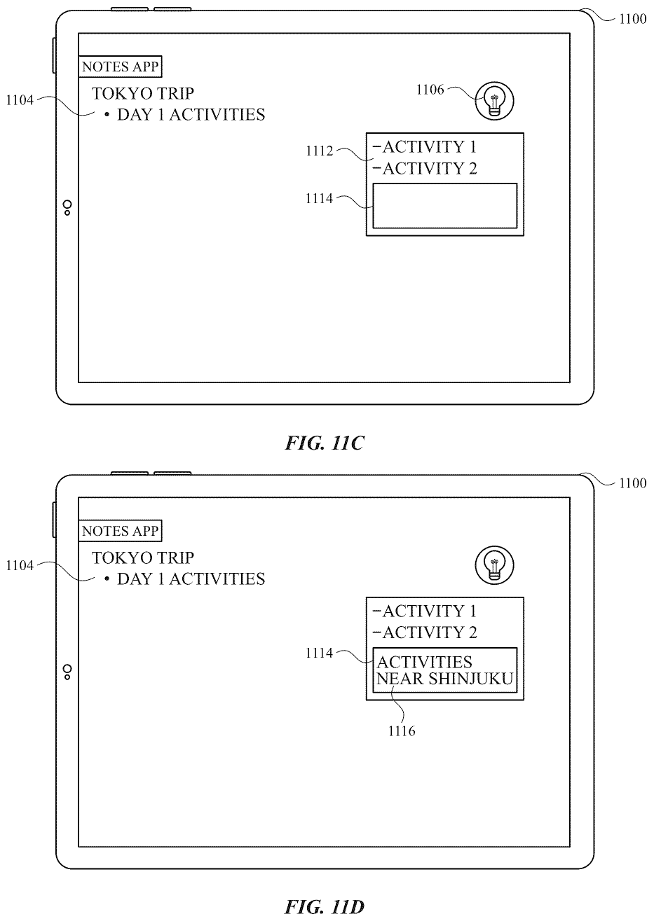

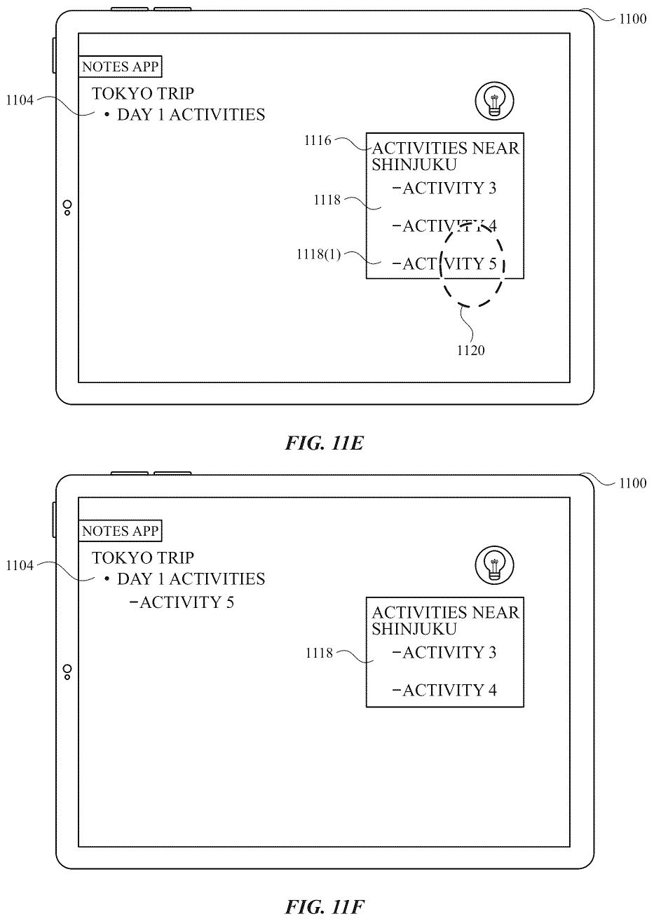

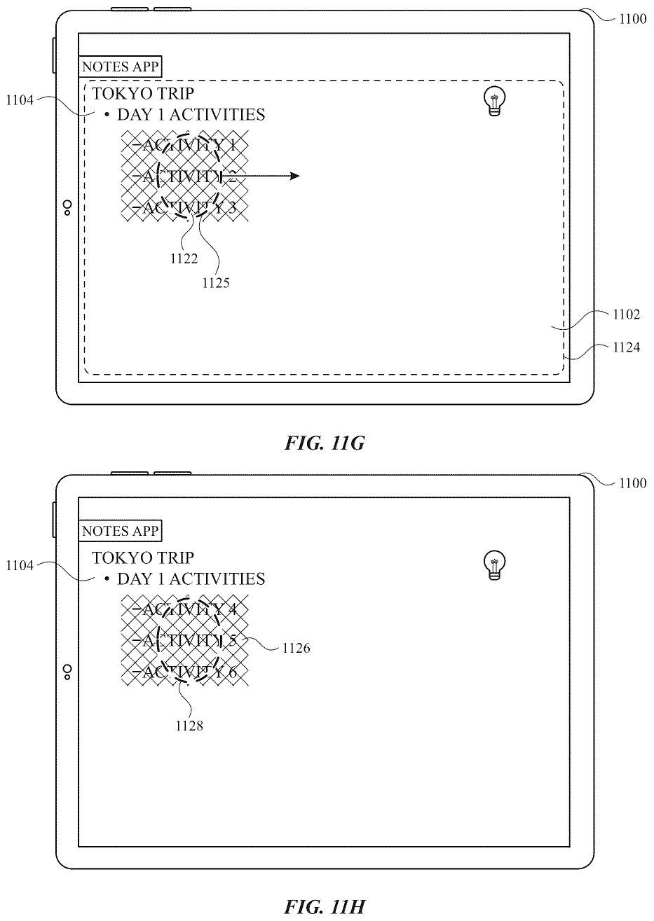

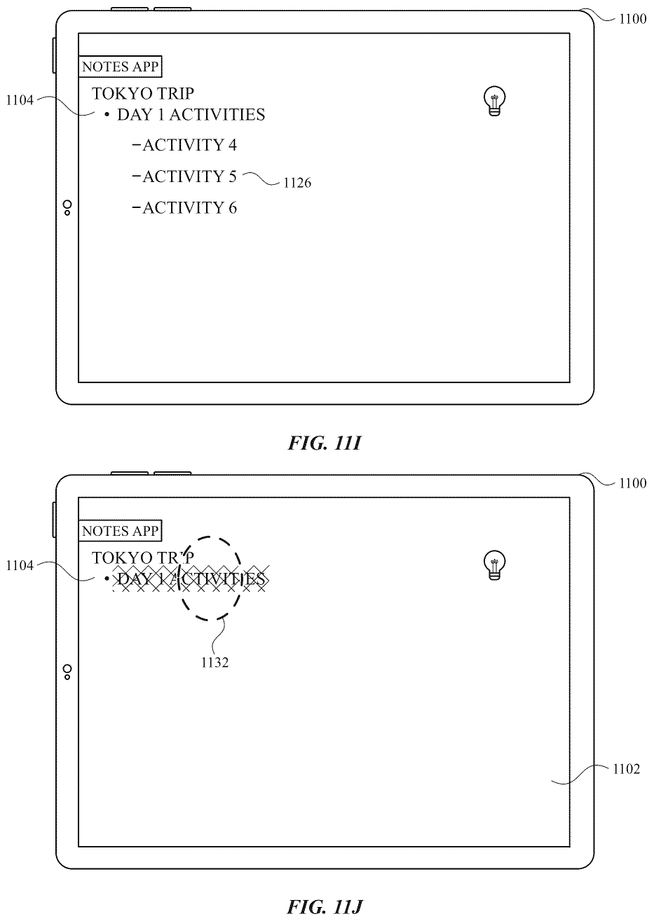

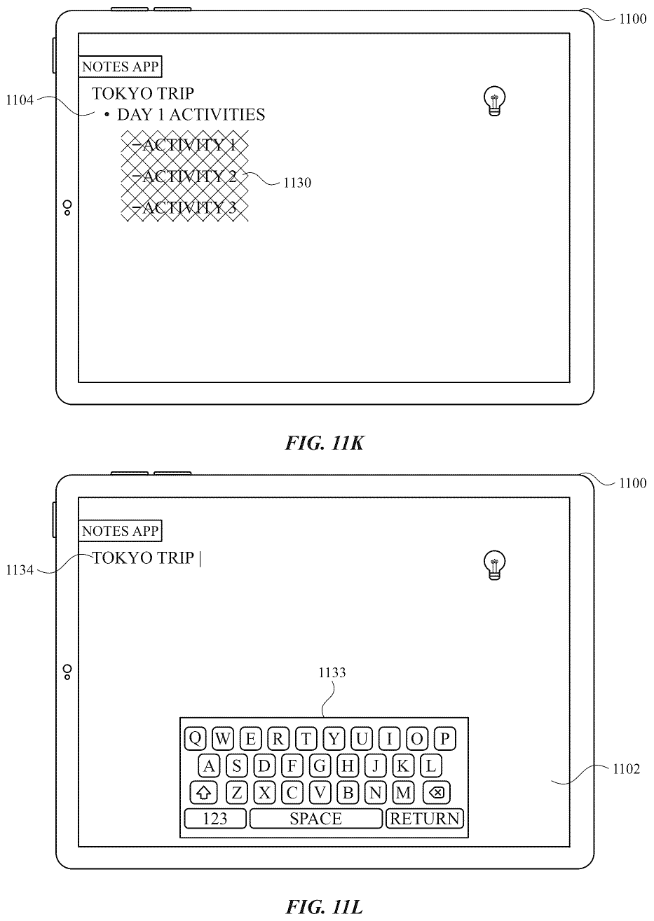

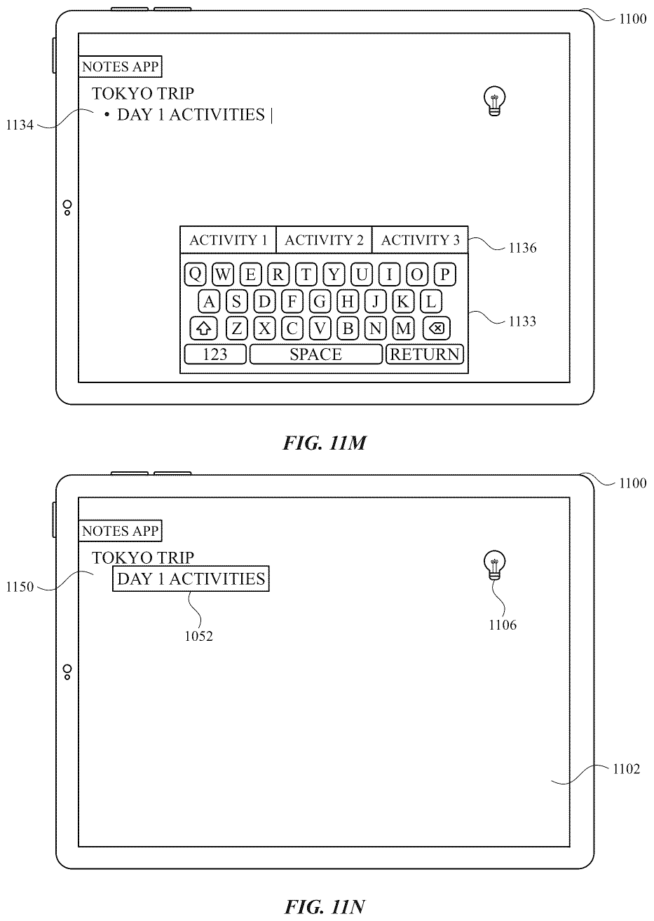

FIGS. 10A-10M and 11A-11P illustrate techniques for providing suggestions, according to various examples.

While some of the examples in FIGS. 10A-10M below include providing suggestions based on detection of a user's gaze, in other examples, device 1000 provides suggestions without relying on user gaze to trigger the presentation of the suggestions. As one example, device 1000 provides suggestions according to the techniques discussed herein in response to determining a lack of user activity associated with the device for a predetermined duration, e.g., 3, 4, or 5 seconds. Device 1000 determines a lack of user activity based on not receiving user input, e.g., certain types of user input such as speech input, touch input, gesture input, input corresponding to movement of device 1000, peripheral device (e.g., keyboard, joystick, and/or mouse) input, and/or device hardware input (e.g., a button press). In some examples, device 1000 ceases to provide the suggestions in response to detecting a threshold amount of user activity associated with the device. In some examples, device 1000 provides suggestions whenever device 1000 is powered on (e.g., displaying content). In some examples, device 1000 implements a process to proactively provide suggestions, e.g., to provide suggestions without receiving explicit user input that requests the suggestions. For example, LLM unit 812 generates suggestions based on context information determined by context module 904 and device 1000 presents a suggestion in response to a determination that the score of the suggestion exceeds a threshold. In some examples, device 1000 displays suggestions in response to detecting that device 1000 is currently receiving spoken and/or typed input. In some examples, one or more settings of device 1000 control the condition(s) that trigger the presentation of suggestions.

In FIG. 10A, device 1000 provides content 1004 via display 1002. Device 1000 at least partially implements the components of computer system 800. In examples illustrated in FIGS. 10A-10M, device 1000 is implemented as a tablet device. In other examples, device 1000 is implemented as another type of electronic device.

Content 1004 includes physical content and/or virtual content. For example, content 1004 includes pass-through video of a physical environment (e.g., video of the physical environment that is captured by image sensor(s) of device 1000 and that is shown on display 1002), virtual content displayed by display 1002, and/or a physical environment directly viewed by a user via display 1002 (e.g., in examples where display 1002 is at least partially transparent or semi-transparent to allow light emanating from the physical environment to pass though and reach the user's eyes). In FIG. 10A, content 1004 includes user interface 1006 of a notes application, e.g., a document/text editing application. User interface 1006 includes the user-inputted text “Tokyo trip.”

In FIG. 10A, device 1000 displays graphical object 1008. Graphical object 1008 represents a digital assistant (DA) or represents another function of device 1000. In some examples, the display of object 1008 indicates that a DA session is initiated. For example, when device 1000 displays object 1008, the digital assistant is an active application and when device 1000 does not display object 1008, the DA is a background application or a closed application. In some examples, to initiate a request to the DA, device 1000 receives natural language input in conjunction with user input corresponding to a selection of object 1008. For example, device 1000 receives a gaze input directed to object 1008 (and/or a gesture input that selects object 1008) and receives natural language input. In response to receiving the gaze input (and/or the gesture input) and the natural language input, the DA initiates a task requested by the natural language input.

While the examples of FIGS. 10A-10M shows that graphical object 1008 represents the DA, device 1000 can represent a DA and/or an initiated DA session in other manners. For example, a graphical element that enables user input (e.g., a text and/or spoken input entry field) represents the DA and the graphical element changes appearance (e.g., moves, changes color, and/or glows) to indicate an initiated DA session. As another example, device 1000 itself (or a particular area of device 1000 (e.g., a display)) represents the DA and the device 1000 (and/or the particular area) provides output (e.g., device 1000 starts to glow) to indicate an initiated DA session. Accordingly, while some examples herein describe providing suggestions based on detecting a user's gaze at graphical object 1008, in other examples, device 1000 provides suggestions based on detecting a user's gaze at another element, e.g., gaze at device 1000 itself, gaze at a particular area of device 1000, and/or gaze at a text input entry field.

FIG. 10A shows gaze indicator 1012. Gaze indicator 1012 marks a current detected location of the user's gaze. In some examples, device 1000 does not display gaze indicator 1012, but FIGS. 10A-10M show gaze indicator 1012 to more clearly explain relevant features. In other examples, device 1000 displays gaze indicator 1012 to inform a user that device 1000 detects their gaze at a particular location.

In FIG. 10A, the user's gaze is currently directed to user interface 1006, and not directed to object 1008. As discussed below, in some examples, in response to detecting that the user's gaze is directed to object 1008, device 1000 generates and displays suggestions (e.g., in suggestions object 1014 in FIG. 10C) based on context information. In FIG. 10A, because the user's gaze is not currently directed to object 1008, device 1000 forgoes generating and displaying suggestions.

In FIG. 10A, device 1000 receives speech input 1010 “under Tokyo trip add three bullet points, day 1, day 2, and day 3.” In response to receiving speech input 1010, device 1000 determines that speech input 1010 corresponds to a command to edit the content of user interface 1006 and includes the dictated text “day 1, day 2, and day 3.” In FIG. 10B, device 1000 performs the corresponding tasks to modify user interface 1006 to include three bullet points under “Tokyo trip” that are respectively titled “day 1,” “day 2,” and “day 3.”

In FIG. 10C, device 1000 detects that the user's gaze is directed to object 1008. In response to detecting that the user's gaze is directed to object 1008, device 1000 displays suggestions object 1014. Suggestions object 1014 includes suggestions 1016 (i.e., suggestions 1016(1), 1016(2), and 1016(3)) determined based on context information associated with content 1004. Device 1000 determines suggestions 1016 according to the techniques discussed above with respect to FIG. 8 and FIGS. 9A-9B. More specifically, in response to detecting the user's gaze at object 1008, context module 904 determines currently relevant context information (e.g., relevant at the time the user gazes at object 1008) and LLM unit 812 generates text input 902 such as “provide relevant suggestions” or “provide suggestions relevant to this context information.” LLM unit 812 processes the context information and text input 902 according to the techniques described with respect to FIGS. 9A-9B to generate LLM output 912 that includes suggestions 1016. In the present example, suggestions 1016 include activities to do in Tokyo because the context information includes the notes application, e.g., includes the text “Tokyo trip” inputted into the notes application.

In some examples, device 1000 generates and/or displays suggestions (e.g., 1016, 1022, 1026, 1032, and 1040) in response to detecting the user's gaze at object 1008 if one or more criteria are satisfied, e.g., satisfied by device 1000. If the one or more criteria are not satisfied, device 1000 does not display suggestions when the user gazes at object 1008. As one example, device 1000 includes a setting that allows a user to select to display suggestions when the user gazes at object 1008. A criterion is satisfied if the setting is enabled and the criterion is not satisfied if the setting is disabled. As another example, a criterion is satisfied if the DA is an active application (e.g., as indicated by display of object 1008) and the criterion is not satisfied if the DA is not an active application, e.g., is a background application, is a suspended application, or is a closed application. As another example, a criterion is satisfied if device 1000 is a predetermined type of device (e.g., a device having gaze tracking capability) and is not satisfied if device 1000 is not the predetermined type of device (e.g., a device without gaze tracking capability). As another example, a criterion is satisfied if device 1000 displays a user interface of a predetermined application (e.g., document editing application and/or a web browsing application) when device 1000 detects the user's gaze at object 1008 and the criterion is not satisfied if device 1000 does not display the user interface of the predetermined application when device 1000 detects the user's gaze at object 1008. As another example, a criterion is satisfied if device 1000 detects that at least predetermined duration (e.g., 2, 3, 4, or 5 seconds) has elapsed since device 1000 last detected the user's gaze at object 1008 and the criterion is not satisfied if device 1000 detects that the predetermined duration has not elapsed since device 1000 last detected the user's gaze at object 1008. Operating device 1000 in such manner may advantageously prevent device 1000 from continuously re-generating and/or re-displaying suggestions while the user maintains their gaze at object 1008. Operating device 1000 in such manner may also maintain the displayed suggestions if the user ceases to gaze at object 1008 and then re-gazes at object 1008 within a short duration.

While FIG. 10C shows that suggestions object 1014 includes three suggestions 1016, the number of suggestions 1016 in suggestions object 1014 can vary. For example, device 1000 predefines the number (e.g., 3, 4, or 5) of suggestions 1016 included in suggestions object 1014 or device 1000 includes a user-configurable setting to specify the number of suggestions to include in suggestions object 1014. In some examples, LLM unit 812 scores each of the suggestions 1016 based on determined relevance to the current context. In some examples, device 1000 includes the n-best (e.g., top 2, 3, 4, or 5) suggestions 1016 in suggestions object 1014 and/or includes the suggestions 1016 that each have a respective score exceeding a threshold score.

In FIG. 10C, device 1000 receives speech input 1018 (“add visit Shibuya Crossing under day 3”) that selects suggestion 1016(1). In response, device 1000 processes the speech input to initiate a corresponding task. As a result, in FIG. 10D, device 1000 modifies user interface 1006 to include the text “visit Shibuya Crossing” under “day 3.” In response to receiving speech input 1018, device 1000 further ceases to display suggestion 1016(1) selected by speech input 1018.

In FIG. 10D, in response to receiving speech input 1018, device 1000 replaces suggestion 1016(1) with different new suggestion 1016(4). In this manner, when a user adopts a suggestion, device 1000 replaces it with a new suggestion, resulting in suggestions object 1014 including a consistent number of suggestions. In some examples, new suggestion 1016(4) is the next best suggestion, e.g., a previously generated suggestion with a score lower than each of the scores for suggestions 1016(1)-1016(3), but higher than the score of any other generated suggestion. In some examples, in response to receiving a user input that selects suggestion 1016(1), device 1000 generates new suggestions based on context information and includes the new suggestions (or a selected subset thereof) in suggestions object 1014.

In FIG. 10E, content 1004 now includes user interface 1006 of the notes application and user interface 1020 of a web browsing application. In FIG. 10E, device 1000 further detects that the user's gaze is directed to object 1008. In response, device 1000 displays suggestions object 1014 including suggestions 1022. Suggestions 1022 includes suggestions 1022(1) and 1022(3) that are tasks performable by the DA and suggestion 1022(2) that is a text suggestion (e.g., text to enter into user interface 1006). Device 1000 determines suggestions 1022 because the current context information includes the notes application (e.g., includes the content “visit Shibuya Crossing” and “Tokyo trip” of the notes application) and the web browsing application (e.g., metadata associated with the web browsing application that indicates the user frequently visits cnn.com).

In FIG. 10E, device 1000 further receives speech input 1024 that selects suggestion 1022(1). In response to receiving speech input 1024, device initiates the corresponding task of navigating to cnn.com. As a result, in FIG. 10F, user interface 1020 includes a webpage for cnn.com. In FIG. 10F, device 1000 further detects that the user's gaze is not directed to object 1008. In response, device 1000 ceases to display suggestions object 1014. In some examples, device 1000 ceases to display suggestions object 1014 further in response to detecting that the user's gaze is also not directed to suggestions object 1014. This may prevent device 1000 from ceasing to display suggestions object 1014 while the user gazes at suggestions object 1014. In some examples, device 1000 ceases to display suggestions object 1014 a predetermined duration (e.g., 1, 2, or 3 seconds) after detecting that the user's gaze is not directed to suggestions object 1014 or to object 1008.

In FIG. 10G, content 1004 now includes a view of New York City. For example, the user and device 1000 are physically in New York City and display 1002 provides a view of New York City via pass-through video. In FIG. 10G, device 1000 further detects that the user's gaze is directed to object 1008. In response, device 1000 displays suggestions object 1014 that includes suggestions 1026 (i.e., suggestions 1026(1), 1026(2), and 1026(3)). Device 1000 determines suggestions 1026 based on current context information. The current (e.g., as of when the user's gaze at object 1008 is detected) context information indicates that device 1000 is located in New York City, that the user frequently calls their mom at the current time, and that the user frequently requests the DA to help find nearby coffee. Accordingly, suggestion 1026(1) is to request device 1000 to tell the user about New York City, suggestion 1026(2) is to request device 1000 to call the user's mom, and suggestion 1026(3) is to request device 1000 to find nearby coffee.

In FIG. 10H, device 1000 detects that the user's gaze is directed to building 1028. Device 1000 thus ceases to display suggestions object 1014. Device 1000 further identifies building 1028 as the Empire State Building. As discussed below, device 1000 uses identified building 1028 as context information to generate future suggestions.

In FIG. 10I, device 1000 detects that the user's gaze is directed to object 1008. In response, device 1000 displays suggestions object 1014 including updated suggestions 1026. Updated suggestions 1026 include new suggestion 1026(4) for device 1000 to tell the user about the Empire State Building. Device 1000 generates new suggestion 1026(4) based on context information indicating that the user recently gazed at the Empire State Building, as described with respect to FIG. 10H.

In FIG. 10J, device 1000 now displays user interface 1006 of the notes application. Device 1000 further detects that the user's gaze is directed to object 1008. In response, device 1000 displays suggestions object 1014 including updated (e.g., re-updated) suggestions 1026. Updated suggestions 1026 include new suggestion 1026(5) for device 1000 to add “day two activities” to user interface 1006. Device 1000 generates new suggestion 1026(5) based on context information indicating that the user has input “day 2” into user interface 1006 of the notes application and that no activities are listed under “day 2.”

In FIG. 10J, device 1000 receives speech input 1030 “I only want suggestions for the notes app.” In response, device 1000 processes speech input 1030 to determine a corresponding user intent. Based on the user intent, device 1000 causes context module 904 generate context information exclusive to the notes application and causes LLM unit 812 to generate suggestions 1032 (FIG. 10K) based on the generated context information. In FIG. 10K, in response to receiving speech input 1030, device 1000 displays suggestions object 1014 that includes suggestions 1032. Suggestions 1032 each relate to the notes application because the user specified that the associated context information should only relate to the notes application.

In FIG. 10K, device 1000 receives speech input 1034 “add day 1 activities” that selects one of suggestions 1032. In response, device 1000 initiates a corresponding task. As a result, in FIG. 10L, device modifies user interface 1006 of the notes application to include the suggested activities “get sushi,” “Mt. Fuji,” and “Yoyogi Park” for “day 1” of the user's trip to Tokyo.

In FIG. 10L, device 1000 further detects that the user's gaze is not directed to object 1008 or to suggestions object 1014. In response, device 1000 ceases to display suggestions object 1014. In FIG. 10L, device 1000 further receives gesture input that selects text 1036 “get sushi” in user interface 1006. In response, device 1000 displays indication 1038 that text 1036 is selected. As discussed below, device 1000 uses selected text 1036 as context information to generate future suggestions.

In FIG. 10M, device 1000 detects that the user's gaze is directed to object 1008. In response, device 1000 displays suggestions object 1014. Suggestions object 1014 includes suggestions 1040 for sushi restaurants in Tokyo. Device 1000 determines suggestions 1040 based on context information indicating that text 1036 “get sushi” is currently selected and/or based on speech input 1030 indicating that the user only wants suggestions relevant to the notes application.

The example of FIGS. 10J-10K shows that device 1000 generates and displays suggestions in response to natural language input (e.g., speech input 1030). In other examples (e.g., shown in FIGS. 10C, 10E, 10G, 10I, 10J, and 10M), device 1000 generates and displays suggestions in response to detecting user gaze at object 1008, e.g., if one or more of the above-described criteria are satisfied. As described, the suggestions (e.g., 1016, 1022, 1026, 1032, and 1040) provided at different times can differ due to the different context information used to generate the respective suggestions, resulting in dynamically updated suggestions determined as most relevant to the current context information.

While the example of FIGS. 10A-10M include generating suggestions using LLM unit 812 and context module 904, in some examples, device 1000 obtains and presents suggestions from other sources. Example other sources include system-level sources, applications installed on the device, and/or external services associated with device 1000 (e.g., a weather information service, an advertising service, a sports information service, and/or an emergency notification service). In some examples, device 1000 determines respective relevance scores for such other suggestions and compares the respective relevance scores against the relevance scores of suggestions generated using LLM unit 812 to determine the suggestions for presentation at a current time, e.g., to determine the most relevant suggestions. Accordingly, in some examples, device 1000 presents suggestions that are not generated by LLM unit 812.

FIGS. 11A-11P illustrate different manners in which device 1100 indicates that suggestions are available to a user, according to various examples.

In FIG. 11A, device 1100 displays user interface 1102 of a notes application. Device 1100 at least partially implements the components of computer system 800. In the examples of FIGS. 11A-11P, device 1100 is implemented as a tablet device. In other examples, device 1100 is implemented as another type of device.

User interface 1102 includes user-inputted content 1104 “Tokyo trip ● day 1” and suggestions indicator 1106. Suggestions indicator 1106 has different visual appearances depending on whether suggestions are available to the user. In FIG. 11A, suggestions indicator 1106 has a first (e.g., non-emphasized) visual appearance, indicating that suggestions are not available to the user.

In some examples, while device 1100 displays user interface 1102, device 1100 requests LLM unit 812 to generate suggestions according to the techniques discussed above. More specifically, device 1100 requests context module 904 to determine context information and LLM 812 unit generates text input 902 such as “provide relevant suggestions” or “provide suggestions relevant to this context information.” LLM unit 812 processes the context information and text input 902 according to the techniques described with respect to FIGS. 9A-9B to generate LLM output 912 that includes suggestions. In some examples, device 1100 requests LLM unit 812 to generate suggestions periodically (e.g., every 5 seconds, 10 seconds, 30 seconds, or 1 minute). In some examples, device 1100 requests LLM unit 812 to generate suggestions each time the content (e.g., displayed content) of user interface 1102 is modified by the user, e.g., when device 1100 detects that the user edits the content of a document by adding, deleting, and/or modifying content. In some examples, the determined context information relates solely to the application of user interface 1102 (e.g., solely includes the notes application and the metadata associated therewith (e.g., user-inputted content 1104 and/or other usage data associated with the notes application)). In some examples, the determined context information includes other context information, e.g., other application(s) and associated metadata, the location of device 1100, and the like.

In FIG. 11A, LLM unit 812 generates suggestions based on content 1104. However, each of the generated suggestions has a low confidence score (e.g., a score below a threshold), indicating low confidence that the generated suggestions are relevant for presentation. For example, LLM unit 812 determines that content 1104 in FIG. 11A provides insufficient information to provide relevant suggestions to the user. As a result, device 1100 does not make the suggestions available to the user and thus displays suggestions indicator 1106 with the first visual appearance.

In FIG. 11B, device 1100 receives user input to modify content 1104 to “Tokyo trip ● day 1 activities.” In response to detecting that content 1104 is modified, device 1100 causes LLM unit 812 to re-generate suggestions. At least some of the new suggestions 1112 (FIG. 11C) have respective scores above a threshold, meaning that LLM unit 812 determines that content 1104 in FIG. 11B now provides sufficient information to provide relevant suggestions to the user. Accordingly, in FIG. 11B, device 1100 indicates that suggestions 1112 are available by changing the first visual appearance of suggestions object 1106 to a second visual appearance in which suggestions object 1106 is circled. In FIG. 11B, device 1100 further receives touch input 1108 on suggestions object 1106.

In FIG. 11C, in response to receiving touch input 1108, device 1100 displays suggestions 1112 and text field 1114. Suggestions 1112 are determined based on content 1104 “Tokyo trip ● day 1 activities” and include activities for the user to do in Tokyo. Text field 1114 allows a user to enter (e.g., type and/or speak) a request to LLM unit 812.

The example of FIGS. 11B-11C show that device 1100 receives input that selects suggestions object 1106 while suggestions object 1106 has the second visual appearance indicating that suggestions 1112 are available to the user. In some examples, device 1100 receives input that selects suggestion object 1106 while suggestions object 1106 has the first visual appearance (e.g., indicating that suggestions are not available to the user). In such examples, in response to receiving the input, device 1100 displays text field 1114 to allow the user to issue requests to LLM unit 812, but does not display any suggestions.

In FIG. 11D, device 1100 receives input corresponding to entry of text 1116 into text field 1114. Device 1100 displays entered text 1116 “activities near Shinjuku” in text field 1114. Device 1100 further receives input corresponding to a request to process entered text 1116. In response, device 1100 processes entered text 1116 using LLM unit 812 to generate suggestions 1118. Device 1110 displays suggestions 1118 in FIG. 11E.

In FIG. 11E, device 1110 receives touch input 1120 on suggestion 1118(1) of suggestions 1118. In FIG. 11F, in response to receiving touch input 1120, device 1100 initiates a task corresponding to suggestion 1118(1), e.g., adds “activity 5” to user-inputted content 1104. In response to receiving touch input 1120, device 1100 further ceases to display suggestion 1118(1).

FIGS. 11G-11I illustrate another example of how device 1100 indicates that suggestions are available to a user.

In FIG. 11G, device 1100 displays user interface 1102 that includes user-inputted content 1104 “Tokyo trip ● day 1 activities”. LLM unit 812 generates suggestions 1122 and determines that suggestions 1122 (e.g., suggested activities to do in Tokyo) are sufficiently relevant for presentation to the user. Accordingly, device 1100 displays suggestions 1122. Suggestions 1122 are displayed in region 1124 that allows the user to input content into user interface 1102. As shown, suggestions 1122 have a different visual appearance than user-inputted content 1104, thereby allowing the user to distinguish between user-inputted content and suggested content.

In FIG. 11G, device 1100 receives swipe input 1125 on suggestions 1122. In response to receiving swipe input 1125, in FIG. 11H, device 1100 displays suggestions 1126 different from suggestions 1122. Suggestions 1126 also have a different visual appearance than user-inputted content 1104 to indicate that the user has yet to adopt suggestions 1126. In some examples, suggestions 1126 are previously generated next-best suggestions. For example, device 1100 already generated suggestions 1126 in FIG. 11G but did not display them because suggestions 1122 are the three highest scored suggestions and suggestions 1126 are the next three highest scored suggestions (e.g., are in the top six suggestions, but are not in the top three). In some examples, suggestions 1126 are newly generated suggestions. For example, in response to receiving swipe input 1125, device 1100 re-generates suggestions and displays suggestions 1126 that are the top-ranked of the re-generated suggestions.

While FIG. 11G shows that swipe input 1125 corresponds to movement in a first (e.g., rightwards) direction, in some examples, device 1100 receives second input corresponding to a selection of suggestions 1122 and that corresponds to movement in a different second direction, e.g., leftwards, upwards, or downwards. In response to receiving the second input, device 1100 displays new suggestions in a manner analogous to that described with respect to FIGS. 11G-11H. The new suggestions can be the same as or different from suggestions 1126. For example, the new suggestions are the same as suggestions 1126 when device 1100 interprets the second input as a request to display the next best suggestions (relative to previous suggestions 1122) and the new suggestions differ from suggestions 1126 when device 1100 interprets the second input as a request to generate new suggestions (e.g., as LLM unit 812 can generate suggestions in a non-deterministic manner, so two instances of the same request to generate suggestions (e.g., based on the same context information) can result in different respective suggestion outputs).

In FIG. 11H, device 1100 receives touch input 1128 on suggestions 1126. In response, in FIG. 11I, device 1100 adds suggestions 1126 to user-inputted content 1104 by changing the visual appearance of suggestions 1126 to match that of user-inputted content 1104.

FIGS. 11J-11K illustrate another example of how device 1100 indicates that suggestions are available to the user.

In FIG. 11J, device 1100 displays user interface 1102 that includes user-inputted content 1104 “Tokyo trip ● day 1 activities.” LLM unit 812 generates suggestions 1130 (FIG. 11K) and determines that suggestions 1130 (e.g., suggested activities to do in Tokyo) are sufficiently relevant for presentation to the user. Accordingly, device 1100 changes the appearance of user-inputted content 1104 (or a portion thereof) to indicate that suggestions 1130 are available. For example, in FIG. 11J, prior to determining the suggestions 1130 are available, the portion “day 1 activities” had a first appearance (e.g., the appearance of “day 1 activities” in FIG. 11B) and in response to determining that suggestions 1130 are available, the appearance of “day 1 activities” changes to the second appearance shown in FIG. 11J.

In FIG. 11J, device 1100 receives touch input 1132 that selects the portion of user inputted content 1104 with the changed appearance. In response, in FIG. 11K, device 1100 displays suggestions 1130 and ceases to change the appearance of the portion of user inputted content 1104. Suggestions 1130 are displayed with a visual appearance different from that of user inputted content 1104 to allow the user to distinguish between user-inputted content and suggested content. In some examples, device 1100 receives a user input corresponding to a selection of suggestions 1130, and in response, adds suggestions 1130 to user-inputted content 1104 (e.g., by changing the appearance of suggestions 1130 to match that of user inputted content 1104), e.g., in a manner analogous to that described with respect to FIGS. 11H-11I.

FIGS. 11L-11M illustrate another example of how device 1100 indicates that suggestions are available to the user.

In FIG. 11L, device 1100 displays user interface 1102 that includes user-inputted content 1134 “Tokyo trip.” Device 1100 further displays keyboard user interface 1133.

In FIG. 11L, device 1100 generates suggestions based on user-inputted content 1134 “Tokyo trip” but determines that the suggestions are not sufficiently relevant for presentation to the user. Thus, in FIG. 11L, device 1100 forgoes displaying any indication that the suggestions are available.

In FIG. 11M, device 1100 has received further user input (e.g., keyboard input) corresponding to the entry of the text “● day 1 activities,” so user-inputted content 1134 now includes the text “Tokyo trip ● day 1 activities”. Device 1100 re-generates suggestions based on the updated user-inputted content 1134 to obtain suggestions 1136. Device 1110 determines that suggestions 1136 are sufficiently relevant for presentation to the user and thus displays suggestions 1136 in keyboard user interface 1133.

In some examples, device 1100 receives an input corresponding to a selection of one of suggestions 1136, and in response, adds the selected suggestion (e.g., “activity 1”) to user-inputted content 1134.

FIGS. 11N-11P illustrate another example of how device 1100 indicates that suggestions are available to the user.

In FIG. 11N, device 1100 displays user interface 1102 of a notes application that includes user-inputted content 1150 “Tokyo trip ● day 1 activities.” Device 1100 further displays suggestions object 1106 with a first appearance (e.g., without a circle) to indicate that suggestions are not currently available to the user, e.g., because device 1100 has not yet requested LLM unit 812 to generate suggestions or because device 1100 determines that generated suggestions are not sufficiently relevant for presentation.

In FIG. 11N, device 1100 receives an input corresponding to a selection of portion 1052 (“day 1 activities”) of user-inputted content 1150. In response, device 1100 displays an indication that portion 1052 is selected, e.g., displays a box around portion 1052.

In response to receiving the input corresponding to the selection of portion 1052, device 1100 generates suggestions 1154 (FIG. 11P) according to the techniques discussed above. Device 1100 generates suggestions 1154 based on at least portion 1052 so suggestions 1154 are determined to be relevant to portion 1052. Accordingly, in some examples, device 1100 generates suggestions in response receiving user input that selects a portion of user-inputted content 1150. In other examples, e.g., as described with respect to FIGS. 11A-11M, device 1100 generates suggestions (e.g., periodically) when user interface 1102 is displayed and/or when new content is added to user interface 1102.

In FIG. 11O, device 1100 determines that suggestions 1154 are sufficiently relevant for presentation to the user. Accordingly, device 1100 displays suggestions object 1106 with a second visual appearance (e.g., with a circle around it) to indicate that suggestions 1154 are available to the user. In other examples, device 1100 indicates that suggestions 1154 are available to the user in another manner, e.g., in the manners illustrated in FIGS. 11G, 11J, and/or 11M. In some examples, in response to receiving the input corresponding to the selection of portion 1052, device 1100 displays an indication that suggestions 1154 are available to the user, regardless of whether device 1100 determines that suggestions 1154 are sufficiently relevant for presentation (e.g., regardless of the respective scores of suggestions 1154).

In FIG. 11O, device further receives touch input 1160 on suggestions object 1106 that has the second visual appearance. In response to receiving touch input 1160, in FIG. 11P, device 1100 displays suggestions 1154. In some examples, device 1100 receives an input corresponding to a selection of one of suggestions 1154, and in response, adds the selected suggestion to user-inputted content 1050, e.g., in a manner analogous to that described with respect to FIGS. 11E-11F.

6. Incorporating Large Language Models into a Digital Assistant System to Assist with Planning Tasks

FIGS. 12A-12Y illustrate user interfaces and techniques for managing plans, according to various examples.

In FIG. 12A, device 1200 displays home screen user interface 1205. Device 1200 at least partially implements the components of computer system 800. In the examples of FIGS. 12A-12Y, device 1200 is implemented as a smartphone device. In other examples, device 1200 is implemented as another type of device. In FIG. 12A, device 1200 receives speech input 1202 (“what's the weather?”) directed to the DA.

In FIG. 12B, in response to receiving speech input 1202, device 1200 displays DA user interface 1204 over home screen user interface 1205. DA user interface 1204 includes representation 1208 of speech input 1202 and response object 1210 for speech input 1202. Device 1200 further provides audio output 1206 to respond to speech input 1202.

Device 1200 determines that speech input 1202 does not correspond to a planning request. More specifically, device 1200 processes speech input 1202 using DA system 700 and/or LLM unit 812 to classify speech input 1202 as a non-planning request. Because speech input 1202 does not correspond to a planning request, device 1200 does not add any graphical object corresponding to speech input 1202 to planning user interface 1224 (FIG. 12I). However, device 1200 provides a response to speech input 1202 via display of representation 1208 and object 1210 in DA user interface 1204 and/or via audio output 1206.

In FIG. 12C, while displaying home screen user interface 1205, device 1200 receives speech input 1212 (“help me eat healthy and lose weight”) directed to the DA. As detailed below, device 1200 determines that speech input 1212 corresponds to a planning request and thus adds planning object 1226 (FIG. 12I) that corresponds to speech input 1212 to planning user interface 1224 (FIG. 12I).

In FIG. 12D, in response to receiving speech input 1212, device 1200 processes speech input 1212 as discussed above with respect to LLM unit 812. As a result, LLM unit 812 determines suggested tasks 1214 (i.e., suggested tasks 1214(1), 1214(2), 1214(3), and 1214(4)) for the plan to eat healthy and lose weight. In some examples, suggested tasks 1214 include a task for the user to perform. For example, the user is to perform suggested task 1214(2) to “find a local gym.” In some examples, suggested tasks 1214 include a task for device 1200 to perform (e.g., execute). For example, device 1200 is to perform suggested task 1214(1) to search for healthy diet plans. In FIG. 12D, in response to receiving speech input 1212, device 1200 further displays, in DA user interface 1204, response object 1216 that includes suggested tasks 1214.

In FIG. 12D, device 1200 displays suggested tasks 1214 concurrently with respective progress indicators 1218 (i.e., 1218(1), 1218(2), 1218(3), and 1218(4)). As detailed below, device 1200 changes the appearance of respective progress indicators 1218 to indicate a completion status of the respective suggested task 1214. In the illustrated example, progress indicators 1218(1), 1218(2), 1218(3) each has a first appearance (e.g., each displays a spinning circle animation) to indicate that each of the respective suggested tasks 1214(1), 1214(2), and 1214(3) is processing and incomplete. For example, device 1200 has started execution of respective task flows for each of suggested tasks 1214(1), 1214(2), and 1214(3), but each of the respective task flows has not completed execution. For example, device 1200 has not yet provided an output determined to satisfy the respective task, has not yet performed an action determined to satisfy the respective task, and/or has not encountered an error leading to termination of the respective task flow. In FIG. 12D, progress indicator 1218(4) has a second appearance (e.g., a not-filled circle) to indicate that device 1200 has not started processing (e.g., executing) respective suggested task 1214(4). For example, device 1200 has determined a task flow for suggested task 1214(4) but has yet to start execution of the task flow.

In FIG. 12E, device 1200 has further processed suggested tasks 1214 and thus updates the appearance of progress indicators 1218 to indicate the completion statuses of the respective suggested tasks 1214. In particular, progress indicators 1218(1)-1218(3) now each have a third appearance (e.g., a filled in circle) to indicate that respective suggested tasks 1214(1)-1214(3) are now complete. For example, execution of each of the respective task flows is complete, e.g., meaning that each of the respective task flows has returned a result determined to satisfy the respective suggested task and/or has caused device 1200 to perform an action to satisfy the respective task. Further, progress indicator 1218(4) now has the first appearance to indicate that suggested task 1214(4) is processing but is not complete.

In FIG. 12F, device 1200 has further processed suggested tasks 1214 to complete suggested task 1214(4). Thus, device 1200 updates the appearance of progress indicator 1218(4) to the third appearance to indicate that respective suggested task 1214(4) is complete. While the examples of FIGS. 12D-12F show that device 1200 visually indicates the progress of suggested tasks 1214(1)-1214(4), in some examples, device 1200 additionally or alternatively provides audio feedback to indicate the progress (e.g., completion status) of at least some of suggested tasks 1214(1)-1214(2). For example, device 1200 provides first audio output to indicate that device 1000 has not started processing task 1214(4), provides second audio output to indicate that device 1000 is currently processing task 1214(4), and provides third audio output to indicate that device 1000 has completed task 1214(4).

In FIG. 12G, in response to determining that each of suggested tasks 1214 is complete, device 1200 displays, in DA user interface 1204, respective response objects 1220 (i.e., response objects 1220(1), 1220(2), 1220(3), and 1220(4)). Respective response objects 1220 include information associated with completion of the respective task, e.g., respective response object 1220(1) includes information about healthy diet plans, respective response object 1220(2) includes information about “local gym A,” respective response object 1220(3) indicates that device 1200 has set a reminder to exercise, and respective response object 1220(4) indicates that device 1200 has set a reminder to eat healthy meals. In some examples, device 1200 receives user input corresponding to a selection of one of respective response objects 1220 and in response, provides (e.g., displays) further information associated with the respective suggested task. For example, in response to a user selection of respective response object 1220(2), device 1200 displays a maps application user interface including additional information about “local gym A” and in response to a user selection of respective response object 1220(4), device 1200 displays a reminder application user interface that allows the user to modify the reminder to cat healthy. While the example of FIGS. 12C-12G illustrate that device 1200 displays respective response objects 1220 in response to determining that each suggested task 1214 is complete, in other examples, device 1200 displays a respective response object 1220 in response to determining that a respective suggested task 1214 is complete. For example, in response to a determination that suggested task 1214(1) is complete, device 1200 displays respective response object 1220(1), regardless of whether suggested tasks 1214(2)-1214(4) are complete.

In FIG. 12G, in response to receiving speech input 1212 and in accordance with determining that speech input 1212 corresponds to a request to initiate a plan (e.g., corresponds to a planning request), device 1200 adds planning object 1226 (FIG. 12I) to planning user interface 1224 (FIG. 12I). In some examples, device 1200 adds planning object 1226 to planning user interface 1224 further in accordance with a determination that each of suggested tasks 1214 is complete.

In FIG. 12H, device 1200 has received user input that requests to dismiss DA user interface 1204. In response, device 1200 dismisses (e.g., ceases to display) DA user interface 1204 and displays home screen user interface 1205. In FIG. 12H, device 1200 further receives speech input 1222 (“Hey Siri, what are you up to?”) that requests to display planning user interface 1224. In some examples, device 1200 receives another type of input that requests to display planning user interface 1224 (e.g., a gesture input, an air gesture input, a gaze input, and the like).

In FIG. 12I, in response to receiving speech input 1222, device 1200 displays planning user interface 1224. Planning user interface 1224 includes one or more graphical depictions of one or more planning tasks with which the DA currently assists the user. Planning user interface 1224 includes planning object 1226 that device 1200 added based on processing speech input 1212 (as shown in FIGS. 12C-12G). Planning user interface 1224 further includes planning object 1228. Device 1200 added planning object 1228 (that corresponds to a task of planning a trip to Tokyo) based on processing speech input 1238, as detailed below with respect to FIGS. 12L-12Q. In some examples, planning objects 1226 and 1228 each include text describing their respective plans (e.g., the title “Tokyo trip” and the title “eat healthy and lose weight”) and optionally, one or more graphics for their respective plans (e.g., an image of Tokyo and image(s) associated with exercise and healthy eating).

Device 1200 displays planning object 1228 in an emphasized manner (e.g., with a bold border around it) and device 1200 displays planning object 1226 in a non-emphasized manner (e.g., without the bold border around it). Device 1200 displays planning object 1228 in the emphasized manner because device 1200 has determined to request additional information about the corresponding plan for the Tokyo trip. Specifically, as discussed below with respect to FIGS. 12L-12Q, device 1200 determined that the plan for the Tokyo trip includes the suggested task to book flights to Tokyo, but that the user has yet to book their flights (e.g., device 1200 has yet to receive and/or detect a set of inputs to complete the flight booking). Accordingly, device 1200 determines to request additional information (e.g., information to complete the flight booking) and displays planning object 1228 in an emphasized manner. Device 1200 does not display planning object 1226 in the emphasized manner because device 1200 has determined to not request additional information about the corresponding plan to eat healthy and lose weight. For example, device 1200 determines that predetermined type(s) of information (e.g., the local gym, healthy diet plans, a schedule for the eat healthy reminder, and/or a schedule for the exercise reminder) associated with the plan are specified and thus does not determine to request additional information.

Device 1200 further displays planning objects 1226 and 1228 in an order based on whether device 1200 requests additional information about the respective plans. For example, because device 1200 requests additional information about the plan for the Tokyo trip but does not request additional information about the plan to eat healthy and lose weight, device 1200 displays planning object 1228 with a more prominent display order than planning object 1226, e.g., displays planning object 1228 on top of planning object 1226.

In FIG. 12I, planning object 1228 further includes description 1230 (“book flight”) of the additional information device 1200 requests about the plan for the Tokyo trip. Operating device 1200 in the manner depicted in FIG. 12I (e.g., by changing the appearance of planning object 1228, by ordering planning object 1228 on top, and/or by including description 1230) may help the user and/or device 1200 more quickly complete desired tasks, e.g., by reminding the user about the information that they still need to provide and by allowing the user to more efficiently access and/or edit incomplete plans.

In FIG. 12I, device 1200 receives touch input 1227 on planning object 1226. In FIG. 12J, in response to receiving touch input 1227, device 1200 displays detailed user interface 1232 corresponding to the plan to eat healthy and lose weight. Detailed user interface 1232 includes more information (e.g., more types of information) about the plan than planning object 1226 does. For example, planning object 1226 includes the title of the plan (and optionally a graphic for the plan) while detailed user interface 1232 includes the user's current weight, information about healthy diet plans, information about “local gym A,” information about the reminder to eat healthy, and information about the reminder to exercise.

Detailed user interface 1232 includes natural language input entry field 1234. Natural language entry field 1234 enables the user to provide natural language inputs to modify and/or retrieve information about the corresponding plan. For example, device 1200 receives a set of inputs including a natural language input and an input (e.g., gesture input and/or gaze input) corresponding to a selection of natural language input entry field 1234. In response, device 1200 processes the natural language input and performs a corresponding task.

In the example of FIG. 12J, device 1200 receives speech input 1236 (“I like gym B”) and an input that selects natural language input entry field 1234. Device 1200 processes speech input 1236 to update the plan to eat healthy and lose weight. Updating the plan includes updating detailed user interface 1232. Specifically, in FIG. 12K, device 1200 replaces the information about “local gym A” with information about local gym “B”. Device 1200 interprets speech input 1236 based on context information associated with the plan, e.g., based on the information displayed in detailed user interface 1232. Specifically, based on interpreting the speech input “I like gym B” in conjunction with context information indicating that information about “local gym A” is displayed, LLM unit 812 generates output 912 that represents a task to replace the information about “local gym A” with information about “local gym B.” The DA then executes the task to modify detailed user interface 1232 to its appearance in FIG. 12K.

In FIG. 12L, while displaying home screen user interface 1205, device 1200 receives speech input 1238. Device 1200 processes speech input 1238 according to the techniques discussed above with respect to FIGS. 9A-9B to determine that speech input 1238 includes two different requests, e.g., a first request to generate a plan for a trip to Tokyo and a different second request to generate a text message to the user's mom saying “I'm going to Tokyo.”

In FIG. 12M, in response to receiving speech input 1238 and in accordance with a determination that speech input 1238 includes the two different requests, device 1200 displays DA user interface 1204. DA user interface 1204 includes response object 1242(1) corresponding to the first request (e.g., a first task) and response object 1242(2) corresponding to the second request (e.g., a second task). DA user interface 1204 further includes progress indicators 1246(1) and 1246(2) that represent respective completion statuses of the first request to generate a plan for a trip to Tokyo and the second request to generate the text message. In FIG. 12M, progress indicators 1246(1) and 1246(2) each has the first visual appearance (as discussed with respect to FIGS. 12D-12F) to indicate that the respective requests are each processing but are each incomplete.

In FIG. 12N, device 1200 has completed processing of the respective requests.

Accordingly, device 1200 updates progress indicators 1246(1) and 1246(2) to have the third appearance (as discussed with respect to FIGS. 12D-12F) to indicate that the respective requests are each complete. In response to receiving speech input 1238 and in accordance with determining that the respective requests are complete, device 1200 displays respective response objects 1248 and 1250. In response to receiving the speech input 1238 and in accordance with a determination that speech input 1238 corresponds to a planning request (and optionally in accordance with a determination that the request to generate a plan is complete), device 1200 adds planning object 1228 (FIG. 12I) to planning user interface 1224.

Response object 1248 includes suggested tasks 1252 (i.e., suggested tasks 1252(1), 1252(2), 1252(3), and 1252(4)) corresponding to the plan for the Tokyo trip. In some examples, device 1200 orders suggested tasks 1252 based on dependencies between the suggested tasks. A dependency between two suggested tasks indicates that a result associated with performance of one of the tasks is required to initiate performance of the other task. In some examples, the DA (e.g., LLM unit 812) determines the dependencies between the suggested tasks of the plan when generating the plan. In the example of FIG. 12N, suggested task 1252(2) has a dependency on suggested task 1252(1) because determining the dates of the Tokyo trip is required to proceed to suggested task 1252(2) of booking a hotel. Because suggested task 1252(2) has a dependency of suggested task 1252(1), device 1200 displays suggested task 1252(2) with a less prominent display order than suggested task 1252(1), e.g., displays suggested task 1252(2) lower than suggested task 1252(1). Displaying suggested tasks of a plan in an order that is based on their respective dependencies may assist the user in determining a proper order in which to provide information to device 1200 to complete the plan, which in turn allows the user to use device 1200 more quickly and efficiently.

In some examples, device 1200 determines that information (e.g., a predetermined type of information) about a plan is unspecified. In accordance with such determination, device 1200 provides an output to request the unspecified information. In some examples, device 1200 provides the output when some types of information are unspecified and does not provide the output when other type(s) of information are unspecified. For example, when device 1200 generates a plan, device 1200 specifies two different sets of information about the plan. If the first set of information (e.g., higher priority information) is unspecified, device 1200 provides the output and if the second set of information (e.g., lower priority information) is unspecified, device 1200 does not provide the output. It will be appreciated that how different type(s) of information are distributed among the first and second sets of information can vary according to the particular generated plan. Further, in some examples, if information in the first set of information is unspecified, device 1200 changes the appearance of a corresponding planning object (e.g., 1228) in planning user interface 1224, changes (e.g., promotes) the display order of the corresponding planning object, and/or includes a description (e.g., 1230) of the requested information in the corresponding planning object, e.g., as described with respect to FIG. 12I.

In FIG. 12N, device 1200 determines that information (e.g., the dates) about the plan for the trip to Tokyo is unspecified and that the information belongs to the first set of information. In accordance with such determinations, device 1200 provides audio output 1254 (“when do you want to go?”) that requests the unspecified information. In contrast, in the examples of FIGS. 12D-12G, device 1200 determines that information about the plan (e.g., the time at which to set the reminder to exercise) is not specified. However, device 1200 determines that the information corresponds to the second set of information (e.g., lower priority information), and thus does not provide an output to request the unspecified information.

In FIG. 12O, after providing audio output 1254, device 1200 receives speech input 1256 (“September 27^{th} to October 15^{th} and I'm staying with friends”) that indicates the unspecified information. In FIG. 12P, device 1200 processes speech input 1256 to update response object 1248. Specifically, response object 1248 no longer includes suggested task 1252(1) (because the dates are now specified) and response object 1248 is now titled “Tokyo trip Sept. 27^{th} to Oct. 15^{th}.”

Speech input 1256 further corresponds to a request to modify the plan for the Tokyo trip, e.g., includes “I'm saying with friends.” In response to receiving speech input 1256, device 1200 processes speech input 1256 to interpret speech input 1256 as a request to remove suggested task 1252(2). For example, the DA processes speech input 1256 in conjunction with context information including the currently displayed content (e.g., suggested task 1252(2) to book a hotel) to determine that because the user is staying with their friends, they do not need to book a hotel. Accordingly, in FIG. 12P, device 1200 modifies the plan by removing suggested task 1252(2).

In FIG. 12P, device 1200 receives touch input 1258 that selects suggested task 1252(3). In FIG. 12Q, in response to receiving touch input 1258, device 1200 initiates suggested task 1252(3) by displaying flight booking user interface 1260. Flight booking user interface 1260 enables the user to provide a set of inputs to complete the flight booking. In FIG. 12Q, device 1200 does not receive input(s) to complete the flight booking. For example, before finishing the flight booking, the user closes flight booking user interface 1260. As a result, device 1200 determines to request additional information about the Tokyo trip plan (e.g., as device 1200 considers flight booking information to correspond to the first set of information (e.g., higher priority information). Accordingly, device 1200 displays planning object 1228 in the manner shown and described with respect to FIG. 12I above.

In FIG. 12R, while displaying home screen user interface 1205, device 1200 receives speech input 1262 (“Hey Siri, how's my Tokyo trip plan?”) that requests progress on the plan for the Tokyo trip. In FIG. 12S, in response to receiving speech input 1262, device 1200 displays detailed user interface 1264 for the plan for the Tokyo trip. Detailed user interface 1264 includes more information about the plan than planning object 1228 that corresponds to the plan (FIG. 12I) does. Specifically, detailed user interface 1264 includes the dates of the trip and suggestions for activities to do in Tokyo. Accordingly, the example of FIGS. 12R-12S illustrates that in response to receiving input that requests progress on a specific plan, device 1200 displays the detailed user interface for the specific plan. In contrast, the example of FIGS. 12H-12I illustrate that in response to receiving input (e.g., 1222) that generally requests for the DA's progress on planning tasks, device 1200 displays a planning user interface (e.g., 1224) for one or more plans.

Once device 1200 generates a plan, the DA enables the user to provide input (e.g., natural language input) to update the plan. Example updates to a plan correcting a step of the plan, providing more information about the plan, changing an objective and/or a step of the plan, adding a step to the plan, removing a step from the plan, or otherwise modifying the plan. Device 1200 indicates such updates to the plan via the graphical object for the plan and/or via the detailed user interface for the plan. In some examples, device 1200 receives the input via selection of a natural language input entry field (e.g., 1234) displayed in the detailed user interface for the plan (e.g., 1232). In some examples, device 1200 receives the input while displaying a user interface different from the detailed user interface. As a specific example, device 1200 receives input requesting “for my Tokyo trip plan, add the task of making a reservation at a good sushi place” and in response, device 1200 updates the plan to include the additional task, e.g., by updating detailed user interface 1264 to include a graphical element for making a reservation at a sushi restaurant. In some examples, based on a user input that provides more information about a plan, device 1200 updates one or more steps of the plan based on the provided information. For example, based on user input “I'm taking my kids on the Tokyo trip,” device 1200 updates the suggested activities in detailed user interface 1264 to include family friendly activities, e.g., by requesting LLM unit to generate suggestions for activities to do in Tokyo based on context information indicating that children are coming along.

In some examples, device 1200 changes a plan (e.g., changes a step and/or a suggestion of the plan) based on information associated with completion of a step of the plan. For example, information obtained from a completion of a previous step causes device 1200 to modify one or more subsequent steps. As a specific example, for the Tokyo trip plan of FIG. 12S, upon completion of the flight booking step, device 1200 changes the suggested activities based on information associated with the flight booking, e.g., suggests first day activities geographically close to the arrival airport and/or suggests last day activities geographically close to the departure airport. More specifically, device 1200 requests LLM unit 812 to generate suggestions for activities to do in Tokyo based on context information associated with the booked flight, e.g., the location of the arrival airport and the location of the departure airport.

FIGS. 12T-12V illustrate an example where device 1200 adds an object to planning user interface 1224 even though the corresponding task is not a planning task.

In FIG. 12T, device 1200 receives speech input 1266 (“set a reminder”). Device 1200 determines that speech input 1266 does not correspond to a planning task. In FIG. 12U, in response to receiving speech input 1266, device 1200 displays DA user interface 1204. DA user interface 1204 includes representation 1268 of speech input and response object 1270 that includes the response “for what, and when?”. Device 1200 further provides audio output 1272 (“for what, and when?”). Device 1200 displays response object 1270 and provides audio output 1272 because speech input 1266 specifies neither timing information for the reminder nor what the reminder should be about.

In FIG. 12U, after device 1200 provides audio output 1272, device 1200 receives speech input 1274 (“let's pick this up later”). Device 1200 determines that speech input 1274 corresponds to a request to pause the task and in accordance with such determination, device 1200 adds corresponding task object 1276 (FIG. 12V) to planning user interface 1224. While the example of FIG. 12U shows that the request to pause the task is a speech input, in other examples, device 1200 receives another type of input that is interpreted as a request to pause the task. For example, if device 1200 receives an input (e.g., a gesture input, an air gesture input, and/or a gaze input) that requests to dismiss DA user interface 1204 while the task is incomplete (e.g., before device 1200 sets the reminder), device 1200 interprets the input as a request to pause the task and thus adds corresponding task object 1276 to planning user interface 1224.

In FIG. 12V, device 1200 displays planning user interface 1224. Planning user interface 1224 now includes corresponding task object 1276 for the paused task of setting a reminder. Device 1200 displays corresponding task object 1276 in an emphasized manner (e.g., with a bolded border around it) and promotes the display order of corresponding task object 1276 (e.g., displays corresponding task object 1276 above planning objects 1228 and 1226) because corresponding task object 1276 is for a paused task. In other examples, device 1200 does not display task objects for paused tasks with the emphasized display manner and/or does not promote the display order of task objects for paused tasks.

In some examples, corresponding task object 1276 allows the user to resume the paused task. For example, device 1200 receives a user input (e.g., a touch input) corresponding to a selection of corresponding task object 1276 and in response, displays a user interface associated with the paused task. The user interface enables the user to provide a set of inputs to complete the task, e.g., to specify timing information for the reminder and to specify the subject of the reminder. Adding task objects that correspond to paused tasks to planning user interface 1224 provides a convenient and efficient way for the user to return to paused tasks, thereby allowing the user to use the device more quickly and efficiently.

In FIG. 12V, device 1200 receives touch input 1278 on planning object 1226. In FIG. 12W, in response to receiving touch input 1278, device 1200 displays detailed user interface 1232 for the plan to eat healthy and lose weight. Detailed user interface 1232 includes sharing object 1280 that allows the user to share the eat healthy and lose weight plan with another device.

In FIG. 12W, device 1200 receives touch input 1282 on sharing object 1280. In FIG. 12X, in response to receiving touch input 1282, device 1200 displays sharing user interface 1284. Sharing user interface includes graphical element 1286 that represents the plan (e.g., that indicates the plan will be sent to another person/device), recipient field 1288, and send object 1290. Device 1200 has further received user input to enter “mom” in recipient field 1288. In FIG. 12X, device 1200 further receives touch input 1292 on send object 1290.

In response to receiving touch input 1292, device 1200 transmits a representation of the plan to the specified recipient, e.g., the user's mom. In some examples, transmitting the representation of the plan includes removing personal information of the user (e.g., the user's health information (e.g., weight of 175 lbs.), location information, financial information, and the like) from the plan. In some examples, transmitting the representation of the plan includes transmitting the suggested tasks of the plan, but not transmitting the results of executing the suggested tasks and/or not transmitting certain user-specified parameters of the suggested tasks. For example, device 1200 transmits the task to find healthy diet plans, transmits the task to find a local gym, transmits the task to set a reminder to cat healthy, and transmits the task to set a reminder to exercise. However, device 1200 does not transmit the specific healthy diet plans (e.g., plans A, B, and C), does not transmit information about local gym B, does not transmit timing information about the user's reminder to eat healthy, and does not transmit timing information about the user's reminder to exercise.

In FIG. 12Y, the mother's device 1295 has received the representation of the plan to cat healthy and lose weight from device 1200. The mother's device 1295 displays detailed user interface 1296 for the plan. Detailed user interface 1296 does not include the weight of the user (e.g., 175 lbs.) and instead includes the weight of the user's mother (e.g., 120 lbs.). Detailed user interface 1296 does not include the user's healthy diet plans (e.g., does not indicate healthy diet plans A, B, and C), does not indicate information about “local gym B,” does not indicate timing information about the reminder to eat healthy, and does not indicate timing information about the reminder to exercise. Instead, detail user interface 1296 includes suggestion objects 1297(1)-1297(4), respectively selectable to initiate a search for healthy diet plans, to initiate a search for a local gym, to initiate a process to set a reminder to eat healthy, and to initiate a process to set a reminder to exercise. Accordingly, transmitting a representation of a plan in the manner described allows users to share plans with others while maintaining the user's privacy and allowing the other user to more easily customize the plan according to their own preferences.

7. Process for Determining Tasks from Speech

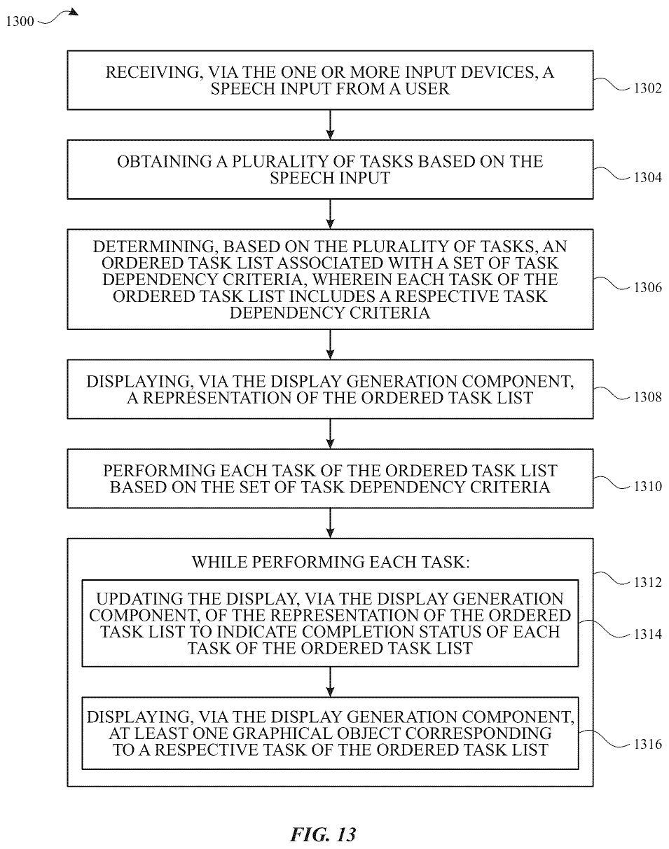

FIG. 13 illustrates process 1300 for determining tasks from speech according to various examples. Process 1300 is performed, for example, at a computer system (e.g., computer system 800) that is in communication with a display generation component and one or more input devices.

In some examples, process 1300 is performed using a client-server system (e.g., system 100), and the blocks of process 1300 are divided up in any manner between the server (e.g., DA server 106) and a client device. In other examples, the blocks of process 1300 are divided up between the server and multiple client devices (e.g., a mobile phone and a smart watch). Thus, while portions of process 1300 are described herein as being performed by particular devices of a client-server system, it will be appreciated that process 1300 is not so limited. In other examples, process 1300 is performed using only a client device (e.g., user device 104) or only multiple client devices. In process 1300, some blocks are, optionally, combined, the order of some blocks is, optionally, changed, and some blocks are, optionally, omitted. In some examples, additional steps may be performed in combination with the process 1300.

Process 1300 includes receiving (1302), via the one or more input devices, a speech input from a user (e.g., from a user of the computer system 800). Process 1300 further includes obtaining (1304) (e.g., using an AI process or a generative AI process) a plurality of tasks based on the speech input. In some examples, a text representation (e.g., 902) of the speech input is parsed (e.g., using an AI process or a generative AI process) into multiple identifiable commands corresponding to actionable tasks performable by the device.

Process 1300 includes determining (1306) (e.g., using an AI process or a generative AI process), based on the plurality of tasks, an ordered task list associated with a set of task dependency criteria, wherein each task of the ordered task list includes a respective task dependency criteria (e.g., each task includes information on whether the task is dependent on the result of other tasks or is independent of the result of other tasks). In some examples, based on the parsed commands, a set of tasks for satisfying the commands is determined (e.g., using an AI process or a generative AI process). In some examples, a determination (e.g., using an AI process or a generative AI process) is made whether each task of the set of tasks is manageable (e.g., an application and/or application programming interface exists in order to execute the respective task).

Process 1300 includes displaying (1308), via the display generation component, a representation of the ordered task list. In some examples, a short summary of each task is displayed next to a progress indicator (e.g., indicating whether the task is incomplete, in progress, or completed).

Process 1300 includes performing (1310) (e.g., using an AI process or a generative AI process) each task of the ordered task list based on the set of task dependency criteria. In some examples, one or more tasks are performed (e.g., using an AI process or a generative AI process) in sequential order based on dependency information. In some examples, one or more tasks are performed concurrently (e.g., using an AI process or a generative AI process) to other tasks, in-part or in-full if possible (e.g., contact information is gathered and a partial message created to eventually be sent pending results of other tasks).

Process 1300 includes, while performing (1312) each task (e.g., using an AI process or a generative AI process), updating (1314) the display, via the display generation component, of the representation of the ordered task list to indicate completion status of each task of the ordered task list. In some examples, for each respective task, a respective progress indicator is dynamically updated (e.g., using an AI process or a generative AI process) to show whether performance of the task is in progress or completed.

Process 1300 includes displaying (1316), via the display generation component, at least one graphical object corresponding to a respective task of the ordered task list. In some examples, for certain tasks, an interface element is displayed showing results of completed tasks or in progress information regarding tasks (e.g., weather information, route information, informative text, etc.).

In some examples, process 1300 further includes determining (e.g., using an AI process or a generative AI process) whether each task of the plurality of tasks satisfies a management criteria, and in accordance with a determination (e.g., using an AI process or a generative AI process) that a respective task of the plurality of tasks satisfies the management criteria, including the respective task as a task within the ordered task list. In some examples, the management criteria includes criteria as to whether a task can be handled based on available applications and API commands.

In some examples, determining (e.g., using an AI process or a generative AI process) whether each task of the plurality of tasks satisfies the management criteria includes obtaining (e.g., using an AI process or a generative AI process) a list of applications accessible to the computer system (e.g., calendar application, e-mail application, contacts application), obtaining (e.g., using an AI process or a generative AI process) a list of application programing interface commands accessible to the computer system; (e.g., create event, compose e-mail, find contact), and in accordance with a determination (e.g., using an AI process or a generative AI process) that a respective task of the plurality of tasks can be satisfied using at least one application of the list of applications and using at least one application programming interface command of the list of application programming interface commands, determining (e.g., using an AI process or a generative AI process) that the respective task satisfies the management criteria.

In some examples, determining (e.g., using an AI process or a generative AI process) whether each task of the plurality of tasks satisfies the management criteria includes applying (e.g., using an AI process or a generative AI process) a dataset to a language model (e.g., a task-specific dataset), modifying (e.g., using an AI process or a generative AI process) at least one parameter associated with the language model to obtain a tuned language model (e.g., modifying and/or adding to a task-specific layer of the LLM architecture), and in accordance with a determination (e.g., using an AI process or a generative AI process) that a respective task of the plurality of tasks can be satisfied using the tuned language model, determining (e.g., using an AI process or a generative AI process) that the respective task satisfies the management criteria.

In some examples, determining (1306) (e.g., using an AI process or a generative AI process) the ordered task list includes identifying (e.g., using an AI process or a generative AI process) whether the plurality of tasks include one or more first tasks which are dependent on the performance of at least one or more different respective tasks of the plurality of tasks (e.g., synchronous tasks which depend on outcome of other tasks), and identifying (e.g., using an AI process or a generative AI process) whether the plurality of tasks include one or more second tasks which are not dependent on the performance of at least one or more different respective tasks of the plurality of tasks (e.g., asynchronous tasks which do not depend on outcome of other tasks). In some examples, the ordered task list includes the one or more first tasks followed by the one or more second tasks.

In some examples, process 1300 further includes identifying (e.g., using an AI process or a generative AI process) whether the one or more first tasks include one or more first respective tasks which are dependent on the performance of at least one or more different respective tasks of the one or more first tasks (e.g., synchronous tasks which depend on outcome of other synchronous tasks), and identifying (e.g., using an AI process or a generative AI process) whether the one or more first tasks include one or more second respective tasks which are not dependent on the performance of at least one or more different respective tasks of the one or more first tasks (e.g., synchronous tasks which do not depend on outcome of other synchronous tasks), wherein the ordered task list includes the one or more first respective tasks followed by the one or more second respective tasks.

In some examples, determining (1306) (e.g., using an AI process or a generative AI process) the ordered task list includes, for each respective task of the ordered task list, obtaining (e.g., using an AI process or a generative AI process) a vector representation of the respective task and identifying (e.g., using an AI process or a generative AI process) an application programming interface based on the vector representation (e.g., a look-up function to identify applicable API using embedded vectors corresponding to tasks).

In some examples, performing (1310) (e.g., using an AI process or a generative AI process) each task of the ordered task list based on the set of task dependency criteria includes, for each respective task of the ordered task list, providing task information to at least one application programming interface associated with the respective task (e.g., transmitting a location parameter from a web browser application to a maps application using applicable API) and receiving a result based on the provided task information. In some examples, the received result is stored as context information.

In some examples, process 1300 further includes, in accordance with a determination (e.g., using an AI process or a generative AI process) that additional information is required in order to perform a respective task of the ordered last list, identifying (e.g., using an AI process or a generative AI process) an additional task based on the additional information and adding the additional task to the ordered task list (e.g., task prompting user for additional information).

In some examples, process 1300 further includes, for each respective task of the ordered last list which is not dependent on the performance of at least one or more different respective tasks of the ordered last list (e.g., asynchronous tasks which do not depend on outcome of other tasks), concurrently performing (e.g., using an AI process or a generative AI process) each respective task.

In some examples, process 1300 further includes, after the performance of a respective task of the ordered task list, obtaining (e.g., using an AI process or a generative AI process) a plurality of resultant parameters based on the performance, adding the resultant parameters to context information, and performing (e.g., using an AI process or a generative AI process) each subsequent task of the ordered task list based on the set of task dependency criteria and the context information (e.g., result of performed tasks (e.g., retrieved weather information) used as context for ongoing task performance).

In some examples, updating (1314) the display, via the display generation component, of the representation of the ordered task list to indicate completion status of each task of the ordered task list includes displaying a progress indicator proximate to a textual representation, wherein the progress indicator includes a progress animation for each task being performed, and a completion indicator for each completed task.

In some examples, process 1300 further includes receiving a user input on a displayed textual representation of a respective task, and in accordance with a determination that the respective task includes at least one of additional information or one or more sub-tasks, displaying at least the additional information and the one or more sub-tasks (e.g., user may tap on task element to reveal additional sub-tasks associated with task element).

In some examples, displaying (1316), via the display generation component, at least one graphical object corresponding to a respective task of the ordered task list includes displaying additional information corresponding to the respective task, wherein the additional information includes at least one of textual information corresponding to the task, a picture representation corresponding to the task, and an application-specific representation corresponding to the task.

In some examples, process 1300 further includes receiving a user input on a displayed textual representation of a respective task, in response to receiving the user input, providing (e.g., using an AI process or a generative AI process) an option to modify at least one parameter associated with the task, and modifying at least one parameter associated with the task in response to a user interaction with the provided option (e.g., user may tap on task element to modify the task).

The operations described above with reference to FIG. 13 are optionally implemented by components depicted in FIGS. 1-4, 6A-6B, 7A-C and/or 8. For example, the operations of process 1300 may be implemented by computer system 800. It would be clear to a person having ordinary skill in the art how other processes are implemented based on the components depicted in FIGS. 1-4, 6A-B, 7A-C, and/or 8.

### 8. Process for Providing Suggestions

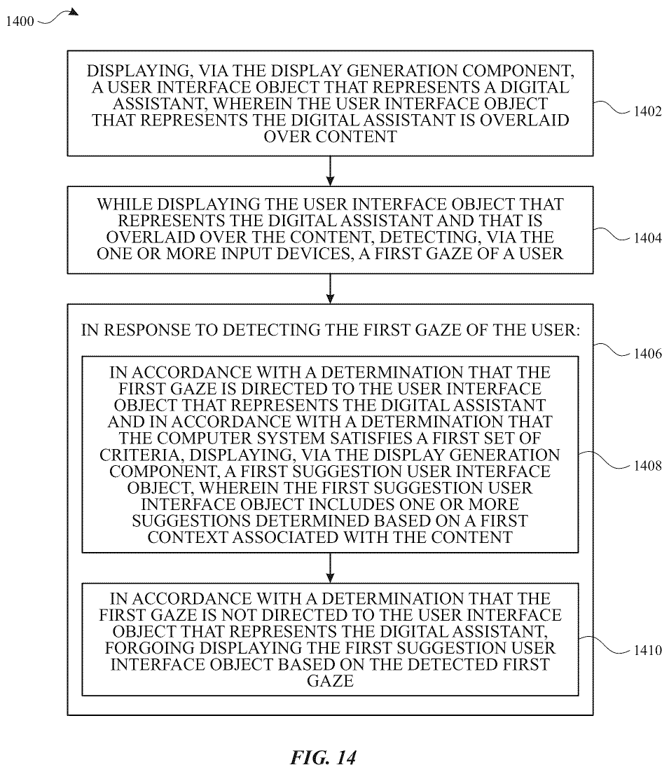

FIG. 14 illustrates process 1400 for providing suggestions, according to various examples. Process 1400 is performed, for example, at a computer system (e.g., computer system 800) that is in communication with a display generation component (e.g., a display controller, a touch-sensitive display system, a display (e.g., that is integrated within and/or connected to the computer system), a 3D display, a transparent display, a projector, and/or a heads-up display) and one or more input devices (e.g., microphone(s), camera(s), and/or touch-sensitive surface(s)).

In some examples, process 1400 is performed using a client-server system (e.g., system 100), and the blocks of process 1400 are divided up in any manner between the server (e.g., DA server 106) and a client device. In other examples, the blocks of process 1400 are divided up between the server and multiple client devices (e.g., a mobile phone and a smart watch). Thus, while portions of process 1400 are described herein as being performed by particular devices of a client-server system, it will be appreciated that process 1400 is not so limited. In other examples, process 1400 is performed using only a client device (e.g., user devices 104, 1000, 1100, or 1200) or only multiple client devices. In process 1400, some blocks are, optionally, combined, the order of some blocks is, optionally, changed, and some blocks are, optionally, omitted. In some examples, additional steps may be performed in combination with the process 1400.

Process 1400 includes displaying (1402), via the display generation component, a user interface object (e.g., 1008) that represents a digital assistant, wherein the user interface object that represents the digital assistant is overlaid over content (e.g., 1004). In some examples, the content includes content displayed via the display generation component, e.g., applications, media, and/or other user interface objects. In some examples, the content includes a physical environment as viewed by the user through the computer system.

Process 1400 includes while displaying (1404) the user interface object that represents the digital assistant and that is overlaid over the content (in some examples, and while not displaying a suggestions user interface object (e.g., 1014)), detecting, via the one or more input devices, a first gaze of a user (e.g., as indicated by 1012).

Process 1400 includes in response to (1406) detecting the first gaze of the user: in accordance with a determination (e.g., using an AI process or a generative AI process) that the first gaze is directed to (e.g., towards, at, and/or aimed at) the user interface object that represents the digital assistant (e.g., 1008) and in accordance with a determination (e.g., using an AI process or a generative AI process) that the computer system satisfies a first set of criteria, displaying (1408), via the display generation component, a first suggestion user interface object (e.g., 1014), wherein the first suggestion user interface object includes one or more suggestions (e.g., 1016, 1022, 1026, 1032, and/or 1040) determined (e.g., using an AI process or a generative AI process) based on a first context (e.g., context information determined by context module 904) associated with the content (e.g., 1004). In some examples, the first set of criteria includes a first criterion that is met when the digital assistant is active (e.g., is an active application and/or when the digital assistant user interface object is overlaid over content). In some examples, the first set of criteria includes a second criterion that is met is when the computer system is a particular type of computer system, e.g., a head mounted device. In some examples, the first set of criteria includes a third criterion that is met when specific content is displayed, e.g., a notes application.

Process 1400 includes in response to (1406) detecting (e.g., using an AI process or a generative AI process) the first gaze of the user: in accordance with a determination (e.g., using an AI process or a generative AI process) that the first gaze is not directed to the user interface object that represents the digital assistant (in some examples, the first gaze is detected as focused elsewhere, e.g., on the content and/or on another user interface object different from the user interface object that represents the digital assistant), forgoing (1410) displaying the first suggestion user interface object based on the detected first gaze. In some examples, in accordance with a determination (e.g., using an AI process or a generative AI process) that the first gaze is directed to the user interface object that represents the digital assistant and in accordance with a determination (e.g., using an AI process or a generative AI process) that the computer system does not satisfy the first set of criteria (e.g., the digital assistant is not an active application), process 1400 includes forgoing displaying the suggestion user interface object based on the detected first gaze.

In some examples, process 1400 further includes: while displaying the first suggestion user interface object (e.g., 1014), detecting, via the one or more input devices (e.g., using an AI process or a generative AI process), a change in the first gaze (e.g., as illustrated by the position of gaze indicator 1012 in FIGS. 10E-10F and/or in FIGS. 10G-10H); and in response to detecting the change in the first gaze: in accordance with a determination (e.g., using an AI process or a generative AI process) that the changed first gaze is not directed to the user interface object (e.g., 1018) that represents the digital assistant (and optionally, in accordance with a determination that the changed first gaze is not directed to the first suggestion user interface object), ceasing to display the first suggestion user interface object.

In some examples, the one or more suggestions (e.g., 1016, 1022, 1026, 1032, and/or 1040) determined (e.g., using an AI process or a generative AI process) based on the first context associated with the content includes at least one of: a user activity (e.g., an action for the user to perform, as opposed to an action the electronic device can perform); a text suggestion (e.g., a suggestion for autofill text); and a task performable by the digital assistant (e.g., a task the digital assistant is capable of executing).

In some examples, process 1400 further includes: while displaying the first suggestion user interface object, detecting, via the one or more input devices (e.g., using an AI process or a generative AI process), a first input (e.g., 1018) (e.g., a spoken input, a gesture input, an air gesture input, a gaze input, and/or a touch input) that corresponds to a selection of a first suggestion (e.g., 1016(1)) of the one or more suggestions; and in response to detecting (e.g., using an AI process or a generative AI process) the first input (in some examples, and while the computer system continues to detect that the user's gaze is directed at the user interface object that represents the digital assistant or at the first suggestion user interface object; in some examples, and while displaying the first suggestion user interface object): initiating a task (e.g., using an AI process or a generative AI process) corresponding to the first suggestion (e.g., as illustrated by the transition between FIGS. 10C-10D); and ceasing to display the first suggestion (e.g., 1016(1)) within the first suggestion user interface object (e.g., 1014) (e.g., as illustrated by the transition between FIGS. 10C-10D).

In some examples, process 1400 further includes: in response to detecting (e.g., using an AI process or a generative AI process) the first input (e.g., 1018) (in some examples, and while the computer system continues to detect (e.g., using an AI process or a generative AI process) that the user's gaze is directed at the user interface object that represents the digital assistant or at the first suggestion user interface object; in some examples, and while displaying the first suggestion user interface object), displaying, via the display generation component, a second suggestion (e.g., 1016(4)) within the first suggestion user interface object (e.g., 1014), wherein the second suggestion is different from the first suggestion. In some examples, the suggestion user interface object has a predetermined number (e.g., 2, 3, 4, or 5) of suggestions, so when one suggestion ceases to be displayed in the suggestions user interface object, another suggestion replaces it.

In some examples, the first context associated with the content includes a default context associated with the content. In some examples, context module 904 determines (e.g., using an AI process or a generative AI process) the most relevant context at a current time, e.g., the time when the computer system detects the user gaze at the user interface object that represents the digital assistant. In some examples, the default context is the most relevant context at the current time.

In some examples, process 1400 further includes displaying, via the display generation component, a first user interface (e.g., 1006 and/or 1020) of a first application, wherein the content (e.g., 1004) includes the first user interface of the first application, and wherein the first context includes the first application. In some examples, the first user interface of the first application is in focus (e.g., is displayed in the foreground of the display) when the gaze of the user is directed to the user interface object that represents the digital assistant.

In some examples, process 1400 further includes detecting, via the one or more input devices (e.g., using an AI process or a generative AI process), a user input (e.g., voice input, gesture input, air gesture input, gaze input, and/or speech input) corresponding to a selection of a first portion (e.g., 1036) of the content (e.g., not the entirety of the content and/or not the entirety of what the display generation component presents), wherein the first context includes the selected first portion of the content. In some examples, in response to detecting (e.g., using an AI process or a generative AI process) the user input, the computer system displays an indication (e.g., 1038) that the first portion of the content is selected.

In some examples, process 1400 further includes concurrently displaying, via the display generation component, a second user interface (e.g., 1006) of a second application and a third user interface (e.g., 1020) of a third application, wherein the third application is different from the second application, and wherein the first context includes the second application and the third application. In some examples, the second user interface and the third user interface are both in focus (e.g., are both displayed in the foreground of the display) when the gaze of the user is directed to the user interface object that represents the digital assistant.

In some examples, the first context includes a location of the computer system (e.g., the location of the computer system when the gaze of the user is directed to the user interface object that represents the digital assistant).

In some examples, process 1400 further includes detecting, via the one or more input devices (e.g., using an AI process or a generative AI process), a user input (e.g., voice input, gesture input, air gesture input, gaze input, and/or speech input) that indicates the first context, wherein the first context is determined based on the user input that indicates the first context.

In some examples, the user input that indicates the first context includes a second gaze of the user (e.g., as indicated by gaze indicator 1012 in FIG. 10H). In some examples, the second gaze of the user is different from the first gaze of the user. For example, the second gaze of the user is detected (e.g., using an AI process or a generative AI process) before the first gaze of the user (e.g., as indicated by gaze indicator 1012 in FIG. 10I). In some examples, the computer system determines (e.g., using an AI process or a generative AI process) that the second gaze of the user is directed to an object (e.g., 1028) (e.g., physical object or virtual object) and identifies the object. In some examples, the first context includes the identified object.

In some examples, the user input that indicates the first context includes a first natural language input (e.g., 1030). In some examples, the first natural language input explicitly indicates the context for which the computer system should provide suggestions, e.g., “I only want suggestions about the notes app” or “I only want suggestions relevant to my current location.”

In some examples, the user input that indicates the first context includes a gesture input (e.g., the input that selects portion 1036 in FIG. 10L) (e.g., a touch input and/or an air gesture input) corresponding to a selection of a second portion (e.g., 1036) of the content. In some examples, in response to detecting (e.g., using an AI process or a generative AI process) the gesture input, the computer system displays, via the display generation component, an indication (e.g., 1038) that the second portion of the content is selected. In some examples, the first context includes the selected second portion of the content.

In some examples, process 1400 further includes after displaying (e.g., after initially displaying) the first suggestion user interface object (e.g., 1014 in FIG. 10G) (in some examples, after ceasing to display the first suggestion user interface object because the computer system detected that the user's gaze is no longer directed at the user interface object representing the digital assistant or at the first suggestion user interface object): while displaying the user interface object that represents the digital assistant, detecting, via the one or more input devices (e.g., using an AI process or a generative AI process), a third gaze of the user (e.g., as indicated by gaze indicator 1012 in FIG. 10I). In some examples, process 1400 further includes response to detecting (e.g., using an AI process or a generative AI process) the third gaze, in accordance with a determination (e.g., using an AI process or a generative AI process) that the third gaze is directed to the user interface object that represents the digital assistant and in accordance with a determination (e.g., using an AI process or a generative AI process) that the computer system satisfies the first set of criteria, displaying, via the display generation component, a second suggestion user interface object (e.g., 1014 in FIG. 10I), wherein: the second suggestion user interface object includes a first set of suggestions (e.g., 1026(4), 1026(1), and 1026(2)) different from the one or more suggestions (e.g., 1026(1), 1026(2), and 1026(3)) included in the first suggestion user interface object; the first set of suggestions is determined (e.g., using an AI process or a generative AI process) based on a second context associated with the content (e.g., the context information used to generate suggestions 1026(4), 1026(1), and 1026(2) in FIG. 10I); and the second context is different from the first context (e.g., the context information used to generate suggestions 1026(1), 1026(2), and 1026(3) in FIG. 10G).

In some examples, process 1400 further includes: detecting, via the one or more input devices (e.g., using an AI process or a generative AI process), a second natural language input (e.g., 1010, 1018, 1024, 1030, and/or 1034); and in response to detecting (e.g., using an AI process or a generative AI process) the second natural language input: in accordance with a determination (e.g., using an AI process or a generative AI process) that the second natural language input corresponds to a command (e.g., a task performable by the digital assistant), initiating a task (e.g., using an AI process or a generative AI process) corresponding to the command; and in accordance with a determination (e.g., using an AI process or a generative AI process) that the second natural language input includes dictated text, displaying, via the display generation component, one or more words transcribed from the second natural language input.

In some examples, process 1400 further includes while displaying an application user interface (e.g., 1102): in accordance with a determination (e.g., using an AI process or a generative AI process) that a second set of criteria, different from the first set of criteria, is satisfied: in accordance with a determination (e.g., using an AI process or a generative AI process) that a set of suggestion availability criteria is satisfied: displaying, via the display generation component and in the application user interface, a visual indication that a second set of suggestions (e.g., 1112, 1118, 1122, 1130, 1136, and/or 1154) is available, wherein the second set of suggestions is determined based on a first content (e.g., 1104, 1134, and/or 1150) (e.g., user inputted content such as text, images, marks, and/or drawings) of the application user interface. In some examples, the second set of criteria includes a first criterion that is met when a predetermined application (e.g., a text editing application) is in focus. In some examples, the second set of criteria includes a second criterion that is met when the computer system is a particular type of electronic device (e.g., a non-head mounted device or a device without gaze tracking capability). In some examples, the second set of criteria includes a third criterion that is met when a digital assistant is not initiated, e.g., is not an active application. In some examples, LLM unit 812 generates suggestions (e.g., using an AI process or a generative AI process) based on the content of the application user interface and the set of suggestion availability criteria include a criterion that is satisfied when at least one of the generated suggestions has a confidence value that exceeds a predetermined threshold. In some examples, in accordance with a determination (e.g., using an AI process or a generative AI process) that the set of suggestion availability criteria is not satisfied (e.g., LLM unit 812 is unable to generate suggestions based on the content of the application user interface or the generated suggestion(s) each have a confidence value below a predetermined threshold), process 1400 includes forgoing displaying the visual indication.

In some examples, process 1400 further includes detecting, via the one or more input devices (e.g., using an AI process or a generative AI process), a user input (e.g., the user input that selected portion 1052 in FIG. 11N) (e.g., voice input, gesture input, air gesture input, gaze input, and/or speech input) corresponding to a selection of a portion (e.g., 1052) of (e.g., not the entirety of) the first content (e.g., 1150), wherein the set of suggestion availability criteria include a criterion that is satisfied when the user input corresponding to the selection of the portion of the first content is received, and wherein the second set of suggestions (e.g., 1154) is determined (e.g., using an AI process or a generative AI process) based on the selected portion of the first content. In some examples, the second set of suggestions are not determined based on any other portion of the application user interface. In some examples, in response to detecting the user input (e.g., using an AI process or a generative AI process), the computer system displays an indication that the portion of the first content is selected.

In some examples, the application user interface includes a first user interface object (e.g., 1106), wherein displaying the visual indication that the second set of suggestions is available includes changing the first user interface object from having a first appearance (e.g., the appearance of object 1106 in FIG. 11A) to a having second appearance different from the first appearance (e.g., the appearance of object 1106 in FIG. 11B). In some examples, process 1400 further includes: while the first user interface object has the second appearance, detecting, via the one or more input devices (e.g., using an AI process or a generative AI process), a first user input (e.g., 1108) corresponding to a selection of the first user interface object; and in response to detecting the first user input corresponding to the selection of the first user interface object, displaying, via the display generation component, the second set of suggestions (e.g., 1112).

In some examples, process 1400 further includes: detecting, via the one or more input devices (e.g., using an AI process or a generative AI process), a second user input (e.g., 1108) (e.g., voice input, gesture input, air gesture input, gaze input, and/or speech input) corresponding to a selection of the first user interface object; in response to detecting the second user input corresponding to the selection of the first user interface object, displaying, via the display generation component, a text entry region (e.g., 1114) (e.g., a field that allows the user to enter text via typing and/or dictation); while displaying the text entry region, detecting, via the one or more input devices, a set of user inputs corresponding to a user request within the text entry region (e.g., the user request represented by text 1116) (e.g., an input to enter a user request within the text entry region and an input to cause the computer system to process the request); and in response to detecting the set of user inputs corresponding to the user request within the text entry region, displaying, via the display generation component, a third set of suggestions (e.g., 1118), wherein the third set of suggestions is determined (e.g., using an AI process or a generative AI process) based on the user request. In some examples, the computer system detects the second user input (e.g., using an AI process or a generative AI process) while the first user interface object has the first appearance or the second appearance.

In some examples, the second set of suggestions includes a suggestion to perform a task (e.g., a task to edit and/or modify) associated with the first content of the application user interface.

In some examples, process 1400 further includes: while displaying the second set of suggestions (e.g., 1118 or 1126), detecting, via the one or more input devices (e.g., using an AI process or a generative AI process), a user input (e.g., 1120 or 1128) (e.g., voice input, gesture input, air gesture input, gaze input, and/or speech input) corresponding to a selection of a suggestion of the second set of suggestions; and in response to detecting (e.g., using an AI process or a generative AI process) the user input corresponding to the selection of the suggestion of the second set of suggestions, initiating a task corresponding to the suggestion of the second set of suggestions (e.g., adding text corresponding to the suggestion to the content of the application user interface and/or otherwise modifying the content) (e.g., as illustrated by the transition between FIGS. 11E-11F or by the transition between FIGS. 11H-11I).

In some examples, the application user interface includes a region (e.g., 1124) (e.g., the body and/or main portion of a document) that allows the user to input content (e.g., text, images, marks, and/or drawings) into the application user interface; and displaying the visual indication that the second set of suggestions is available includes displaying the second set of suggestions (e.g., 1122) in the region.

In some examples, process 1400 further includes: while displaying the second set of suggestions in the region, detecting, via the one or more input devices (e.g., using an AI process or a generative AI process), a user input (e.g., 1125) (e.g., a gesture input and/or an air gesture input, e.g., a swipe input) corresponding to a selection of the second set of suggestions (e.g., 1122); and in response to detecting (e.g., using an AI process or a generative AI process) the user input corresponding to the selection of the second set of suggestions: in accordance with a determination (e.g., using an AI process or a generative AI process) that the user input corresponding to the selection of the second set of suggestions corresponds to movement in a first direction (e.g., up, down, left, or right), displaying, via the display generation component, a fourth set of suggestions (e.g., 1126) different from the second set of suggestions (e.g., replacing the second set of suggestions with the fourth set of suggestions), wherein the fourth set of suggestions is determined (e.g., using an AI process or a generative AI process) based on the first content; and in accordance with a determination (e.g., using an AI process or a generative AI process) that the user input corresponding to the selection of the second set of suggestions corresponds to movement in a second direction different from the first direction, displaying, via the display generation component, a fifth set of suggestions different from the second set of suggestions and the fourth set of suggestions (e.g., replacing the second set of suggestions with the fifth set of suggestions), wherein the fifth set of suggestions is determined based on the first content.

In some examples, process 1400 further includes displaying, in the region (e.g., 1124) and via the display generation component, first user-inputted content (e.g., 1104) (e.g., text, images, marks, and/or drawings) with a third appearance (e.g., the appearance of user-inputted content 1004 in FIG. 11B or FIG. 11G), wherein displaying the second set of suggestions in the region includes displaying the second set of suggestions with a fourth appearance (e.g., the appearance of suggestions 1122 in FIG. 11G) different from the third appearance.

In some examples, process 1400 further includes before displaying the visual indication that the second set of suggestions is available, displaying, in the application user interface and via the display generation component, second user-inputted content with a fifth appearance (e.g., the appearance of “day 1 activities” in FIG. 11B), wherein displaying the visual indication that the second set of suggestions is available includes changing the fifth appearance of the second user-inputted content to a sixth appearance (e.g., the appearance of “day 1 activities” in FIG. 11J) different from the fifth appearance. In some examples, the second set of suggestions are determined based on the second-user inputted content.

In some examples, process 1400 further includes: while displaying the second user-inputted content with the sixth appearance, detecting, via the one or more input devices (e.g., using an AI process or a generative AI process), a user input (e.g., 1132) (e.g., voice input, gesture input, air gesture input, gaze input, and/or speech input) corresponding to a selection of the second user-inputted content; and in response to detecting the user input corresponding to the selection of the second user-inputted content, displaying, via the display generation component, the second set of suggestions (e.g., 1130).

In some examples, process 1400 further includes displaying, via the display generation component, a keyboard user interface object (e.g., 1133), wherein displaying the visual indication that the second set of suggestions is available includes displaying the second set of suggestions (e.g., 1136) within the keyboard user interface object.

The operations described above with reference to FIG. 14 are optionally implemented by components depicted in FIGS. 1-4, 6A-6B, 7A-7C, and/or 8. For example, the operations of process 1400 may be implemented by computer system 800. It would be clear to a person having ordinary skill in the art how other processes are implemented based on the components depicted in FIGS. 1-4, 6A-6B, 7A-7C, and/or 8.

9. Process for Assisting with Planning Tasks

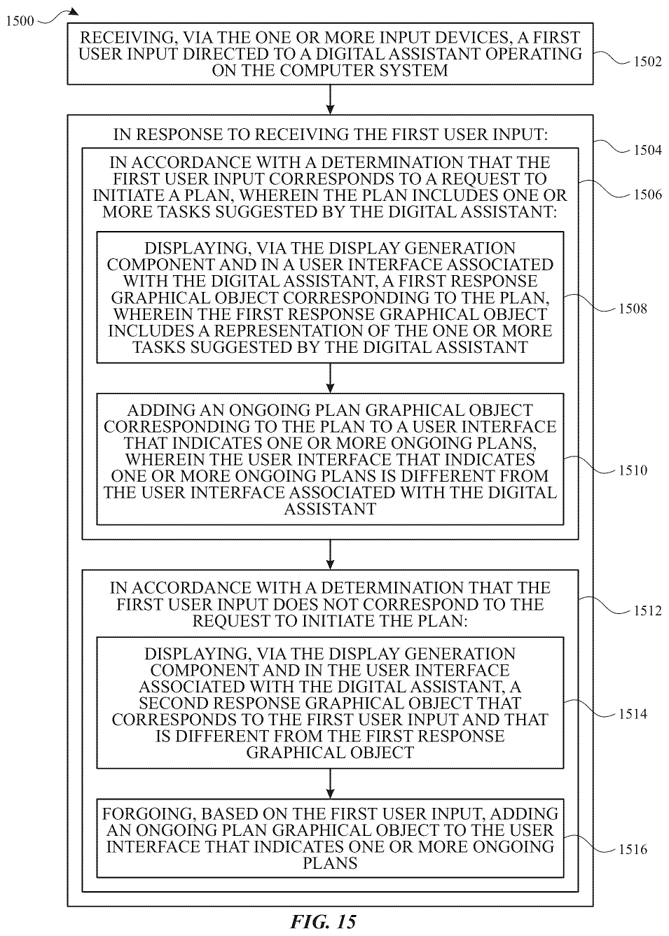

FIG. 15 illustrates process 1500 for managing a plan, according to various examples. Process 1500 is performed, for example, at a computer system (e.g., computer system 800) that is in communication with a display generation component (e.g., a display controller, a touch-sensitive display system, a display (e.g., that is integrated within and/or connected to the computer system), a 3D display, a transparent display, a projector, and/or a heads-up display) and one or more input devices (e.g., microphone(s), camera(s), and/or touch-sensitive surface(s)).

In some examples, process 1500 is performed using a client-server system (e.g., system 100), and the blocks of process 1500 are divided up in any manner between the server (e.g., DA server 106) and a client device. In other examples, the blocks of process 1500 are divided up between the server and multiple client devices (e.g., a mobile phone and a smart watch). Thus, while portions of process 1500 are described herein as being performed by particular devices of a client-server system, it will be appreciated that process 1500 is not so limited. In other examples, process 1500 is performed using only a client device (e.g., user devices 104, 1000, 1100, or 1200) or only multiple client devices. In process 1500, some blocks are, optionally, combined, the order of some blocks is, optionally, changed, and some blocks are, optionally, omitted. In some examples, additional steps may be performed in combination with the process 1500.

Process 1500 includes receiving (1502) (e.g., detecting), via the one or more input devices, a first user input (e.g., 1202 or 1212) (e.g., a natural-language input) directed to a digital assistant operating on the computer system.

Process 1500 includes in response to (1504) receiving the first user input: in accordance with a determination (1506) (e.g., using an AI process or a generative AI process) that the first user input corresponds to a request to initiate a plan, (e.g., a plan for completion over a period of time, e.g., a plan for a future event (e.g., party or vacation) and/or a fitness plan (e.g., including workouts and/or meals)) wherein the plan includes one or more tasks (e.g., 1214 or 1252) (e.g., actions related to the requested plan) suggested by the digital assistant: displaying (1508), via the display generation component and in a user interface associated with the digital assistant (e.g., 1204) (e.g., a default digital assistant UI), a first response graphical object (e.g., 1216 or 1248) corresponding to the plan, wherein the first response graphical object includes a representation of the one or more tasks suggested by the digital assistant.

In some examples, process 1500 includes, in response to (1504) receiving the first user input and in accordance with a determination (1506) (e.g., using an AI process or a generative AI process) that the first user input corresponds to a request to initiate a plan, providing a response to the first user input (e.g., in addition to or alternatively to displaying the first response graphical object in the user interface associated with the digital assistant). Providing the response to the first user input includes modifying the displayed content of a user interface, providing an audio output, and/or causing a device (e.g., the device that received the first user input and/or an external device) to initiate a task. In some examples, process 1500 includes providing the response without displaying the user interface associated with the digital assistant and/or without displaying the first response graphical object in the user interface associated with the digital assistant.

Process 1500 includes in response to (1504) receiving the first user input: in accordance with a determination (1506) (e.g., using an AI process or a generative AI process) that the first user input corresponds to a request to initiate a plan: adding (1510) an ongoing plan graphical object corresponding to the plan (e.g., 1226 or 1228) to a user interface that indicates one or more ongoing plans (e.g., 1224), wherein the user interface that indicates one or more ongoing plans is different from the user interface associated with the digital assistant (e.g., 1204). In some examples, the ongoing plan graphical object includes a representation of the one or more suggested tasks. In some examples, the one or more tasks represented in the ongoing plan graphical object are the same tasks represented in the first response graphical object. In some examples, the user interface that indicates the one or more ongoing plans is not displayed via the display generation component when receiving the first user input and/or not displayed when the user interface associated with the digital assistant is displayed.

Process 1500 includes in response to (1504) receiving the first user input: in accordance with a determination (1512) (e.g., using an AI process or a generative AI process) that the first user input does not correspond to the request to initiate the plan: displaying (1514), via the display generation component and in the user interface associated with the digital assistant (e.g., 1204) (e.g., the default digital assistant UI), a second response graphical object that corresponds to the first user input (e.g., 1210) and that is different from the first response graphical object (e.g., 1216 or 1248). In some examples, the second response graphical object does not include the representation of the one or more tasks suggested by the digital assistant for completing the plan. In some examples, the first user input does not correspond to any request to initiate any plan, wherein a plan includes one or more tasks suggested by the digital assistant.

In some examples, process 1500 includes in response to (1504) receiving the first user input: in accordance with a determination (1512) (e.g., using an AI process or a generative AI process) that the first user input does not correspond to the request to initiate the plan: providing a response to the first user input (e.g., in addition to or alternatively to displaying the second response graphical object in the user interface associated with the digital assistant). Providing the response to the first user input includes modifying the displayed content of a user interface, providing an audio output, and/or causing a device (e.g., the device that received the first user input and/or an external device) to initiate a task. In some examples, process 1500 includes providing the response without displaying the user interface associated with the digital assistant and/or without displaying the second response graphical object in the user interface associated with the digital assistant.

Process 1500 includes in response to (1504) receiving the first user input: in accordance with a determination (1512) (e.g., using an AI process or a generative AI process) that the first user input does not correspond to the request to initiate the plan: forgoing (1516), based on the first user input, adding an ongoing plan graphical object (e.g., forgoing adding any ongoing plan graphical object) to the user interface that indicates one or more ongoing plans (e.g., 1224).

In some examples, process 1500 further includes in response to receiving the first user input (e.g., 1238), and in accordance with a determination (e.g., using an AI process or a generative AI process) that the first user input includes a first request and a second request different from the first request (e.g., the first user input includes at least two separate tasks that the digital assistant can perform), displaying, via the display generation component: a response graphical object corresponding to a response to the first request (e.g., 1241(1) or 1248); and a response graphical object corresponding to a response to the second request (e.g., 1242(2) or 1250).

In some examples, process 1500 further includes displaying, via the display generation component, the ongoing plan graphical object (e.g., 1226 or 1228) in the user interface that indicates one or more ongoing plans (e.g., 1224), including: in accordance with a determination (e.g., using an AI process or a generative AI process) that the computer system requests additional information for the plan, displaying the ongoing plan graphical object in a first manner (e.g., the manner of display of planning object 1228 in FIG. 12I) (e.g., emphasized manner, e.g., with a first visual appearance (e.g., shape, size, color, font size, border thickness, shade, and/or opacity)); and in accordance with a determination (e.g., using an AI process or a generative AI process) that the computer system does not request additional information for the plan, displaying the ongoing plan graphical object in a second manner (e.g., the manner of display of planning object 1226 in FIG. 12I) (e.g., default and/or non-emphasized manner, e.g., with a second visual appearance (e.g., shape, size, color, font size, border thickness, shade, and/or opacity)) different from the first manner. In some examples, when the computer system generates (e.g., using an AI process or a generative AI process) a plan, the computer system specifies a set information the user can provide for the plan. The set of information includes a first set of information (e.g., information the computer system considers to be higher priority) and a second set of information (e.g., information the computer system considers to be lower priority). If the first set of information is not specified, the computer system displays the ongoing plan graphical object in the first manner to request additional information for plan. If the second set of information is not specified, the computer system displays the ongoing plan graphical object in the second manner.

In some examples, displaying the ongoing plan graphical object (e.g., 1228) in the first manner includes displaying a description (e.g., 1230) (e.g., automatically-generated text content and or generative text content) of the additional information that is requested.

In some examples, the ongoing plan graphical object is first ongoing plan graphical object (e.g., 1226 or 1228) (e.g., automatically-generated visual content and or generative visual content) and the user interface that indicates one or more ongoing plans includes a second ongoing plan graphical object (e.g., 1226 or 1228) (e.g., automatically-generated visual content and or generative visual content) corresponding to a second plan. In some examples, process 1500 further includes concurrently displaying, via the display generation component and in the user interface that indicates one or more ongoing plans, the first ongoing plan graphical object and the second ongoing plan graphical object, including: in accordance with a determination that the computer system requests the additional information for the first plan and in accordance with a determination that the computer system does not request second additional information for the second plan, displaying the first ongoing plan graphical object with a higher display order than the second ongoing plan graphical object; and in accordance with a determination that the computer system does not request the additional information for the first plan and in accordance with a determination that the computer system requests the second additional information for the second plan, displaying the first ongoing plan graphical object with a lower display order than the second ongoing plan graphical object. In some examples, each ongoing plan graphical object in the user interface that indicates one or more ongoing plans has a display order (e.g., rank) and the ongoing plan graphical objects are ordered such that an ongoing plan graphical object with a higher display order is displayed more prominently than (e.g., above, higher than, and/or in front of) an ongoing plan graphical object with a lower display order.

In some examples, process 1500 further includes: while displaying, via the display generation component, the ongoing plan graphical object (e.g., 1226) (e.g., automatically-generated visual content and or generative visual content) in the user interface that indicates one or more ongoing plans, detecting, via the one or more input devices (e.g., using an AI process or a generative AI process), a user input (e.g., 1227) (e.g., a spoken input, a gesture input, an air gesture input, a gaze input, and/or a touch input) corresponding to a selection of the ongoing plan graphical object; and in response to detecting the user input corresponding to a selection of the ongoing plan graphical object, displaying, via the display generation component, a user interface corresponding to the plan (e.g., 1232). In some examples, the user interface corresponding to the plan includes more detail about the plan than the ongoing plan graphical object. For example, the user interface includes the steps and/or suggestions of the plan while the ongoing plan graphical object includes a title of the plan and a graphical element (e.g., image) corresponding to the plan.

In some examples, the user interface corresponding to the plan includes a natural language input entry field (e.g., 1234).

In some examples, process 1500 further includes: while displaying the user interface corresponding to the plan, detecting, via the one or more input devices (e.g., using an AI process or a generative AI process), a natural language input (e.g., 1236); and in response to detecting the natural language input, updating (e.g., using an AI process or a generative AI process) the plan (e.g., adding an element to the plan, removing an element from the plan, and/or modifying an element of the plan) based on the natural language input, wherein updating the plan includes updating the user interface (e.g., 1232) corresponding to the plan. In some examples, the computer system receives the natural language input via a selection of the natural language input entry field. For example, the computer system receives the natural language input via typed input into the entry field and/or via a combination of gaze input at the entry field and spoken input.

In some examples, updating (e.g., using an AI process or a generative AI process) the plan includes interpreting the natural language input based on context information associated with the plan. In some examples, the context information includes what is displayed in the user interface (e.g., 1232) corresponding to the plan. In some examples, the context information includes the dialog of previous user-digital assistant interactions associated with the plan.

In some examples, process 1500 further includes: detecting, via the one or more input devices (e.g., using an AI process or a generative AI process), a user input (e.g., 1222) (e.g., a spoken input, a gesture input, an air gesture input, a gaze input, and/or a touch input) corresponding to a request to display the user interface that indicates one or more ongoing plans; and in response to receiving the user input corresponding to the request to display the user interface that indicates one or more ongoing plans, displaying, via the display generation component, the user interface that indicates one or more ongoing plans (e.g., 1224).

In some examples, the user input corresponding to the request to display the user interface that indicates one or more ongoing plans includes a speech input (e.g., 1222) that requests ongoing tasks associated with the digital assistant. In some examples, the user input includes a swipe input from the home screen user interface (e.g., 1205).

In some examples, the one or more tasks suggested by the digital assistant are one or more tasks to be performed in the future (e.g., using an AI process or a generative AI process) (e.g., task(s) that are not currently complete and task(s) to be performed by the user and/or by the computer system).

In some examples, the one or more tasks suggested by the digital assistant include a first task and a second task, and wherein displaying the first response graphical object corresponding to the plan includes: in accordance with determining a dependency between the first task and the second task, displaying a representation of the first task (e.g., 1251(1)) and a representation of the second task (e.g., 1252(2)) in an order based on the dependency between the first task and the second task. In some examples, a dependency between two tasks specifies that a result of the first task is required for performance of the second task (or vice-versa). In some examples, if performance of the first task (e.g., using an AI process or a generative AI process) depends on results from performing the second task, the computer system displays the second task representation with a higher display order (e.g., more prominently) than the first task representation. If performance of the second task (e.g., using an AI process or a generative AI process) depends on results from performing the first task, the computer system displays the second task representation with a lower display order (e.g., less prominently) than the first task representation.

In some examples, process 1500 further includes: while displaying the first response graphical object (e.g., 1248) (e.g., automatically-generated visual content and or generative visual content) corresponding to the plan, detecting, via the one or more input devices automatically (e.g., using an AI process or a generative AI process), a user input (e.g., 1256) (e.g., a spoken input, a gesture input, an air gesture input, a gaze input, and/or a touch input) corresponding to a request to modify the plan; and in response to detecting the user input corresponding to the request to modify the plan, modifying the display of the representation of the one or more tasks (e.g., adding a new task representation, removing a task representation, and/or modifying a task representation) suggested by the digital assistant (e.g., as illustrated by the transition between FIGS. 120 and 12P).

In some examples, the computer system can perform automatically (e.g., using an AI process or a generative AI process) a third task of the one or more tasks suggested by the digital assistant.

In some examples, process 1500 further includes: detecting, via the one or more input devices automatically (e.g., using an AI process or a generative AI process), a user input (e.g., 1258) corresponding to a request to initiate the third task; and in response to detecting the user input corresponding to the request to initiate the third task, initiating, by the computer system automatically (e.g., using an AI process or a generative AI process), the third task (e.g., displaying user interface 1260 in FIG. 12Q).

In some examples, the one or more tasks suggested by the digital assistant includes a fourth task, and wherein displaying the first response graphical object includes: concurrently displaying, via the display generation component, a representation of the fourth task (e.g., 1214(1), 1214(2), 1214(3), or 1214(4)) with a respective progress indicator (e.g., 1218(1), 1218(2), 1218(3), or 1218(4)), wherein: in accordance with a determination automatically (e.g., using an AI process or a generative AI process) that the fourth task is incomplete (e.g., the computer system is still performing the first task, the computer system has not determined a result to satisfy the task, and/or has not provided an output to satisfy the first task), the respective progress indicator has a third appearance (e.g., the appearance of 1218(4) in FIG. 12D or in FIG. 12E); and in accordance with a determination automatically (e.g., using an AI process or a generative AI process) that the fourth task is complete (e.g., the computer system has determined a result to satisfy the task and/or has provided an output to satisfy the first task), the respective progress indicator has a fourth appearance (e.g., the appearance of 1218(4) in FIG. 12F) different from the third appearance.

In some examples, the one or more tasks suggested by the digital assistant include a fifth task. In some examples, process 1500 includes in accordance with a determination automatically (e.g., using an AI process or a generative AI process) that the fifth task is complete, displaying, via the display generation component, a response graphical object (e.g., 1220(1), 1220(2), 1220(3), or 1220(4)) indicating the completion of the fifth task. In some examples, the computer system displays a respective response graphical object indicating completion of a task of the suggested tasks in response to the task completing, e.g., regardless of whether other task(s) of the suggested tasks are complete.

In some examples, process 1500 includes in accordance with a determination automatically (e.g., using an AI process or a generative AI process) that each task of the one or more tasks (e.g., 1214(1), 1214(2), 1214(3), and 1214(4)) suggested by the digital assistant is complete, displaying, via the display generation component, one or more respective response graphical objects (e.g., 1220(1), 1220(2), 1220(3), or 1220(4)) that respectively indicate completion of each task of the one or more tasks suggested by the digital assistant. In some examples, the computer system does not display any response graphical object indicating completion of a suggested task until each of the suggested tasks included in the plan is complete.

In some examples, the one or more tasks suggested by the digital assistant include a task (e.g., 1214(3) and/or 1214(4)) to set a reminder.

In some examples, the one or more tasks suggested by the digital assistant include a task for a user to review suggested information (e.g., to review healthy diet plans corresponding to response object 1220(1)).

In some examples, the one or more tasks suggested by the digital assistant include a task for the user to perform (e.g., as opposed to a task that the computer system can perform).

In some examples, process 1500 further includes: in accordance with a determination automatically (e.g., using an AI process or a generative AI process) that information (e.g., a predetermined type of information) about the plan is unspecified, providing an output (e.g., 1254) (e.g., audio output, displayed output, and/or haptic output) indicative of a request for the information about the plan; after providing the output indicative of the request for the information about the plan, detecting, via the one or more input devices automatically (e.g., using an AI process or a generative AI process), a user input (e.g., 1256) that indicates the information about the plan; and updating the display of the first response graphical object (e.g., 1248) (e.g., removing a task representation, adding a task representation, and/or updating a task representation) based on the user input that indicates the information about the plan

In some examples, process 1500 further includes: detecting, via the one or more input devices automatically (e.g., using an AI process or a generative AI process), a user input (e.g., 1274) corresponding to a request to pause a sixth task; and in response to detecting the user input corresponding to the request to pause the sixth task, adding a graphical object (e.g., 1276) that corresponds to the sixth task to the user interface (e.g., 1224) that indicates the one or more ongoing plans.

In some examples, process 1500 further includes: detecting, via the one or more input devices automatically (e.g., using an AI process or a generative AI process), a user input (e.g., 1262) corresponding to a request for progress associated with the plan; and in response to detecting the user input corresponding to the request for progress associated with the plan, providing information corresponding to progress associated with the plan (e.g., displaying user interface 1264) (e.g., displaying the user interface corresponding to the plan). In some examples, the computer system detects the user input after adding the ongoing plan graphical object (e.g., 1228) to the user interface (e.g., 1224) that indicates the one or more ongoing plans.

In some examples, process 1500 further includes: detecting, via the one or more input devices automatically (e.g., using an AI process or a generative AI process), a set of user inputs (1282 and 1292) corresponding to a request to share the plan with an external computer system (e.g., 1295) (e.g., to share the plan with another person); and in response to detecting the set of user inputs corresponding to the request to share the plan with the external computer system, transmitting a representation of the plan to the external computer system (e.g., as illustrated by FIG. 12Y).

In some examples, transmitting the representation of the plan to the external computer system includes removing personal information automatically (e.g., using an AI process or a generative AI process) (e.g., information of the user whose input caused the computer system to create the plan; in some examples, the personal information includes information that can be used to identify the user and/or sensitive information of the user, e.g., health information, location information, financial information, internet search history, home address, passwords, account identifiers, information about the user's preferences, and the like) from the plan. In some examples, transmitting the representation of the plan includes transmitting the one or more tasks suggested by the digital assistant without transmitting select parameter(s) of the suggested task(s) and/or without transmitting the result(s) of executing the suggested task(s). In some examples, the select parameter(s) of the suggested task(s) are specified by the user of the computer system.

The operations described above with reference to FIG. 15 are optionally implemented by components depicted in FIGS. 1-4, 6A-6B, 7A-7C, and/or 8. For example, the operations of process 1500 may be implemented by computer system 800. It would be clear to a person having ordinary skill in the art how other processes are implemented based on the components depicted in FIGS. 1-4, 6A-6B, 7A-7C, and/or 8.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve task performance and suggestions using LLM architecture. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide customized tasks lists and personalized suggestions to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of task performance and suggestions using LLM architecture, the present technology can be configured to allow users to select to “opt in” or “opt out” of participation in the collection of personal information data during registration for services or anytime thereafter. In another example, users can select not to provide personal information (e.g., calendar data) for task performance and suggestions. In yet another example, users can select to limit amount of personalized data obtained (e.g., only providing “available” and “unavailable” indicators for calendar data). In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, task lists and task suggestions can be provided to users by inferring preferences based on non-personal information data or a bare minimum amount of personal information, such as the content being requested by the device associated with a user, other non-personal information available to the task and suggestion architecture, or publicly available information.

What is claimed is:

1. A computer system configured to communicate with a display generation component and one or more input devices, the computer system comprising:
one or more processors; and
memory storing one or more programs configured to be executed by the one or more processors, the one or more programs including instructions for:
receiving, via the one or more input devices, a first user input directed to a digital assistant operating on the computer system; and
in response to receiving the first user input:
in accordance with a determination that the first user input corresponds to a request to initiate a plan, wherein the plan includes one or more tasks suggested by the digital assistant:
displaying, via the display generation component and in a user interface associated with the digital assistant, a first response graphical object corresponding to the plan, wherein the first response graphical object includes a representation of the one or more tasks suggested by the digital assistant; and
adding an ongoing plan graphical object corresponding to the plan to a user interface that indicates one or more ongoing plans, wherein the user interface that indicates one or more ongoing plans is different from the user interface associated with the digital assistant; and
in accordance with a determination that the first user input does not correspond to the request to initiate the plan:
displaying, via the display generation component and in the user interface associated with the digital assistant, a second response graphical object that corresponds to the first user input and that is different from the first response graphical object; and
forgoing, based on the first user input, adding an ongoing plan graphical object to the user interface that indicates one or more ongoing plans.

2. The computer system of claim 1, the one or more programs including instructions for:
in response to receiving the first user input, and in accordance with a determination that the first user input includes a first request and a second request different from the first request, displaying, via the display generation component:
a response graphical object corresponding to a response to the first request; and
a response graphical object corresponding to a response to the second request.

3. The computer system of claim 1, the one or more programs including instructions for:
displaying, via the display generation component, the ongoing plan graphical object in the user interface that indicates one or more ongoing plans, including:
in accordance with a determination that the computer system requests additional information for the plan, displaying the ongoing plan graphical object in a first manner; and
in accordance with a determination that the computer system does not request additional information for the plan, displaying the ongoing plan graphical object in a second manner different from the first manner.

4. The computer system of claim 3, wherein displaying the ongoing plan graphical object in the first manner includes displaying a description of the additional information that is requested.

5. The computer system of claim 3, wherein the ongoing plan graphical object is a first ongoing plan graphical object, the user interface that indicates one or more ongoing plans includes a second ongoing plan graphical object corresponding to a second plan, the one or more programs including instructions for:
concurrently displaying, via the display generation component and in the user interface that indicates one or more ongoing plans, the first ongoing plan graphical object and the second ongoing plan graphical object, including:
in accordance with a determination that the computer system requests the additional information for the first plan and in accordance with a determination that the computer system does not request second additional information for the second plan, displaying the first ongoing plan graphical object with a higher display order than the second ongoing plan graphical object; and
in accordance with a determination that the computer system does not request the additional information for the first plan and in accordance with a determination that the computer system requests the second additional information for the second plan, displaying the first ongoing plan graphical object with a lower display order than the second ongoing plan graphical object.

6. The computer system of claim 1, the one or more programs including instructions for:
while displaying, via the display generation component, the ongoing plan graphical object in the user interface that indicates one or more ongoing plans, detecting, via the one or more input devices, a user input corresponding to a selection of the ongoing plan graphical object; and
in response to detecting the user input corresponding to a selection of the ongoing plan graphical object, displaying, via the display generation component, a user interface corresponding to the plan.

7. The computer system of claim 6, wherein the user interface corresponding to the plan includes a natural language input entry field.

8. The computer system of claim 6, the one or more programs including instructions for:
while displaying the user interface corresponding to the plan, detecting, via the one or more input devices, a natural language input; and
in response to detecting the natural language input, updating the plan based on the natural language input, wherein updating the plan includes updating the user interface corresponding to the plan.

9. The computer system of claim 8, wherein updating the plan includes interpreting the natural language input based on context information associated with the plan.

10. The computer system of claim 1, the one or more programs including instructions for:
detecting, via the one or more input devices, a user input corresponding to a request to display the user interface that indicates one or more ongoing plans; and
in response to receiving the user input corresponding to the request to display the user interface that indicates one or more ongoing plans, displaying, via the display generation component, the user interface that indicates one or more ongoing plans.

11. The computer system of claim 10, wherein the user input corresponding to the request to display the user interface that indicates one or more ongoing plans includes a speech input that requests ongoing tasks associated with the digital assistant.

12. The computer system of claim 1, wherein the one or more tasks suggested by the digital assistant include one or more tasks to be performed in the future.

13. The computer system of claim 1, wherein the one or more tasks suggested by the digital assistant include a first task and a second task, and wherein displaying the first response graphical object corresponding to the plan includes:
in accordance with determining a dependency between the first task and the second task, displaying a representation of the first task and a representation of the second task in an order based on the dependency between the first task and the second task.

14. The computer system of claim 1, the one or more programs including instructions for:
while displaying the first response graphical object corresponding to the plan, detecting, via the one or more input devices, a user input corresponding to a request to modify the plan; and
in response to detecting the user input corresponding to the request to modify the plan, modifying the display of the representation of the one or more tasks suggested by the digital assistant.

15. The computer system of claim 1, wherein the computer system can perform a third task of the one or more tasks suggested by the digital assistant.

16. The computer system of claim 15, the one or more programs including instructions for:
detecting, via the one or more input devices, a user input corresponding to a request to initiate the third task; and
in response to detecting the user input corresponding to the request to initiate the third task, initiating, by the computer system, the third task.

17. The computer system of claim 1, wherein the one or more tasks suggested by the digital assistant includes a fourth task, and wherein displaying the first response graphical object includes:
concurrently displaying, via the display generation component, a representation of the fourth task with a respective progress indicator, wherein:
in accordance with a determination that the fourth task is incomplete, the respective progress indicator has a third appearance; and
in accordance with a determination that the fourth task is complete, the respective progress indicator has a fourth appearance different from the third appearance.

18. The computer system of claim 1, wherein the one or more tasks suggested by the digital assistant include a fifth task, the one or more programs including instructions for:
in accordance with a determination that the fifth task is complete, displaying, via the display generation component, a response graphical object indicating the completion of the fifth task.

19. The computer system of claim 1, the one or more programs including instructions for:
in accordance with a determination that each task of the one or more tasks suggested by the digital assistant is complete, displaying, via the display generation component, one or more respective response graphical objects that respectively indicate completion of each task of the one or more tasks suggested by the digital assistant.

20. The computer system of claim 1, wherein the one or more tasks suggested by the digital assistant include a task to set a reminder.

21. The computer system of claim 1, wherein the one or more tasks suggested by the digital assistant include a task for a user to review suggested information.

22. The computer system of claim 1, wherein the one or more tasks suggested by the digital assistant include a task for the user to perform.

23. The computer system of claim 1, the one or more programs including instructions for:
in accordance with a determination that information about the plan is unspecified, providing an output indicative of a request for the information about the plan;
after providing the output indicative of the request for the information about the plan, detecting, via the one or more input devices, a user input that indicates the information about the plan; and
updating the display of the first response graphical object based on the user input that indicates the information about the plan.

24. The computer system of claim 1, the one or more programs including instructions for:
detecting, via the one or more input devices, a user input corresponding to a request to pause a sixth task; and
in response to detecting the user input corresponding to the request to pause the sixth task, adding a graphical object that corresponds to the sixth task to the user interface that indicates the one or more ongoing plans.

25. The computer system of claim 1, the one or more programs including instructions for:
detecting, via the one or more input devices, a user input corresponding to a request for progress associated with the plan; and
in response to detecting the user input corresponding to the request for progress associated with the plan, providing information corresponding to progress associated with the plan.

26. The computer system of claim 1, the one or more programs including instructions for:
detecting, via the one or more input devices, a set of user inputs corresponding to a request to share the plan with an external computer system; and
in response to detecting the set of user inputs corresponding to the request to share the plan with the external computer system, transmitting a representation of the plan to the external computer system.

27. The computer system of claim 26, wherein transmitting the representation of the plan to the external computer system includes removing personal information from the plan.

28. A non-transitory computer-readable storage medium storing one or more programs configured to be executed by one or more processors of a computer system that is in communication with a display generation component and one or more input devices, the one or more programs including instructions for:
receiving, via the one or more input devices, a first user input directed to a digital assistant operating on the computer system; and
in response to receiving the first user input:
in accordance with a determination that the first user input corresponds to a request to initiate a plan, wherein the plan includes one or more tasks suggested by the digital assistant:
displaying, via the display generation component and in a user interface associated with the digital assistant, a first response graphical object corresponding to the plan, wherein the first response graphical object includes a representation of the one or more tasks suggested by the digital assistant; and
adding an ongoing plan graphical object corresponding to the plan to a user interface that indicates one or more ongoing plans, wherein the user interface that indicates one or more ongoing plans is different from the user interface associated with the digital assistant; and
in accordance with a determination that the first user input does not correspond to the request to initiate the plan:
displaying, via the display generation component and in the user interface associated with the digital assistant, a second response graphical object that corresponds to the first user input and that is different from the first response graphical object; and
forgoing, based on the first user input, adding an ongoing plan graphical object to the user interface that indicates one or more ongoing plans.

29. A method, comprising:
at a computer system in communication with a display generation component and one or more input devices:
receiving, via the one or more input devices, a first user input directed to a digital assistant operating on the computer system; and
in response to receiving the first user input:
in accordance with a determination that the first user input corresponds to a request to initiate a plan, wherein the plan includes one or more tasks suggested by the digital assistant:
displaying, via the display generation component and in a user interface associated with the digital assistant, a first response graphical object corresponding to the plan, wherein the first response graphical object includes a representation of the one or more tasks suggested by the digital assistant; and
adding an ongoing plan graphical object corresponding to the plan to a user interface that indicates one or more ongoing plans, wherein the user interface that indicates one or more ongoing plans is different from the user interface associated with the digital assistant; and
in accordance with a determination that the first user input does not correspond to the request to initiate the plan:
displaying, via the display generation component and in the user interface associated with the digital assistant, a second response graphical object that corresponds to the first user input and that is different from the first response graphical object; and
forgoing, based on the first user input, adding an ongoing plan graphical object to the user interface that indicates one or more ongoing plans.
